(19) United States
(12) Patent Application Publication
(10) Pub. No.: US 2024/0206031 A1
(43) Pub. Date: Jun. 20, 2024

(54) LIGHT-EMITTING METHODS AND LIGHT-EMITTING DEVICES FACING LIMITED CONDITIONS

(71) Applicant: NOVATECH CO., LTD., Huzhou (CN)

(72) Inventors: Maurizio MOLLINELLI, Tavullia(PU) (IT); Yan'an SHEN, Huzhou (CN); Xiaoping ZHOU, Huzhou (CN); Bei CHENG, Huzhou (CN); Chuan YU, Huzhou (CN); Hong SHI, Huzhou (CN); Daojun ZHAN, Huzhou (CN)

(73) Assignee: NOVATECH CO., LTD., Huzhou (CN)

(21) Appl. No.: 18/530,151

(22) Filed: Dec. 5, 2023

Related U.S. Application Data
(63) Continuation-in-part of application No. PCT/CN2022/138841, filed on Dec. 14, 2022.

(30) Foreign Application Priority Data
Nov. 17, 2022 (CN) 202211440746.5
Nov. 12, 2023 (CN) 202311504787.0

(51) Int. Cl. H05B 45/20; H05B 45/10

(52) U.S. Cl. CPC H05B 45/20; H05B 45/10

(57) ABSTRACT

The present disclosure provides a light-emitting method and a light-emitting device facing a limited condition. The limited condition may include that a light emitted by a light source transmits through a non-display surface of a light-transmitting plate that satisfies a light-transmitting condition so that a display surface of the light-transmitting plate displays a display light that satisfies a display condition. The light-transmitting condition may include a chromaticity coordinate range corresponding to the light-transmitting plate. The display condition may include a chromaticity coordinate range of the display light. The light-emitting method may include the light source satisfying that a chromaticity coordinate range corresponding to the light source is a chromaticity coordinate range of the light source for displaying the display light, and a light color adjustment range corresponding to the light source is a spectrum adjustment range of the light source for displaying the display light.

### CROSS-REFERENCE TO RELATED APPLICATIONS

This application is a continuation-in-part of International Application No. PCT/CN2022/138841, filed on Dec. 14, 2022, which claims priority to Chinese Patent Application No. 202211440746.5, filed on Nov. 17, 2022; this application also claims priority to Chinese Patent Application No. 202311504787.0, filed on Nov. 12, 2023, the entire contents of each of which are hereby incorporated by reference.

### TECHNICAL FIELD

The present disclosure relates to the field of dynamic dimming technology, and in particular, to light-emitting methods and light-emitting devices facing limited conditions.

### BACKGROUND

Panels (e.g., modern microcrystalline glass, etc.) are widely applied in aerospace, architectural decoration, furniture life, consumer electronics, etc. A display device may consist of a panel sheet (substrate) and a signal lamp (light source). Lights displayed on a display surface of the panel sheet are different due to different lights emitted by the display device. Thus, it is urgent to determine a light-emitting method that enables the display device to provide different lights under different limited conditions, so as to provide a display light that meets the diverse needs of users.

Therefore, it is desired to provide a light-emitting method and a light-emitting device facing limited conditions, which may make the light source and panel emit different lights under limited conditions to obtain different display lights, thereby meet the display needs of users in different scenarios.

### SUMMARY

One or more embodiments of the present disclosure provide a light-emitting method facing a limited condition. The limited condition may include that a light emitted by a light source transmits through a non-display surface of a light-transmitting plate that satisfies a light-transmitting condition so that a display surface of the light-transmitting plate displays a display light that satisfies a display condition. The light-transmitting condition may include a chromaticity coordinate range corresponding to the light-transmitting plate, wherein the chromaticity coordinate range corresponding to the light-transmitting plate may be a chromaticity coordinate region where a transmitted light of a CIE standard illuminant passing through the light-transmitting plate is rendered in a CIE standard chromaticity system. The display condition may include a chromaticity coordinate range of the display light, wherein the chromaticity coordinate range of the display light may be a chromaticity coordinate range required by the display light to display a transmitted light in a target color. The light-emitting method may include the light source satisfying that a chromaticity coordinate range corresponding to the light source is a chromaticity coordinate range of the light source for displaying the display light, and a light color adjustment range corresponding to the light source is a spectrum adjustment range of the light source for displaying the display light.

One of the embodiments of the present disclosure provides a light-emitting device facing a limited condition. The light-emitting device may include a light source and a light-transmitting plate. The light source may be configured to emit light to a non-display surface of a light-transmitting plate that satisfies a light-transmitting condition so that a display surface of the light-transmitting plate may display a display light that satisfies a display condition. The light-transmitting condition may include a chromaticity coordinate range corresponding to the light-transmitting plate, wherein the chromaticity coordinate range corresponding to the light-transmitting plate may be a chromaticity coordinate region where a transmitted light of a CIE standard illuminant passing through the light-transmitting plate is rendered in a CIE standard chromaticity system. The display condition may include a chromaticity coordinate range of the display light, wherein the chromaticity coordinate range of the display light may be a chromaticity coordinate range required by the display light to display a transmitted light in a target color. The light source may satisfy that a chromaticity coordinate range corresponding to the light source is a chromaticity coordinate range of the light source for displaying the display light, and a light color adjustment range corresponding to the light source is a spectrum adjustment range of the light source for displaying the display light.

One or more embodiments of the present disclosure provide a non-transitory computer-readable storage medium storing computer instructions. When a computer reads the computer instructions in the storage medium, the computer may perform the light-emitting method facing the limited condition as described in the embodiments of the present disclosure.

### BRIEF DESCRIPTION OF THE DRAWINGS

The present disclosure is further illustrated in terms of exemplary embodiments. These exemplary embodiments are described in detail according to the drawings. These embodiments are non-limiting exemplary embodiments, in which like reference numerals represent similar structures, wherein:

FIG. 1 is an exemplary schematic diagram illustrating a dimming device according to some embodiments of the present disclosure;

FIG. 2 is a flowchart illustrating an exemplary process of a method for determining at least one light-emitting parameter according to some embodiments of the present disclosure;

FIG. 3 is a schematic diagram illustrating an exemplary light-emitting device according to some embodiments of the present disclosure;

FIG. 4 is a schematic diagram illustrating an exemplary system for designing a light source according to some embodiments of the present disclosure;

FIG. 5 is a flowchart illustrating an exemplary process of a method for designing a light source according to some embodiments of the present disclosure;

FIG. 6 is a diagram illustrating an area range of W1-W4 in Example 1;

FIG. 7 is a curve graph illustrating spectral transmittances of 21 glasses in Example 1;

FIG. 8 is a diagram illustrating a spectral distribution of RGBA tetrachromatic lamp beads in Example 2 at equal power;

FIG. 9 is a diagram illustrating a transmission spectral distribution of a microcrystalline glass panel in Example 2;

FIG. 10 is a diagram illustrating a spectral distribution of RGBA tetrachromatic lamp beads used in a white light color rendering device in Example 2 when white color is rendered;

FIG. 11 is a diagram illustrating a distribution of chromaticity coordinates of a light source, a microcrystalline glass panel, and a white light color rendering device in Example 2 when the white light color rendering device is rendering white color;

FIG. 12 is a diagram illustrating a spectral distribution of RGB trichromatic lamp beads in Example 3 at equal power;

FIG. 13 is a diagram illustrating a transmission spectral distribution of a microcrystalline glass panel in Example 3;

FIG. 14 is a diagram illustrating a spectral distribution of RGB trichromatic lamp beads used in a white light color rendering device in Example 3 when white color is rendered;

FIG. 15 is a diagram illustrating a distribution of chromaticity coordinates of a light source, a microcrystalline glass panel, and a white light color rendering device in Example 3 when the white light color rendering device is rendering white color;

FIG. 16 is a diagram illustrating a spectral distribution of an LED light source in Example 3 at equal power;

FIG. 17 is a diagram illustrating a transmission spectral distribution of a microcrystalline glass panel in Example 4;

FIG. 18 is a diagram illustrating a spectral distribution of an LED light source used in a white light color rendering device in Example 4 when white color is rendered;

FIG. 19 is a diagram illustrating a distribution of chromaticity coordinates of a light source, a microcrystalline glass panel, and a white light color rendering device in Example 4 when the white light color rendering device is rendering white color;

FIG. 20 is a diagram illustrating a transmittance spectrum before and after applying a filter compensator to a microcrystalline glass panel in a contrasting example;

FIG. 21 is a schematic diagram illustrating an exemplary light-emitting method facing a limited condition according to some embodiments of the present disclosure;

FIG. 22 is a diagram illustrating a chromaticity coordinate range of a display light according to some embodiments of the present disclosure;

FIG. 23 is a diagram illustrating a chromaticity coordinate range corresponding to a light source according to some embodiments of the present disclosure;

FIG. 24 is a diagram illustrating a chromaticity coordinate range of a display light according to some other embodiments of the present disclosure;

FIG. 25 is a diagram illustrating a chromaticity coordinate range corresponding to a light source according to some other embodiments of the present disclosure;

FIG. 26 is a diagram illustrating a spectral distribution of an intrinsic peak of a light source according to some embodiments of the present disclosure;

FIG. 27 is a diagram illustrating a transmission spectral distribution of a microcrystalline glass panel according to some embodiments of the present disclosure; and

FIG. 28 is a diagram illustrating a transmission spectral distribution of a microcrystalline glass panel used in a light-emitting device that displays white color according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words may be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may further include other steps or elements.

The flowcharts used in the present disclosure illustrate the operation that the system implements according to the embodiment of the present disclosure. It should be understood that the foregoing or following operation may not necessarily be performed exactly in order. Instead, steps can be processed in reverse order or simultaneously. Instead, the operation may be processed in reverse order or simultaneously. Besides, one or more other operations may be added to these processes, or one or more operations may be removed from these processes.

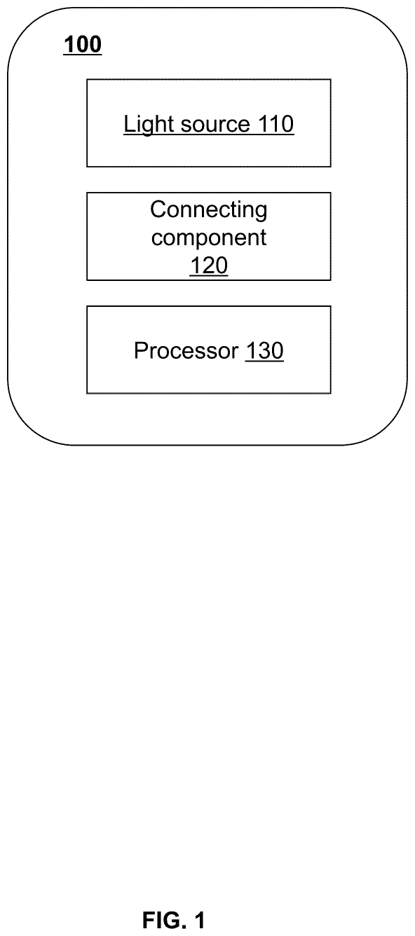

FIG. 1 is a schematic diagram illustrating an exemplary dimming device according to some embodiments of the present disclosure.

The dimming device refers to a device that may display different lights. In some embodiments, as shown in FIG. 1, the dimming device 100 may include a light source 110, a connecting component 120, a processor 130, etc. In some embodiments, the dimming device 100 may also include other components, such as a light-transmitting plate and/or a dimming component (not shown in the figures), etc.

The light source 110 refers to a light-emitting component that produces light.

In some embodiments, the light-emitting device of the light source may include one or more types. For example, the light-emitting component may include one or more of a backlight module, a digital tube, a light-emitting diode, etc.

In some embodiments, the light-emitting component of the light source may include one or more of an LED component, a fluorescent component, a quantum dot component, etc.

In some embodiments, a spectrum of the light source may include a visible light spectrum.

In some embodiments, the spectrum of the light source may include one or more intrinsic peaks. The one or more intrinsic peaks may be distinct peaks that appear in a spectral curve of the light source. It should be understood that the light-emitting intensity of the light at a wavelength corresponding to an intrinsic peak is relatively high.

In some embodiments, the spectrum of the light source may include one intrinsic peak. In some embodiments, the spectrum of the light source may include two intrinsic peaks. In some embodiments, the spectrum of the light source may include three intrinsic peaks. In some embodiments, the spectrum of the light source may include four intrinsic peaks. In some embodiments, the spectrum of the light source may include one to two intrinsic peaks. In some embodiments, the spectrum of the light source may include one to three intrinsic peaks. In some embodiments, the spectrum of the light source may include two to three intrinsic peaks. In some embodiments, the spectrum of the light source may include one to four intrinsic peaks. In some embodiments, the spectrum of the light source may include two to four intrinsic peaks. In some embodiments, the spectrum of the light source may include three to four intrinsic peaks. A count of intrinsic peaks included in the spectrum of the light source varies depending on the actual situation. The count of the intrinsic peaks may be designed and preset according to the actual situation.

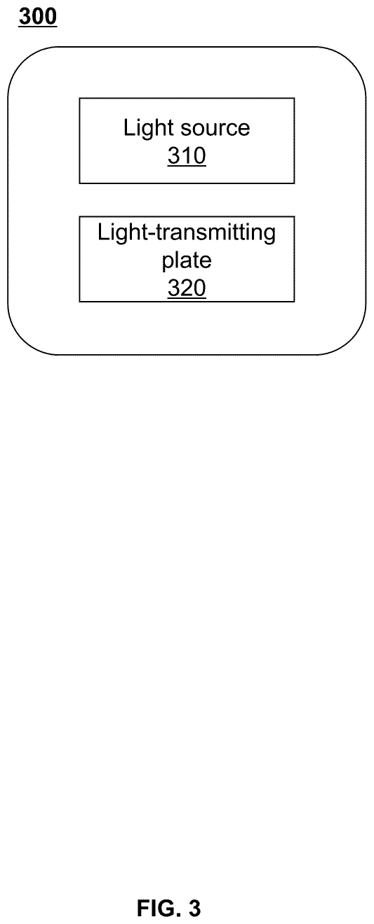

In some embodiments, more descriptions regarding the light source, the light-emitting component, etc. may be found in FIG. 3 and related descriptions thereof.

In some embodiments of the present disclosure, the light source has a plurality of intrinsic peaks, then the spectrum of the light source may cover a relatively wide range of wavelengths, thus achieving a relatively rich color representation and meeting different requirements of users for a display light.

In some embodiments, the light source 110 may be configured to emit light to a non-display surface of the light-transmitting plate so that a display surface of the light-transmitting plate displays the display light.

The light-transmitting plate refers to a medium for transmitting light. In some embodiments, the light-transmitting plate may include a plurality of materials. For example, the light-transmitting plate may be a plate of microcrystalline glass, polymethyl methacrylate (PMMA) (e.g., acrylic), polycarbonate (PC), or other light-transmitting materials. The microcrystalline glass may have excellent characteristics such as high hardness, corrosion resistance, compression resistance, impact resistance, non-absorption of water, less ash staining, no radiation, etc. The microcrystalline glass may be widely used in fields such as aerospace, building decoration, furniture life, consumer electronics, etc. A display device of the microcrystalline glass panel used in architectural decoration and furniture life appliances is often composed of a dark or brown low-transparent tinted microcrystalline glass panel sheet (substrate) and a signal lamp (light source). The microcrystalline glass panel paired with the signal lamp often serves as a display panel. The signal lamp informs the user about an operating status (on, standby, normal, abnormal, etc.), operating hours, and an operating mode through the display panel. In a display device (a stove top, a freezer, etc.) of the furniture life, a small LED digital tube is often used as a lamp. In an architectural curtain wall display, an LED panel, a fluorescent lamp, or a quantum dot panel are often used as the lamp.

In some embodiments, the light-transmitting plate may include a display surface and a non-display surface. The display surface refers to a surface of the light-transmitting plate that is used to display the display light. The non-display surface refers to a surface of the light-transmitting plate that is used to receive light from the light source.

The display light refers to a light emitted by the light source that passes through the light-transmitting plate and is displayed on the display surface of the light-transmitting plate. In some embodiments, the display light may include different colors. For example, the display light may be any one of white light, yellow light, blue light, cyan light, green light, orange light, purple light, red light, etc., or a combination of a plurality of colors. As another example, when the display light is the white light, the white light may also include a plurality of types. For example, warm white light, cool white light, neutral white light, etc. The light source may emit different lights according to different requirements of display lights. In some embodiments, the dimming instruction may be an instruction issued for the display light. Different display lights may be selected to be displayed according to actual needs. Exemplarily, the display light may be any color of light such as white light, yellow light, blue light, etc. Display lights with different colors may be represented by controlling different chromaticity coordinate ranges of the display light.

The connecting component 120 refers to an interface or a component for connecting different components or devices. In some embodiments, the connecting component may transmit signals, data, or energy. In some embodiments, the connecting component may include connecting assemblies that connect two-by-two between components such as the processor, the light source, an adjustment component, the light-transmitting plate, etc. A count of the connecting component may be one or more, and the count of the connecting component and a connecting manner may be set according to needs, which is not limited here. In some embodiments, the connecting component 120 may connect different components or devices in a plurality of manners. For example, the connecting component 120 may connect different components or devices in wired or wireless manners. Descriptions regarding the processor may be found in FIG. 1 and related descriptions hereinafter.

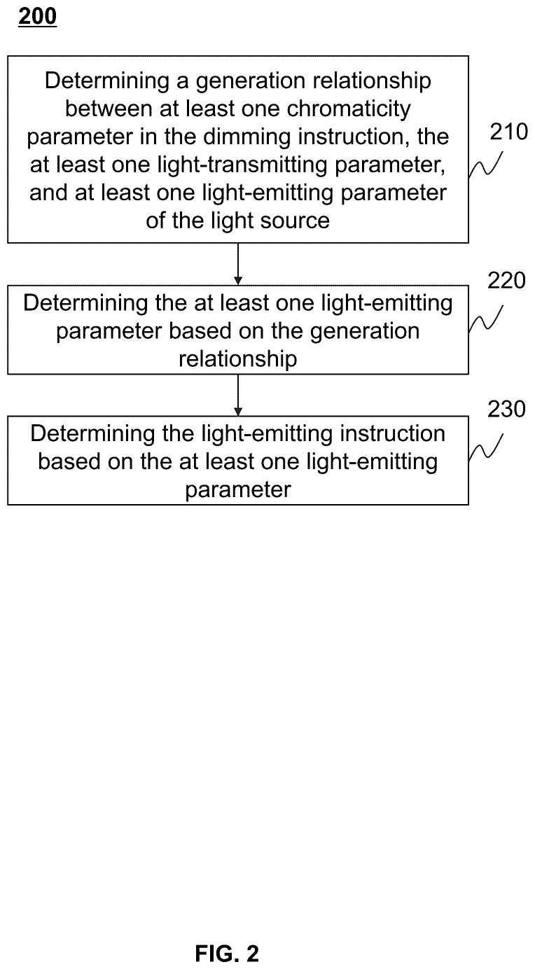

In some embodiments, the connecting component 120 may be configured to transmit the dimming instruction of the display light to the processor 130 and transmit a light-emitting instruction of the light source to the light source 110. Descriptions regarding the dimming instruction may be found in FIG. 1 and related descriptions hereinafter. Further descriptions regarding the dimming instruction may be found in FIG. 2 and related descriptions thereof.

The connecting component may obtain the dimming instruction in a plurality of manners. For example, the connecting component may obtain the dimming instruction based on software or a system (e.g., cell phone software, a dimming system, etc.) of a third-party user terminal. The third-party user terminal may include a cell phone, an LCD TV, a computer, etc. As another example, the connecting component may obtain the dimming instruction based on the adjustment component. Descriptions regarding the adjustment component may be found in FIG. 1 and related descriptions hereinafter.

In some embodiments, the processor 130 may be configured to process information and/or data related to the dimming device 100 to perform one or more of the functions described in the present disclosure. In some embodiments, the processor 130 may be communicatively connected to the light source 110, the connecting component 120, etc., thereby obtaining and transmitting the dimming instruction, at least one light-transmitting parameter of the light-transmitting plate, etc.

In some embodiments, the processor 130 may be configured as a combination of one or more of a microcontroller (MCU), an embedded processor, a graphics processing Unit (GPU), etc.

In some embodiments, the processor 130 may be configured to determine the light-emitting instruction based on the dimming instruction and the at least one light-transmitting parameter of the light-transmitting plate. The process of determining the light-emitting instruction based on the dimming instruction and the at least one light-transmitting parameter of the light-transmitting plate may include determining a generation relationship between at least one chromaticity parameter, at least one light-transmitting parameter, and at least one light-emitting parameter of the light source in the dimming instruction. The process may also include determining the at least one light-emitting parameter based on the generation relationship and determining the light-emitting instruction based on the at least one light-emitting parameter. The generation relationship may be jointly determined based on generation results at different wavelengths. The generation results may be related to a derivative of the at least one light-transmitting parameter and the at least one light-emitting parameter. More descriptions may be found in FIG. 2 and related descriptions thereof.

In some embodiments, the processor may be further configured to determine a first derivative function based on a first chromaticity wavelength function of the light-transmitting plate; determine a second derivative function based on a color matching function; determine a third derivative function based on the at least one chromaticity parameter, the first derivative function, the second derivative function, and a wavelength spacing; determine the generation results at the different wavelengths based on the first derivative function, the second derivative function, and the third derivative function. In some embodiments, each of the first derivative function and the third derivative function may include a second-order derivative function relative to a wavelength. In some embodiments, the third derivative function may include a first-order derivative function relative to the wavelength. More descriptions regarding the above may be found in FIG. 2 and related descriptions thereof.

In some embodiments, the dimming device 100 may further include a light-transmitting plate. A light transmittance of the light-transmitting plate may be adjustable, and the connecting component 120 may be further configured to transmit the at least one light-transmitting parameter to the processor 130.

In some embodiments, the light-transmitting plate may be a material with adjustable light transmittance or a specially designed structure with adjustable light transmittance.

In some embodiments, the connecting component 120 may transmit the at least one light-transmitting parameter including the light transmittance to the processor 130. The processor 130 may control the light-emitting intensity of the display light transmitted through the light-transmitting plate by adjusting the light transmittance of the light-transmitting plate. Descriptions regarding the light-emitting intensity may be found in FIG. 2 and related descriptions thereof.

The light transmittance refers to a degree to which the light-transmitting plate transmits the light. For example, the light transmittance may be represented by a percentage or decimal of the light transmitted through the light-transmitting plate. The higher the light transmittance, the more light the light-transmitting plate transmits.

In some embodiments of the present disclosure, the light-transmitting plate in the dimming device may have an adjustable light transmittance, and the dimming device may control the light transmittance more flexibly to further realize a dimming effect so that the dimming device may be adapted to different user needs.

In some embodiments, the dimming device 100 may further include the adjustment component. The adjustment component refers to a component for adjusting or controlling parameters of the dimming device. For example, the adjustment component may be configured as one of a knob, a button, a touch device, etc. Exemplarily, a user may change the dimming instruction delivered by the dimming device by rotating the adjustment component.

In some embodiments, the adjustment component may be configured to adjust the display light based on the dimming instruction.

In some embodiments, the connecting component may obtain the dimming instruction based on software or a system, etc. (e.g., cell phone software, an operating system, etc.) of a third-party user terminal and send the dimming instruction to the processor. The processor may send the obtained dimming instruction to the adjustment component. The adjustment component may adjust the display light based on the dimming instruction.

The dimming instruction refers to an instruction for controlling the display light. For example, the dimming instruction may include a control instruction that regulates parameters related to the display light. The parameters related to the display light may include brightness, a light-emitting intensity, at least one chromaticity parameter, etc. of the display light. In some embodiments, the dimming instruction may be to adjust the at least one light-emitting parameter according to a preset brightness mode such as a reading mode or a resting mode. The reading mode indicates a parameter setting for displaying light in a reading state. The resting mode indicates a parameter setting for displaying light in a resting state.

More descriptions regarding the above may be found in FIG. 2 and related descriptions thereof.

Some embodiments of the present disclosure, through the dimming device including the light source, the connecting component, the processor, etc., different dimming instructions may be obtained, and corresponding light-emitting parameters may be generated. Based on the light-emitting parameters, the light source may be adjusted, thereby realizing adjustment of the display light to meet different needs of users for display light.

FIG. 2 is a flowchart illustrating an exemplary process for determining at least one light-emitting parameter according to some embodiments of the present disclosure. As shown in FIG. 2, process 200 may include the following steps. In some embodiments, process 200 may be executed by processor 130.

In 210, a generation relationship between at least one chromaticity parameter in a dimming instruction, at least one light-transmitting parameter of a light-transmitting plate, and at least one light-emitting parameter of a light source may be determined. More descriptions regarding the dimming instruction, the light-transmitting plate, and the light source may be found in FIG. 1 and related descriptions thereof.

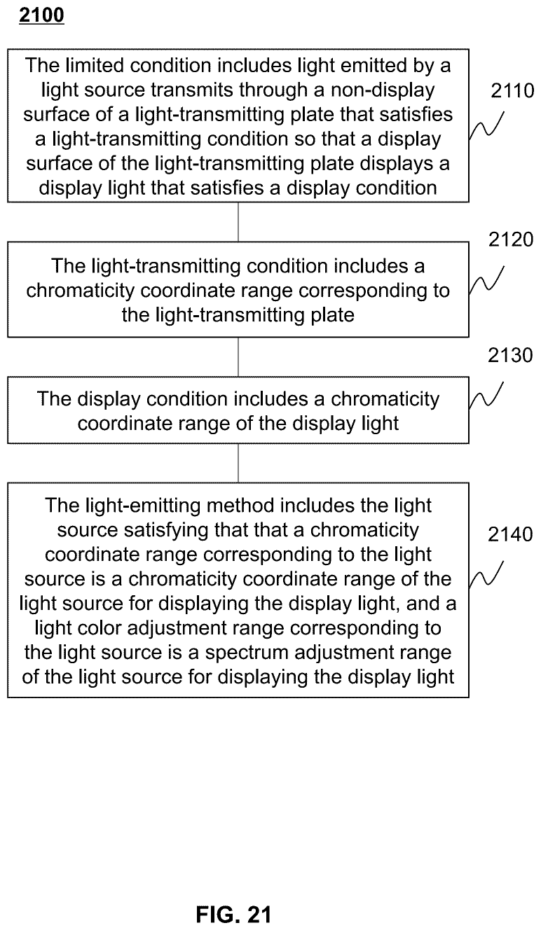

The chromaticity parameter refers to a parameter used to describe a color characteristic of a display light. For example, the chromaticity parameter may include at least one of a color temperature, a color saturation, a chromaticity coordinate, a chromaticity coordinate range, etc. of the display light. More descriptions regarding the color temperature may be found in FIG. 21 and related descriptions thereof. The chromaticity coordinates, the chromaticity coordinate ranges, etc. corresponding to the display lights for different color needs/color temperature needs are different. The chromaticity coordinate range corresponding to the display light refers to a range of chromaticity coordinates required by the display light to display a light that meets a certain color (such as a target color) demand. For example, the chromaticity coordinate range corresponding to the display light is V2. The chromaticity coordinate corresponding to the display light may be a certain chromaticity coordinate in the chromaticity coordinate range (e.g., V2). Different colors of display light may correspond to different chromaticity coordinate ranges. The target color refers to a color that the user wants. For example, the target color may be any one of white, yellow, blue, cyan, green, orange, purple, red, etc., or a combination of a plurality of colors. As another example, when the target color light is white, the white color may also include a plurality of types. Exemplarily, warm white, cool white, neutral white, etc. The target color may also be represented directly by display lights of different colors. For example, the target color of the display light is red.

In some embodiments, the processor may determine the chromaticity parameter of the display light in a plurality of manners. For example, the processor may obtain the chromaticity parameter of the display light based on the connecting component. The connecting component may obtain the chromaticity parameter input by a user through software or a system of a third-party user terminal. The user refers to an operator of a dimming device. The operator may include a designer, a user, etc. of the dimming device.

In some embodiments, the processor may obtain the chromaticity coordinate, the chromaticity coordinate range corresponding to the display light using preset equations (e.g., chromaticity equations, color tolerance equations, etc.), etc. More descriptions may be found in the related description of FIG. 2 hereinafter.

In some embodiments, the chromaticity parameter may be manually preset based on needs. For example, the chromaticity parameters corresponding to display light for different color needs/color temperature needs, etc. may be preset in advance. As another example, color saturation of the display light, etc. may be manually preset.

The light-transmitting parameter refers to a parameter used to characterize a light transmittance of the light-transmitting plate. For example, the light-transmitting parameter may include at least one of a chromaticity coordinate corresponding to the light-transmitting plate, a chromaticity coordinate range corresponding to the light-transmitting plate, a light transmittance of the light-transmitting plate, an attenuation coefficient of light of the light-transmitting plate, etc. More descriptions regarding the light transmittance may be found in FIG. 1 and related descriptions thereof. The chromaticity coordinate range corresponding to the light-transmitting plate refers to a chromaticity coordinate region where a transmitted light of a CIE standard illuminant passing through the light-transmitting plate is rendered in a CIE standard chromaticity system. For example, the chromaticity coordinate range corresponding to the light-transmitting plate is V1. The chromaticity coordinates corresponding to the light-transmitting plate is a certain chromaticity coordinate in the chromaticity coordinate range (e.g., V1). The CIE standard chromaticity system refers to a standard system for quantitatively describing colors. For example, the CIE standard chromaticity system is a CIE 1931 standard chromaticity system, etc. The attenuation coefficient of light refers to a measurement parameter that describes the amount of energy that is lost in propagating light through the light-transmitting plate. The attenuation coefficient of light may indicate the attenuation degree of light when the light passes through a medium or other obstacle (the light-transmitting plate). For example, the attenuation coefficient of light may be expressed as a degree to which the light-emitting intensity decreases with distance or medium. The greater the attenuation coefficient of light, the more energy is lost when propagating the light through the light-transmitting plate, and the greater the degree of weakening the light-emitting intensity. More descriptions regarding the light-emitting intensity may be found hereinafter.

In some embodiments, the processor may determine the light-transmitting parameter of the light-transmitting plate in a plurality of manners.

In some embodiments, the processor may obtain the light-transmitting parameter based on the connecting component. The connecting component may obtain the light-transmitting parameter based on software or a system (e.g., cell phone software, a dimming system, etc.) of a third-party user terminal. In some embodiments, the light-transmitting parameter may be set manually based on requirements. More descriptions regarding the connecting component may be found in FIG. 1 and related descriptions thereof.

In some embodiments, the processor may obtain the chromaticity coordinate, the chromaticity coordinate range corresponding to the light-transmitting plate using equations (e.g., equations (1-1) -(1-7), etc.), etc. More descriptions may be found in the related descriptions in FIG. 2 hereinafter.

In some embodiments, the light-transmitting parameter of the light-transmitting plate may be manually preset. For example, the attenuation coefficient of the light of the light-transmitting plate, etc. may be manually preset.

The light-emitting parameter refers to a parameter used to describe a light-emitting feature of the light source. For example, the light-emitting parameter may include at least one of the chromaticity coordinates corresponding to the light source, the chromaticity coordinates corresponding to the light source, a brightness, a luminous flux, a light-emitting intensity, etc. of the light source. The chromaticity coordinate range corresponding to the light source refers to a chromaticity coordinate range of the light source for displaying the display light. A light color adjustment range corresponding to the light source is a spectrum adjustment range of the light source for displaying the display light. For example, when the chromaticity coordinate range corresponding to the display light is V2, the chromaticity coordinate range corresponding to the light source is V3. For example, when the chromaticity coordinate range corresponding to the display light is V2, the chromaticity coordinate range corresponding to the light source is V3. The chromaticity coordinates corresponding to the light source is a certain chromaticity coordinate in the chromaticity coordinate range (such as V3). The luminous flux refers to light energy emitted by the light source per unit time. The brightness refers to luminous flux per unit area of the light source in a given direction. The light-emitting intensity refers to luminous flux emitted by the light source within a unit solid angle in a given direction.

In some embodiments, the processor may calculate the chromaticity coordinate range V1 corresponding to the light-transmitting plate by a transmittance function, using a stimulus formula and a color matching function of a CIE standard chromaticity system. The color matching function refers to a function used to determine a tri-stimulus value in the CIE standard chromaticity system. The transmittance function refers to a function that expresses transmittance of the light-transmitting plate. The processor may obtain the transmittance function through measurement by a photometric. In some embodiments, the processor may determine the chromaticity coordinate range V1 according to equations (1-1) -(1-7).

$${X}_{i} = k {\sum }_{380}^{780} {φ}_{i} ( λ ) \overline{x} ( λ ) Δ λ \qquad ( 1 - 1 )$$

$${Y}_{i} = k {\sum }_{380}^{780} {φ}_{i} ( λ ) \overline{y} ( λ ) Δ λ \qquad ( 1 - 2 )$$

$${Z}_{i} = k {\sum }_{380}^{780} {φ}_{i} ( λ ) \overline{z} ( λ ) Δ λ \qquad ( 1 - 3 )$$

$$k = \frac{100}{{\sum }_{380}^{780} {φ}_{i} ( λ ) \overline{y} ( λ ) Δ λ} \qquad ( 1 - 4 )$$

$${x}_{i} = \frac{{X}_{i}}{{X}_{i} + {Y}_{i} + {Z}_{i}} \qquad ( 1 - 5 )$$

$${y}_{i} = \frac{{Y}_{i}}{{X}_{i} + {Y}_{i} + {Z}_{i}} \qquad ( 1 - 6 )$$

$${z}_{i} = \frac{{Z}_{i}}{{X}_{i} + {Y}_{i} + {Z}_{i}} \qquad ( 1 - 7 )$$

where Xᵢ, Yᵢ, and Zᵢ denote tri-stimulus values of the light-transmitting plate, xᵢ, yᵢ, and zᵢ denote chromaticity coordinates of the light-transmitting plate, x̅(λ), y̅(λ), and z̅(λ) denote functions of the tri-stimulus values in the CIE standard chromaticity system, Δλ denotes the wavelength spacing, and λ is the wavelength; φᵢ(λ) denotes the transmittance function of the light-transmitting plate, and i denotes a serial number of the light-transmitting plate. Descriptions regarding the wavelength spacing may be found in related descriptions hereinafter. k denotes a correction factor, which is a coefficient greater than zero. Considering the influence of the light-transmitting plate (such as glass surface types, etc.) on the spectrum, the correction factor k is an equation that includes a scattering effect of the light-transmitting plate (such as glass, etc.) or an experience value for a specific light-transmitting plate (such as glass, etc.), which may be preset in advance. In equations (1-1) -(1-7), a wavelength within a range of 380 nm-780 nm is taken as an example. In some embodiments, the processor may set a range of the wavelength according to actual needs. In some embodiments, a value corresponding to the correction factor k may be obtained through a simulation experiment. In the simulation experiment, a spectral transmittance of the light-transmitting plate (such as glass, etc.) is calibrated based on an energy spectrum map of the light-transmitting plate (such as glass, etc.) and the light source, and the correction factor k is obtained based on a weighting operation.

In the case where the tri-stimulus values of the light-transmitting plate, the function of the tri-stimulus values in the CIE standard chromaticity system, the wavelength spacing, and the wavelength are known, the processor may obtain a plurality of chromaticity coordinates of the light-transmitting plate based on traversal of different wavelengths, and use the plurality of chromaticity coordinates as a corresponding chromaticity coordinate range V1 of the light-transmitting plate.

In some embodiments, for a display light with a color demand, the processor may obtain a chromaticity coordinate range V2 of the display light under the color demand based on a chromaticity equation and a color tolerance equation of the CIE standard chromaticity system. In a standard chromaticity curve, the processor may obtain a tangent to the chromaticity coordinate range V2 of the display light under the color demand by graphing based on the chromaticity coordinate in the chromaticity coordinate range V1 corresponding to the light-transmitting plate. The processor may determine a region enclosed by the tangent line and a spectral trace line as a chromaticity coordinate range V3 corresponding to the light source under the color demand.

In some embodiments, the processor may calculate or derive the light-emitting parameter of the light source based on the generation relationship between the chromaticity parameter, the light-transmitting parameter, and the light-emitting parameter of the light source to achieve adjustment of the light by the dimming device.

The generation relationship may be used to describe a relationship between the chromaticity parameter, the light-transmitting parameter, and the light-emitting parameter. In some embodiments, the generation relationship may be represented in a plurality of forms. For example, the generation relationship may be represented as mathematical models such as a predetermined correspondence, a function, a set of equations, etc., between the chromaticity parameter, the light-transmitting parameter, and the light-emitting parameter.

In some embodiments, the chromaticity parameter of the display light, the light-transmitting parameter of the light-transmitting plate, and the light-emitting parameter of the light source may be represented by the chromaticity coordinate. The chromaticity coordinates corresponding to the display light refers to a coordinate point in V2. The chromaticity coordinates corresponding to the light-transmitting plate refers to a coordinate point in V1. The chromaticity coordinates corresponding to the light source refers to a coordinate point in V3. The generation relationship refers to a correspondence between the chromaticity coordinates corresponding to the display light, the chromaticity coordinates corresponding to the light-transmitting plate, and the chromaticity coordinates corresponding to the light source. Descriptions regarding V1, V2, and V3 may be found in FIG. 2 and related descriptions thereof.

In some embodiments, the processor may jointly determine the generation relationship based on the generation results at different wavelengths. For example, the processor may use a function, a set of equations, mathematical models, etc., between the generation results corresponding to the plurality of wavelengths as the generation relationship.

In some embodiments, the processor may select a plurality of different wavelengths within the range of the wavelength. In some embodiments, the range of the wavelength may be a range of a visible light wavelength. In some embodiments, the different wavelengths (the range of the visible light wavelength) may be within a range of 380 nm-780 nm, etc. The range of the wavelength may be set according to actual needs. The present disclosure takes different wavelengths (the range of the visible light wavelength range) within a range of 380 nm-780 nm for example.

In some embodiments, the generation results correlate a derivative of the light-transmitting parameter and the light-emitting parameter. The derivative of the light-transmitting parameter may be a derivative function obtained by, as a function of the light-transmitting parameter relative to the wavelength, performing a first-order derivation of the wavelength or a second-order derivation of the wavelength, etc.

The generation results refer to results at different wavelengths associated with chromaticity coordinate data. For example, the generation results may include related data of the chromaticity coordinates corresponding to the light-transmitting plate at different wavelengths, related data of the chromaticity coordinates corresponding to the light source at different wavelengths, related data of the chromaticity coordinates in the CIE standard chromaticity system at different wavelengths, etc.

In some embodiments, the processor may determine the generation results in a plurality of manners based on the derivative of the light-transmitting parameter and the light-emitting parameter. For example, the processor may determine the generation results based on the derivative of the light-transmitting parameter and the light-emitting parameter via a predetermined algorithm or a predetermined rule. The predetermined algorithm or the predetermined rule may be set manually based on requirements. For example, the predetermined rule may be that when a point corresponding to a display light coordinate is an isoenergetic white light point, the processor may determine the generation results based on the derivative of the light-transmitting parameter and the light-emitting parameter by graphing.

In some embodiments, the processor may determine a first derivative function based on the first chromaticity wavelength function of the light-transmitting plate, determine a second derivative function based on a color match function, determine a third derivative function based on the chromaticity parameter, the first derivative function, the second derivative function, and the wavelength spacing, and determine the generation results at different wavelengths based on the first derivative function, the second derivative function, and the third derivative function.

The first chromaticity wavelength function refers to a function between the corresponding chromaticity coordinate of the light-transmitting plate and the wavelength. For example, the first chromaticity wavelength function may be expressed as xᵢ(λ) and yᵢ(λ). In some embodiments, the processor may obtain the first chromaticity wavelength function from the transmittance function using the stimulus equation and the color matching function of the CIE standard chromaticity system. More descriptions regarding the transmittance function, the stimulus equation, and the color matching function may be found in the related description of FIG. 2 hereinabove.

The first derivative function refers to a derivative function of the first chromaticity wavelength function. The derivative function of the first chromaticity wavelength function may include a portion obtained by taking derivative of the first chromaticity wavelength function, and other portions may be included in the derivative function of the first chromaticity wavelength function.

In some embodiments, the first derivative function may include the second-order derivative function relative to the wavelength. The first derivative function may include a portion of a twice derivative of the first chromaticity wavelength function. In some embodiments, the first derivative function may be expressed as x″ᵢ(λ) and y″ᵢ(λ).

The color matching function refers to a chromaticity-wavelength function of the display light in the CIE standard chromaticity system. For example, the color matching function may be expressed as x̅(λ) and y̅(λ) in the tri-stimulus value function in the CIE standard chromaticity system.

The second derivative function refers to a derivative function of the color matching function. The derivative function of the color matching function may include a portion obtained by taking derivative of the color matching function, and other portions may be included in the derivative function of the color matching function.

In some embodiments, the second derivative function may include the first-order derivative function relative to the wavelength.

In some embodiments, the second derivative function may include a portion of a single derivative of the color matching function. The second derivative function may be expressed as x̅′(λ) and y̅′(λ).

The wavelength spacing refers to a gradient value that divides the wavelength. For example, the wavelength spacing may be 1 nm, 2 nm, 5 nm, etc. The wavelength spacing may be set according to actual needs. Exemplarily, when the wavelength spacing is 5 nm, the corresponding wavelength may be divided into [380 nm, 385 nm, 390 nm, . . . , 775 nm. 780 nm].

The third derivative function refers to a derivative function of an objective function relative to the wavelength. The derivative function of the objective function may include a derived portion and other portions. In some embodiments, the third derivative function may include the second-order derivative function relative to the wavelength. In some embodiments, the third derivative function may be expressed as m″ᵢ(λ) and n″ᵢ(λ). The objective function refers to a function between the chromaticity coordinate corresponding to the light source and the wavelength. The objective function may be expressed as mᵢ(λ), nᵢ(λ).

In some embodiments, the processor may determine the third derivative function by calculation based on the chromaticity parameter, the first derivative function, the second derivative function, and the wavelength spacing. In some embodiments, the third derivative function may be positively correlated with the chromaticity parameter and the second derivative function, and negatively correlated with the first derivative function and the wavelength spacing. The processor may obtain the third derivative function by calculation based on equation (2-1) and equation (2-2).

$$u = \frac{1}{2} {\sum }_{380}^{780} \frac{{x}_{i}^{″} ( λ ) {m}_{i}^{″} ( λ )}{{\overline{x}}^{′} ( λ )} Δ λ \qquad ( 2 - 1 )$$

$$v = \frac{1}{2} {\sum }_{380}^{780} \frac{{y}_{i}^{″} ( λ ) {n}_{i}^{″} ( λ )}{{\overline{y}}^{′} ( λ )} Δ λ \qquad ( 2 - 2 )$$

(u, v) denotes the chromaticity coordinate of the display light, x″ᵢ(λ) and y″ᵢ(λ) denote the first derivative function, x̅′(λ) and y̅′(λ) denote the second derivative function, and m″ᵢ(λ) and n″ᵢ(λ) denote the third derivative function, and Δλ denotes the wavelength spacing. With the above-described chromaticity coordinate of the display light, the first derivative function, the second derivative function, and the wavelength spacing being known, the processor may obtain the third derivative function by calculation based on the equation. In some embodiments, the processor may take the above equations as generation relationships.

In some embodiments, the processor may make a plurality of variations of equation (2-1) and equation (2-2). For example, equation (2-1) and equation (2-2) may also include other forms. Exemplarily, equation (2-1) and equation (2-2) may be varied to be cumulative calculations when the wavelength spacing changes. As another example, equation (2-1) and equation (2-2) may be varied in other ways, etc.

In some embodiments, the processor may determine the generation results at different wavelengths by calculations based on the first derivative function, the second derivative function, and the third derivative function. For example, the generation results include a second-order derivative of a function between a chromaticity coordinate corresponding to the light-transmitting plate and a wavelength at different wavelengths, a second-order derivative of a function between a chromaticity coordinate corresponding to the light source and a wavelength at different wavelengths, and a first-order derivative of the color matching function at different wavelengths.

In some embodiments, the generation relationship may include a correspondence between the chromaticity coordinate of the display light, the chromaticity coordinate of the light-transmitting plate, and the chromaticity coordinate of the light source.

In some embodiments of the present disclosure, the chromaticity coordinate of the light source may be obtained by calculation, and thus the generation relationship may be obtained, which may make the adjustment of the light-emitting parameter of the light source more rapid and precise.

In 220, the at least one light-emitting parameter may be determined based on the generation relationship.

In some embodiments, the processor may determine the light-emitting parameter in a plurality of different manners based on the generation relationship. For example, the processor may construct a spectrum based on the generation relationship and determine the light-emitting parameters at different wavelengths based on the spectrum.

In some embodiments, the processor may perform two indefinite integrations on the third derivative function to obtain the objective function. The objective function refers to a function between the chromaticity coordinate corresponding to the light source and the wavelength. The processor may determine a chromaticity coordinate corresponding to the light source at a certain wavelength based on the objective function, e.g., the chromaticity coordinate is (mᵢ, nᵢ). The processor may determine the light-emitting parameters of the light source based on the chromaticity coordinate corresponding to the light source.

In some embodiments, for a determined wavelength, the processor may calculate, based on the above equations (2-1) and equations (2-2) as well as the chromaticity coordinates corresponding to the display light and the wavelength, using the first derivative function, the second derivative function, and the third derivative function, respectively, to obtain a first function value of the first derivative function, a second function value of the second derivative function, and a third function value of the third derivative function. The processor may determine the chromaticity coordinate corresponding to the light source at a certain wavelength based on the chromaticity coordinate corresponding to the display light, the first function value, the second function value, the third function value, the wavelength spacing, etc. The processor may determine the light-emitting parameter of the light source based on the chromaticity coordinate corresponding to the light source. Based on the same manner, the processor may calculate chromaticity coordinates corresponding to the light source at other wavelengths, thereby determining light-emitting parameters of the light source at other wavelengths.

In some embodiments, the processor may also determine the light-emitting parameters of the light source in any other feasible manner.

In some embodiments, the processor may adjust the light-emitting parameter of the light source to adjust the chromaticity coordinates corresponding to the light source to be (mᵢ, nᵢ). Thus, a display light displayed on a display surface of the light-transmitting plate having chromaticity coordinates (xᵢ, yᵢ) transmitted by the light source may be in a chromaticity coordinate region V2 corresponding to the display light, or a display light having a chromaticity coordinate (u, v) may be displayed.

In 230, the light-emitting instruction may be determined based on the at least one light-emitting parameter.

The light-emitting instruction refers to a control instruction for adjusting the light source. For example, the light-emitting instruction may include a control instruction for adjusting the decrease or increase of the brightness, the light-emitting intensity, etc. of the light source.

In some embodiments, the processor may generate the light-emitting instruction based on the light-emitting parameter. In some embodiments, the processor may adjust the light source based on the light-emitting instruction.

In some embodiments of the present disclosure, the generation relationship may be jointly determined based on the generation results at different wavelengths. Based on the generation relationship, the light-emitting parameter may be determined, and based on the light-emitting parameter, the light-emitting instruction may be determined. The above method may convert different needs of the user into control instructions for the light source, and accurately regulate the light source, so as to realize the regulation of the display light, so as to satisfy the user's needs for different light in different scenes.

It should be noted that the foregoing description of the process 200 is intended to be exemplary and illustrative only and does not limit the scope of application of the present disclosure. For those skilled in the art, various corrections and changes may be made to the process 200 under the guidance of the present disclosure. However, these corrections and changes remain within the scope of the present disclosure.

FIG. 3 is a schematic diagram illustrating an exemplary light-emitting device according to some embodiments of the present disclosure.

As shown in FIG. 3 the light-emitting device 300 may include the light source 310 and the light-transmitting plate 320.

More descriptions regarding the light source and the light-transmitting plate may be found in FIG. 1 and related descriptions thereof.

In some embodiment, the light source 310 may be configured to emit light to a non-display surface of a light-transmitting plate that satisfies a light-transmitting condition so that a display surface of the light-transmitting plate displays a display light that satisfies a display condition.

In some embodiments, the light-transmitting condition may include a chromaticity coordinate range corresponding to the light-transmitting plate. The chromaticity coordinate range corresponding to the light-transmitting plate refers to a chromaticity coordinate region where a transmitted light of a CIE standard illuminant passing through the light-transmitting plate is rendered in a CIE standard chromaticity system.

In some embodiments, the display condition may include a chromaticity coordinate range of the display light. The chromaticity coordinate range of the display light refers to a chromaticity coordinate range required by the display light to display a transmitted light in a target color.

In some embodiments, the light source 310 may satisfy that a chromaticity coordinate range corresponding to the light source is a chromaticity coordinate range of the light source for displaying the display light, and a light color adjustment range corresponding to the light source is a spectrum adjustment range of the light source for displaying the display light.

In some embodiments, a spectrum of the light source may include one or more intrinsic peaks. More descriptions regarding the one or more intrinsic peaks may be found in FIG. 1 and related descriptions thereof.

In some embodiments, a light-emitting component of the light source may be a lighting component.

The lighting component refers to a light-emitting component that only emits light of a specific wavelength. The lighting component may include one or more primary color lamps. A lighting component that includes only one primary color lamp is a monochromatic lighting component.

The primary color lamp refers to a light-emitting component used to display a light in a specific color. For example, red LED lamps, green LED lamps, blue LED lamps, etc.

In some embodiments, the monochromatic lighting component may include one primary color lamp, and an intrinsic peak of a spectrum of the light source may be within a range of 440 nm-485 nm. The lighting unit may stably provide a required lighting light, with stable performance, which is economical and durable.

In some embodiments, the monochromatic lighting component may include two primary color lamps, the intrinsic peaks of the spectrum of the light source may be within a range of 440 nm-495 nm and a range of 520 nm-570 nm, respectively, and the primary color lamp with the intrinsic peak within the range of 440 nm-495 nm is dominant. The lighting unit may provide more stable lighting light through color complementary in response to a wavelength shift caused by long-term use of a single primary color LED lamp.

In some embodiments, the light-emitting component of the light source may be a monochromatic lighting component. The monochromatic lighting component may include three primary color lamps, and the intrinsic peaks of the spectrum of the light source may be within a range of 440 nm-495 nm, a range of 495 nm-520 nm, and a range of 520 nm-570 nm, respectively, and the primary color lamp with the intrinsic peak within the range of 440 nm-495 nm may be dominant. The lighting unit may not only solve the problem of narrow color adjustment range of the single primary color lamp and the two primary color lamps, but also reduce the performance requirements for a blue band primary color lamp, which is conducive to long-term use, and may broaden the color gamut of display, thereby providing new application directions for the next generation of aviation displays.

In some embodiments, the light-emitting device 300 may be a light-emitting device facing a limited condition. In some embodiments, the light-emitting device 300 may include the dimming device 100. The dimming device 100 may be a part of the light-emitting device 300.

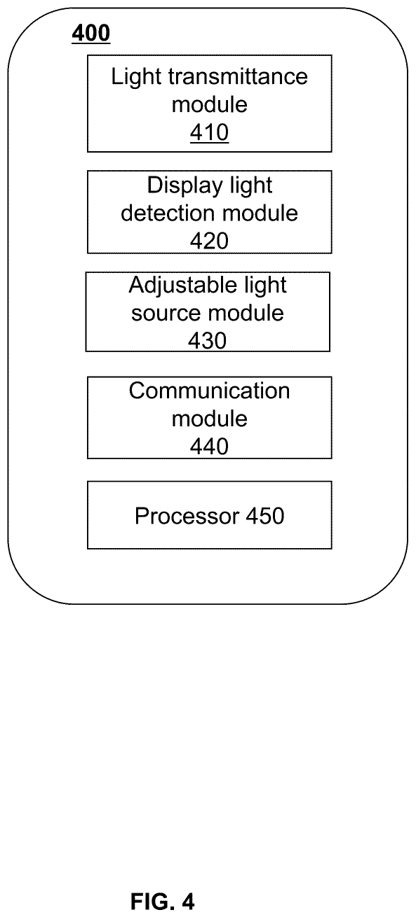

FIG. 4 is a schematic diagram illustrating an exemplary system for designing a light source according to some embodiments of the present disclosure.

In some embodiments, the system 400 for designing the light source may include a light transmittance module 410, a display light detection module 420, an adjustable light source module 430, a communication module 440, and a processor 450.

In some embodiments, the light transmittance module 410 may be configured to adjust at least one light-transmitting parameter of a light-transmitting plate. In some embodiments, the light-transmitting parameter(s) may include a light transmittance. More descriptions regarding the light-transmitting plate, the light-transmitting parameter, and the light transmittance may be found in FIG. 1-FIG. 2 and the related description thereof.

In some embodiments, the display light detection module 420 may be configured to detect a display light.

The display light detection module 420 may detect parameters related to the display light, etc. The parameters related to the display light may include a brightness, a light-emitting intensity, at least one chromaticity parameter, etc. of the display light. More descriptions regarding the display light may be found in FIG. 1-FIG. 2 and related descriptions thereof.

In some embodiments, the adjustable light source module 430 may be configured to adjust the light source. The adjustable light source module 430 may adjust the at least one light-emitting parameter of the light source based on a light-emitting instruction sent by the processor 450. More descriptions regarding the light source, the light-emitting instruction, and the light-emitting parameter may be found in FIG. 1 and related descriptions thereof.

In some embodiments, the communication module 440 refers to a module that may be configured to enable communicative connections between different components or modules. In some embodiments, the communication module 440 may be configured to enable a communication connection between the light-transmitting module 410, the display light detection module 420, the adjustable light source module 430, and the processor 450.

In some embodiments, the processor 450 may be configured to process information and/or data related to the system 400 for designing the light source to perform one or more of the functions described in the present disclosure.

In some embodiments, the processor 450 may be configured as a combination of one or more of a microcontroller (MCU), an embedded processor, a graphics processing unit (GPU), etc.

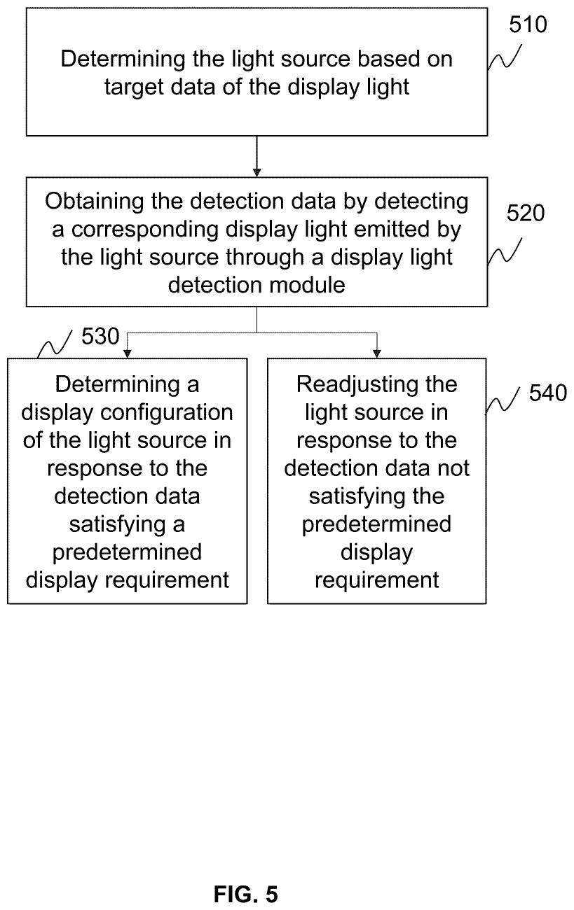

In some embodiments, the processor 450 may be configured to determine the light source based on target data of the display light; obtain detection data by detecting, through the display light detection module, a corresponding display light emitted by the light source; determine a display configuration of the light source in response to determining that the detection data satisfies a predetermined display requirement; or readjust the light source in response to determining that the detection data does not satisfy the predetermined display requirement. More descriptions regarding the above may be found in FIG. 5 and related descriptions thereof.

FIG. 5 is a flowchart illustrating an exemplary process for designing a light source according to some embodiments of the present disclosure. As shown in FIG. 5, process 500 includes the following steps. In some embodiments, process 500 may be executed by processor 450.

As shown in FIG. 5, the processor 450 may design the light source based on steps 510 to 540.

In 510, the light source may be determined based on target data of a display light.

The target data refers to at least one parameter related to the display light that needs to be obtained. For example, the target data may include at least one chromaticity parameter in a dimming instruction, etc. In some embodiments, the processor 450 may determine the at least one light-emitting parameter of the light source based on the target data through a generation relationship. More descriptions regarding the display light, the dimming instruction, the generation relationship, the light-emitting parameter, etc. may be found in the related descriptions of FIG. 1-FIG. 2.

In 520, the detection data by detecting, through a display light detection module, a corresponding display light emitted by the light source may be obtained.

The detection data refers to data related to the display light detected by the display light detection module. For example, the detection data may include at least one chromaticity parameter of the display light, a light-emitting intensity, brightness, etc. More descriptions regarding the chromaticity parameter of the display light, the light-emitting intensity, the brightness, etc. may be found in FIG. 1- FIG. 2 and related descriptions thereof.

In 530, a display configuration of the light source may be determined in response to determining that the detection data satisfies a predetermined display requirement.

The predetermined display requirement may be manually preset. For example, the predetermined display requirement may be that a difference between the detection data and target data is less than a preset threshold. The preset threshold may be set according to requirements.

In some embodiments, the processor may use the light-emitting parameter corresponding to the light source whose difference between the detection data and the target data is less than the preset threshold as the display configuration of the light source.

In 540, the light source may be readjusted in response to determining that the detection data does not satisfy the predetermined display requirement.

In some embodiments, when the detection data does not satisfy the predetermined display requirement, the processor may readjust a corresponding light-emitting parameter of the light source and repeat operations 510-540 until the detection data satisfies the predetermined display requirement.

In some embodiments of the present disclosure, a system and a method for designing a light source enables precise control and adjustment of the light source to meet specific display requirements and scene needs. With the detection data and the support of the communication module, the processor may dynamically adjust the display configuration of the light source to ensure that the display light satisfies the predetermined requirement.

Some embodiments of the present disclosure provide the system for designing the light source including the processor and the light source. More descriptions regarding the light source may be found in FIG. 1 and related descriptions thereof. More descriptions regarding the processor may be found in FIG. 4 and related descriptions thereof.

In some embodiments, the processor may be configured to determine the light source based on the target data of the display light; obtain the detection data by detecting, through the display light detection module, a corresponding display light emitted by the light source; determine the display configuration of the light source in response to determining that the detection data satisfies the predetermined display requirement; and readjust the light source in response to determining that the detection data does not satisfy the predetermined display requirement. More descriptions may be found in related descriptions in FIG. 5.

Some embodiments of the present disclosure provide a method for designing a light source, the method may be executed by the processor. The processor may determine the light source based on the target data of the display light; obtain the detection data by detecting, through the display light detection module, the corresponding display light emitted by the light source; determine the display configuration of the light source in response to determining that the detection data satisfies the predetermined display requirement; and readjust the light source in response to determining that the detection data does not satisfy the predetermined display requirement. More descriptions may be found in FIG. 5 and related descriptions thereof.

The present disclosure utilizes a light color adjustment technique for white light color development of a display component composed of a microcrystalline glass panel and a light source, which relates to the fields including a color mixing adjustment technique in photometry, a spectral analysis technique, and a white display technique and the application fields including but not limited to stove top display, curtain wall display, aerospace display, etc.

Microcrystalline glass is widely used in fields such as aerospace, architectural decoration, furniture life, consumer electronics, etc. for its excellent characteristics including high hardness, corrosion resistance, compression resistance, impact resistance, non-absorbent, less dust, non-radiation, etc. A display device of microcrystalline glass panel used in building decoration and furniture life appliances is often composed of dark or brown low-transparent coloring microcrystalline glass panel sheet (substrate) and a signal lamp (light source). The microcrystalline glass panel paired with the signal lamp often serves as a display panel. The signal lamp informs the user about an operating status (on, standby, normal, abnormal, etc.), operating hours, and operating mode through the display panel. In a display device (stove top, freezer, etc.) of the furniture life, a small LED digital tube is often used as a lamp. In an architectural curtain wall display, an LED panel, a fluorescent lamp, or a quantum dot panel are often used as the lamp. Since the microcrystalline glass panel has a visible light cutoff filtering property, only red light and infrared light may be transmitted through the display panel, making it difficult to satisfy diverse display needs of users.

As the most difficult color in modern displays, white often requires the use of three primary colors of red, green, and blue mixed in equal proportions. For the microcrystalline glass panel, it is even more difficult to display white.

In some embodiments of the present disclosure, a white light color rendering device based on the microcrystalline glass panel and a method for adjusting a light color thereof are provided. The display device may be used in a simple and reliable implementation form to enhance a power of the light transmitting through the microcrystalline glass panel, which maximizes an intensity and a spectral efficiency of a light tool and make the light tool display white light, thereby solving the technical problems in the prior art that the color is dim and the cost is high by adding an optical compensator such as a filter or a filter film between the light source and the microcrystalline glass panel.

Some embodiments of the present disclosure provide the white light color rendering device based on the microcrystalline glass panel, which may include the microcrystalline glass panel and the light source. The microcrystalline glass panel may have a display surface and a non-display surface. The light source may be located on a side of the non-display surface of the microcrystalline glass panel, and the light source displays white light on the display surface of the microcrystalline glass panel. A chromaticity coordinate region W1 presented by a transmitted light of a CIE standard illuminant through the microcrystalline glass panel in the CIE standard chromaticity system is determined by the following coordinates:

TABLE 1
Chromaticity coordinate region W1 presented by transmitted
light of microcrystalline glass panel

| x | y |
|---|---|
| 0.68 | 0.31 |
| 0.71 | 0.29 |
| 0.65 | 0.34 |
| 0.63 | 0.36 |
| 0.61 | 0.38 |
| 0.56 | 0.2 |
| 0.58 | 0.4 |
| 0.54 | 0.42 |
| 0.36 | 0.34 |
| 0.28 | 0.24 |

In some embodiments, the light source may transmit light through the microcrystalline glass panel to display white light, and a white chromaticity coordinate region W2 may be obtained according to a CIE whiteness equation as well as a color tolerance equation, which is determined by the following coordinates:

TABLE 2
White chromaticity coordinate region W2
of the white light color rendering device

| Color temperature | Color coordinates x | Color coordinates y |
|---|---|---|
| 4200 | 0.40 | 0.49 |
| 4950 | 0.36 | 0.49 |
| 6030 | 0.31 | 0.49 |
| 7150 | 0.27 | 0.47 |
| 9000 | 0.23 | 0.43 |
| 12570 | 0.19 | 0.39 |
| 21270 | 0.17 | 0.34 |
| ∞ | 0.15 | 0.29 |
| ∞ | 0.13 | 0.23 |
| ∞ | 0.13 | 0.19 |
| ∞ | 0.14 | 0.15 |
| ∞ | 0.17 | 0.12 |
| ∞ | 0.21 | 0.13 |
| ∞ | 0.26 | 0.16 |
| ∞ | 0.30 | 0.18 |
| 11730 | 0.33 | 0.19 |
| 2220 | 0.37 | 0.22 |
| 1810 | 0.42 | 0.25 |
| 1670 | 0.48 | 0.29 |
| 1670 | 0.51 | 0.33 |
| 1780 | 0.53 | 0.38 |
| 1880 | 0.54 | 0.41 |
| 2430 | 0.50 | 0.44 |
| 3130 | 0.46 | 0.47 |

In some embodiments, the microcrystalline glass panel may have an average transmittance of no more than 7% within a visible spectrum range of 380 nm-780 nm.

In some embodiments, the spectrum of the light source may have 1-4 intrinsic peaks.

In some embodiments, the light source constitutes a light-emitting component, including one of an LED component, a fluorescent component, and a quantum dot component.

Some embodiments of the present disclosure provide a method for adjusting a light color of a white light color rendering device based on a microcrystalline glass panel. The method may include adjusting at least one optical parameter of the light source, the at least one optical parameter including an intensity and a full width at half maxima of a main wavelength spectrum, to adjust a spectral coverage range, so that a light emitted by the light source may be transmitted through the microcrystalline glass panel and display a white light in the white chromaticity coordinate region W2. More descriptions regarding the full width at half maxima of the main wavelength spectrum may be found in FIG. 21 and related descriptions thereof.

In some embodiments, the method may be based on a law of complementary colors of Grassman's color mixing theory, and specifically include steps S1-S3.

In S1, a transmittance function φᵢ(λ) of the microcrystalline glass panel is measured in a photometric, where i is a serial number of the microcrystalline glass panel, and a corresponding chromaticity region W1 of the microcrystalline glass panel is obtained based on the stimulus equation and the color matching function of the CIE standard chromaticity system; the equations used herein are similar to the equations (1-1)-(1-7) in FIG. 2, with the difference that, for the microcrystalline glass panel, Xᵢ, Yᵢ, and Zᵢ denote tri-stimulus values of the microcrystalline glass panel, xᵢ, yᵢ, and zᵢ denote chromaticity coordinates of the microcrystalline glass panel, x̅(λ), y̅(λ), and z̅(λ) denote functions of the tri-stimulus values in a CIE 1931 standard chromaticity observing system, Δλ denotes the wavelength spacing, and λ denotes the wavelength. φᵢ(λ) denotes the transmittance function of the microcrystalline glass panel, and i denotes the serial number of the microcrystalline glass panel.

In some embodiments, for any microcrystalline glass panel chromaticity coordinate in a chromaticity region W1 corresponding to the microcrystalline glass panel, a tangent line to the white chromaticity coordinate region W2 may be made through a point of the microcrystalline glass panel chromaticity coordinate. A region surrounded by the tangent line and the spectral trace line may be a light source chromaticity coordinate range W3 of the white light color rendering device.

In S2, a white chromaticity coordinate point (u1, v1) is selected in the white chromaticity coordinate region W2, and it is known that the chromaticity coordinates of the microcrystalline glass panel are (xᵢ₁, yᵢ₁), and then chromaticity coordinates (mᵢ₁, nᵢ₁) of a required light source may be obtained by calculation according to the following equations (2-1) to (2-2). Descriptions regarding equation (2-1) and equation (2-2) may be found in FIG. 2 and related descriptions thereof.

In S3, a light source with chromaticity coordinates of (mᵢ₁, nᵢ₁) is selected in the range of W3, or the chromaticity coordinates of the light source are adjusted to (mᵢ₁, nᵢ₁) by adjusting optical parameters of a light source to make the light emitted by the light source transmit through the display surface of the microcrystalline glass panel having chromaticity coordinates (xᵢ₁, yᵢ₁) and display a white light in the white chromaticity coordinate region W2, or display a white light having white chromaticity coordinates of (u1, v1).

In some embodiments, any point in the chromaticity region W1 corresponding to the microcrystalline glass panel may be selected or the chromaticity coordinates (xᵢ₁, yᵢ₁) of the microcrystalline glass panel may be selected to be connected to an isoenergetic white light point (0.333, 0.333) in a chromaticity coordinate map and make an extension line. A dominant wavelength of a spectral color at any point (except the isoenergetic white light point) on a connection line from an intersection of the extension line and the spectral trace line to the isoenergetic white light point (0.333, 0.333) may be a dominant wavelength of a standard white light complementary color of the light source.

In some embodiments, a light source having a chromaticity coordinate of (mᵢ₁, nᵢ₁) may be selected on the connection line from the intersection of the extension line and the spectral trace line to the isoenergetic white light point (0.333, 0.333). By adjusting the optical parameters of the light source, the chromaticity coordinates of the light source may be adjusted to (mᵢ₁, nᵢ₁), so that the light emitted by the light source may transmit through the display surface of the microcrystalline glass panel having the white chromaticity coordinates (xᵢ₁, yᵢ₁) and display a white light with the white chromaticity coordinates (u1, v1).

In some embodiments of the present disclosure, only the light source and the microcrystalline glass panel are used as the white light color rendering device, through the light color adjustment technique, the spectral efficiency of the light source may be maximized, and a light that transmits through the microcrystalline glass panel may be made to be white. The device is of a simple and reliable structure, without a need for additional shading ink or light filter compensator, which has a simple manufacturing process and a high qualification rate. The device may be suitable for a plurality of application scenarios, especially suitable for white display scenarios of narrow space and high-intensity structures such as white display on the stove surface, aerospace, etc.

In some embodiments of the present disclosure, the spectral efficiency (light intensity, spectral range, full width at half maxima of the main wavelength spectrum) of the light source may be maximally utilized under the same white light color rendering intensity. The white light display device has a low power consumption high adjustability of a white light color temperature, and high color tolerance, which is suitable for a plurality of display scenarios such as a small signal lamp or a display unit. A white region with a color temperature covers from 1670K to positive infinity and a color difference less than 1.5 is provided, which may provide a good display of white under bright and dark illumination (e.g., bright field of view illumination >10 cd/m², dark field of view illumination <1 cd/m²).

The following white light color rendering device based on the microcrystalline glass panel and the light color adjustment method thereof are further described in conjunction with the embodiments and the accompanying drawings, which are not used to limit the protection scope of the present disclosure.

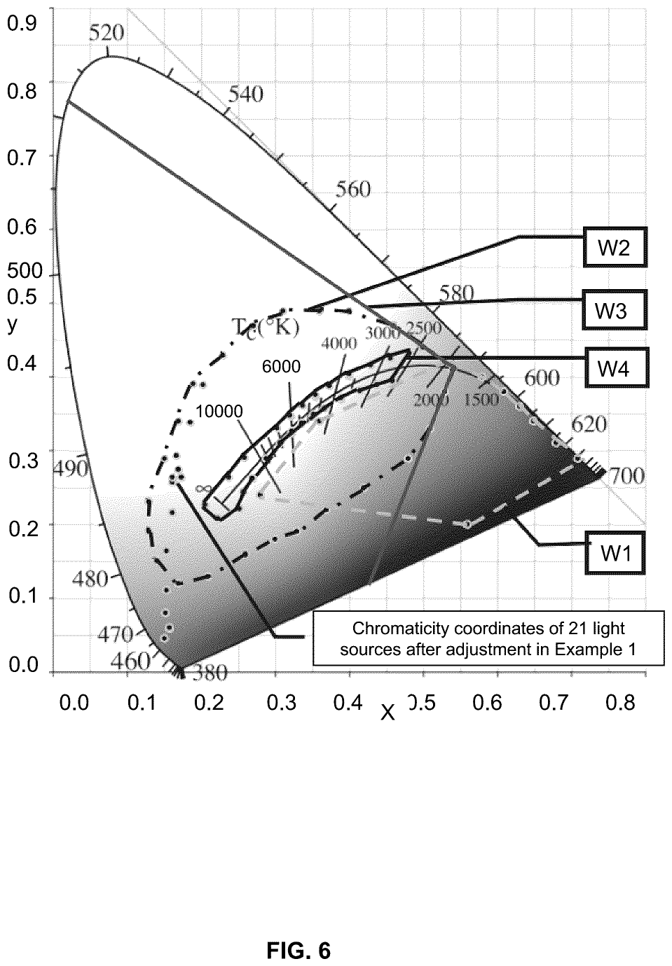

FIG. 6 is a diagram illustrating a region range of W1-W4 in Example 1.

Example 1: The present embodiment uses a light color adjustment technique to display white light on a display component composed of a microcrystalline glass panel and a light source, wherein a chromaticity coordinate of the microcrystalline glass panel is taken as known information, by adjusting optical parameters of the light source to perform a light color adjustment, the light source displays a white light on a display surface of the microcrystalline glass panel, the white light displayed on the display surface is in a white chromaticity coordinate region W2, and a chromaticity coordinate of a light on a side of a non-display surface is an intrinsic chromaticity coordinate of the light source, which is different from the chromaticity coordinate on the display surface.

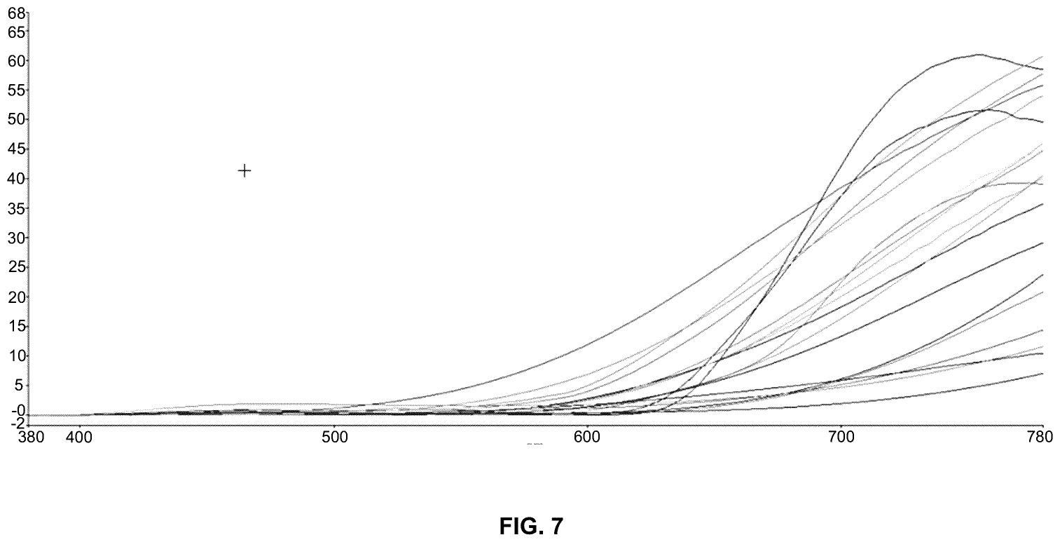

FIG. 7 is a graph illustrating spectral transmittance curves of 21 kinds of glasses in Example 1.

White light color rendering device consists of a light source and a microcrystalline glass panel and chooses the black microcrystalline glass with a visible light transmittance rate of not more than 7% as the display panel. According to a CIE 1931 standard chromaticity observing system, “Specification of Colors” (GB/T3977-2008), “Methods for the Measurement of Object Color” (GB/T3978-2008), “Measurement Method of Object Color” (GB/T3979-2008) and “Determination of Light Transmittance, Solar Direct Transmittance, Total Solar Energy Transmittance, and Ultraviolet Transmittance for Glass in Building and Glazing Factors” (GB/T2680-94), a spectrophotometer may be applied in experimental conditions such as field of view angle being 1°-4°, field of view brightness being greater than 10 cd/m2, etc. to perform spectral characterization on the 21 kinds of microcrystalline glass panels in the example, and transmission spectral power φᵢ(λ) of the microcrystalline glass panels may be obtained, where i=1, 2, 3, . . . , 21, as shown in FIG. 7.

Chromaticity coordinates corresponding to the known microcrystalline glass panels are obtained by applying equations (1-1) to (1-7) according to calculation manners in the above standards, and the chromaticity coordinates are in a chromaticity region W1.

Visible light transmittances and chromaticity coordinates of the 21 kinds of microcrystalline glass panels are as shown in Table 3:

TABLE 3
Visible light transmittances and chromaticity coordinates
of 21 kinds of microcrystalline glass panels

| | Visible light | Chromaticity | Chromaticity |
|---|---|---|---|
| i | transmittance | coordinate xᵢ | coordinate yᵢ |
| 1 | 6.71 | 0.5816 | 0.4005 |
| 2 | 0.69 | 0.6487 | 0.3378 |
| 3 | 1.35 | 0.6466 | 0.3478 |
| 4 | 0.85 | 0.6343 | 0.3585 |
| 5 | 3.69 | 0.6118 | 0.3808 |
| 6 | 1.34 | 0.6537 | 0.342 |
| 7 | 0.98 | 0.5854 | 0.4014 |
| 8 | 0.67 | 0.6801 | 0.3118 |
| 9 | 1.00 | 0.4092 | 0.3395 |
| 10 | 1.73 | 0.3566 | 0.3413 |
| 11 | 0.80 | 0.5927 | 0.3214 |
| 12 | 0.22 | 0.6343 | 0.3355 |
| 13 | 2.47 | 0.5973 | 0.3463 |
| 14 | 1.47 | 0.5791 | 0.3383 |
| 15 | 0.74 | 0.6564 | 0.3409 |
| 16 | 0.34 | 0.32 | 0.28 |
| 17 | 0.09 | 0.651 | 0.2899 |
| 18 | 3.08 | 0.5843 | 0.3458 |
| 19 | 0.95 | 0.64 | 0.3531 |
| 20 | 0.34 | 0.6017 | 0.2286 |
| 21 | 0.46 | 0.6651 | 0.2595 |

It is given that a chromaticity coordinate region of the microcrystalline glass panel is W1, and optical parameters of the light source are adjusted such that the light emitted by the light source transmits through the display surface of the microcrystalline glass panel and generates a light effect in a white chromaticity coordinate region W2.

A white tolerance of the display surface of the microcrystalline glass panel through which the light emitted by the light source transmits is between 0 and 1.5. CIE whiteness calculation equations (3-1) to (3-4) are used, where W denotes a whiteness, T_{w} denotes a light-tone index, Y denotes a stimulus value of a displayed white light, x and y denote chromaticity coordinates of the displayed white light, and xₙ and yₙ denote chromaticity coordinates of a fully diffuse reflector, which are 0.31006 and 0.31615, respectively:

W=Y+800(xₙ−x)+1700(yₙ−y) (3-1)

T_{W}=1000(xₙ−x)−650(yₙ−y) (3-2)

40<W<5Y−280 (3-3)

−4<T_{W}<2 (3-4)

A color temperature Tc is calculated by equation (4-1) and equation (4-2):

$${A}_{c} = \frac{x - 0.329}{y - 0.187} \qquad ( 4 - 1 )$$

$${T}_{C} = 669 {A}_{c}^{4} - 779 {A}_{c}^{3} + 3660 {A}_{c}^{2} - 7047 {A}_{c}^{2} + 5 \; 652 \qquad ( 4 - 2 )$$

wherein Ac denotes a reciprocal of a straight slope of an isochromatic temperature line Tc. Then the white chromaticity coordinate region W2 is obtained, and the light effect produced by the light emitted by the light source and transmitting through the display surface of the microcrystalline glass panel is in the white chromaticity coordinate region W2, which may be determined by coordinates in the following Table 4.

TABLE 4
Chromaticity regions of the white light color rendering device

| | Chromaticity | Chromaticity |
|---|---|---|
| Color temperature | coordinate x | coordinate y |
| 4200 | 0.40 | 0.49 |
| 4950 | 0.36 | 0.49 |
| 6030 | 0.31 | 0.49 |
| 7150 | 0.27 | 0.47 |
| 9000 | 0.23 | 0.43 |
| 12570 | 0.19 | 0.39 |
| 21270 | 0.17 | 0.34 |
| ∞ | 0.15 | 0.29 |
| ∞ | 0.13 | 0.23 |
| ∞ | 0.13 | 0.19 |
| ∞ | 0.14 | 0.15 |
| ∞ | 0.17 | 0.12 |
| ∞ | 0.21 | 0.13 |
| ∞ | 0.26 | 0.16 |
| ∞ | 0.30 | 0.18 |
| 11730 | 0.33 | 0.19 |
| 2220 | 0.37 | 0.22 |
| 1810 | 0.42 | 0.25 |
| 1670 | 0.48 | 0.29 |
| 1670 | 0.51 | 0.33 |
| 1780 | 0.53 | 0.38 |
| 1880 | 0.54 | 0.41 |
| 2430 | 0.50 | 0.44 |
| 3130 | 0.46 | 0.47 |

where a center position of the white chromaticity coordinate region W2 is a chromaticity point of the isoenergetic white light with coordinates (0.3333,0.3333).

According to the American National Standard ANSI NEMA ANSLG C78.377-2008 (Specifications for the Chromaticity of Solid State Lighting Products), a chromaticity coordinate region W4 of optimal white color rendering, with a white color temperature from 2700 k to ∞, is selected from the above white chromaticity coordinate region W2, as shown in Table 5, and a corresponding white chromaticity coordinate region map thereof is as shown in FIG. 6.

TABLE 5
Chromaticity coordinate region of optimal color rendering
for the white light color rendering device

| | |
|---|---|
| Color | Chromaticity coordinates |

| temperature | | x | y |
|---|---|---|---|
| 2700 K | Center value | 0.4578 | 0.4101 |
| | Tolerance | 0.4813 | 0.4319 |
| | | 0.4562 | 0.4260 |
| | | 0.4373 | 0.3893 |
| | | 0.4593 | 0.3944 |
| 3000 K | Center value | 0.4338 | 0.4030 |
| | Tolerance | 0.4562 | 0.4260 |
| | | 0.4299 | 0.4165 |
| | | 0.4147 | 0.3814 |
| | | 0.4373 | 0.3893 |
| 3500 K | Center value | 0.4073 | 0.3917 |
| | Tolerance | 0.4299 | 0.4165 |
| | | 0.3996 | 0.4015 |
| | | 0.3889 | 0.3690 |
| | | 0.4147 | 0.3814 |
| 4000 K | Center value | 0.3818 | 0.3797 |
| | Tolerance | 0.4006 | 0.4044 |
| | | 0.3736 | 0.3874 |
| | | 0.3670 | 0.3578 |
| | | 0.3898 | 0.3716 |
| 4500 K | Center value | 0.3611 | 0.3658 |
| | Tolerance | 0.3736 | 0.3874 |
| | | 0.3548 | 0.3736 |
| | | 0.3512 | 0.3465 |
| | | 0.3670 | 0.3578 |
| 5000 K | Center value | 0.3447 | 0.3553 |
| | Tolerance | 0.3551 | 0.3760 |
| | | 0.3376 | 0.3616 |
| | | 0.3366 | 0.3369 |
| | | 0.3515 | 0.3487 |
| 5700 K | Center value | 0.3287 | 0.3417 |
| | Tolerance | 0.3376 | 0.3616 |
| | | 0.3207 | 0.3462 |
| | | 0.3222 | 0.3243 |
| | | 0.3366 | 0.3369 |
| 6500 K | Center value | 0.3123 | 0.3282 |
| | Tolerance | 0.3205 | 0.3481 |
| | | 0.3028 | 0.3304 |
| | | 0.3068 | 0.3113 |
| | | 0.3221 | 0.3261 |
| 6500 K-∞ | Tolerance | 0.2886 | 0.2887 |
| | | 0.2696 | 0.2629 |
| | | 0.2576 | 0.2439 |
| | | 0.2524 | 0.2215 |
| | | 0.2231 | 0.2078 |
| | | 0.2593 | 0.2905 |
| | | 0.2369 | 0.2646 |
| | | 0.2059 | 0.2267 |

Based on the chromaticity coordinate region W4 of optimal white color rendering and the intrinsic chromaticity coordinate value of the glass, the chromaticity coordinate range of the LED is obtained as shown in FIG. 6 and as shown in Table 6.

TABLE 6
Chromaticity coordinates of 21 kinds of LED

| i | Chromaticity coordinate xᵢ | Chromaticity coordinate yᵢ |
|---|---|---|
| 1 | 0.1506 | 0.0450 |
| 2 | 0.1508 | 0.0449 |
| 3 | 0.1508 | 0.0794 |
| 4 | 0.1524 | 0.0794 |
| 5 | 0.1534 | 0.1106 |
| 6 | 0.1538 | 0.1634 |
| 7 | 0.1572 | 0.0593 |
| 8 | 0.1607 | 0.2643 |
| 9 | 0.1610 | 0.2578 |
| 10 | 0.1610 | 0.2578 |
| 11 | 0.1618 | 0.2157 |
| 12 | 0.1631 | 0.2576 |
| 13 | 0.1661 | 0.2932 |
| 14 | 0.1661 | 0.2932 |
| 15 | 0.1662 | 0.2568 |
| 16 | 0.1699 | 0.2742 |
| 17 | 0.1738 | 0.2637 |
| 18 | 0.1856 | 0.3393 |
| 19 | 0.1856 | 0.3393 |
| 20 | 0.1822 | 0.3047 |
| 21 | 0.2027 | 0.3897 |

Chromaticity coordinates of the microcrystalline glass panel are selected in the chromaticity coordinate region W1 corresponding to the microcrystalline glass panel, and the chromaticity coordinates are tangent with the white chromaticity region W2 to obtain a maximal intersecting region range W3, that is, a chromaticity coordinate range of the light color adjustment of the light source.

A white color with a certain color difference is obtained by using a dominant wavelength or a complementary color wavelength to perform color complementary in a chromaticity ring. The intrinsic chromaticity coordinate of the light source is corrected by a light source controller to be within the maximum intersecting region range W3 such that the light effect produced by the light source transmitting through the display surface of the microcrystalline glass panel is in a required specified white chromaticity coordinate region W2.

A light source is selected in the maximal intersecting region range W3, and the chromaticity coordinate of the light source is measured. The chromaticity coordinate may make the light effect produced by the light source transmitting through the display surface of the microcrystalline glass panel in the required specified white chromaticity coordinate region W2.

In addition, preferably, any point in the chromaticity region W1 corresponding to the microcrystalline glass panel may be selected or the chromaticity coordinates of the microcrystalline glass panel may be selected to be connected to an isoenergetic white light point (0.333, 0.333) in a chromaticity coordinate map and make an extension line. A dominant wavelength of a spectral color at any point (except the isoenergetic white light point) on a connection line from an intersection of the extension line and the spectral trace line to the isoenergetic white light point (0.333, 0.333) may be a dominant wavelength of a standard white light complementary color of the light source.

The chromaticity coordinate of the light source is selected on the connection line from the intersection of the extension line and the spectral trace line to the isoenergetic white light point (0.333,0.333), and the optical parameters of the selected light source are adjusted. Thus, the light emitted by the light source may transmit through the display surface of the microcrystalline glass panel and display a white light having a specified white chromaticity coordinate on the display surface.

Example 2: The embodiment changes a light intensity ratio of RGBA trichromatic lamp beads, thereby changing a color position when the device renders the color such that the light emitted by four intrinsic peak light sources may transmit through the display surface of the microcrystalline glass panel and display a white light on the display surface.

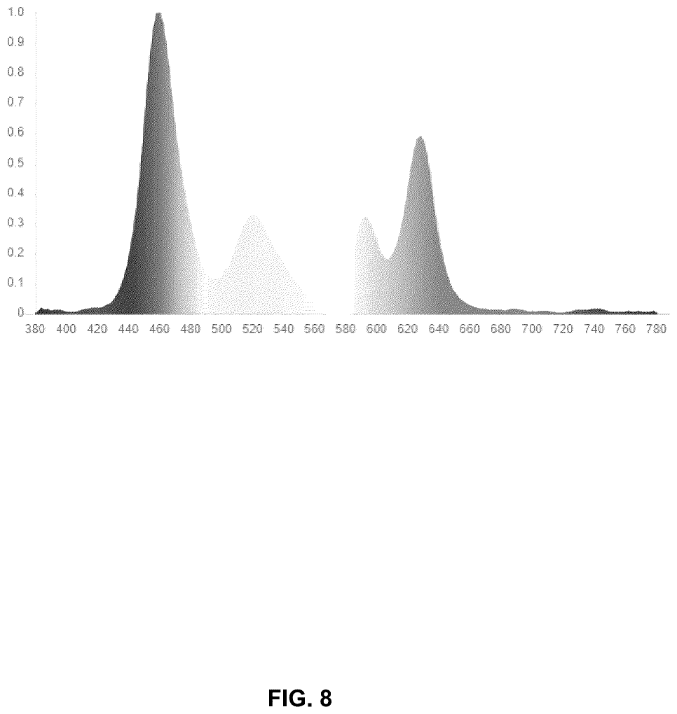

FIG. 8 is a diagram illustrating a spectral distribution of RGBA tetrachromatic lamp beads at equal power in Example 2.

In example 2, a white light color rendering device based on a microcrystalline glass panel and an RGBA tetrachromatic LED light source is provided. The light emitted by the RGBA tetrachromatic LED light source may transmit through the microcrystalline glass panel and a white light may be displayed by adjusting a light intensity ratio of the RGBA tetrachromatic LED light source. The device includes a microcrystalline glass panel and a light source composed of RGBA tetrachromatic LED lamp beads. The microcrystalline glass panel has a display surface, and the light source is located on a side of a non-display surface of the microcrystalline glass panel. A spectrum of the light source under equal power is shown in FIG. 8, and the chromaticity coordinates thereof are (0.2941, 0.2363).

The spectrum of the light source has four intrinsic peaks, each of which corresponds to a light-emitting lamp bead, where a characteristic peak of a red R lamp bead (a dominant wavelength) is 628 nm, a full width at half maxima thereof is within a range of 618 nm-637 nm, a total covering range thereof is 19 nm, and a color position corresponding to a maximum light intensity thereof is (0.6852, 0.3088). A characteristic peak of a green G lamp bead (the dominant wavelength) is 520 nm, a full width at half maxima thereof is within a range of 504 nm-540 nm, a total covering range thereof is 36 nm, and a color position corresponding to a maximum light intensity thereof is (0.1783, 0.7207). A characteristic peak of a blue B lamp bead (the dominant wavelength) is 460 nm, a full width at half maxima thereof is within a range of 450 nm-472 nm, a total covering range thereof is 22 nm, and a color position corresponding to a maximum light intensity thereof is (0.1410, 0.0491). A characteristic peak of an amber A lamp bead (the dominant wavelength) is 592 nm, a full width at half maxima thereof is within a range of 581 nm-602 nm, a total covering range thereof is 21 nm, and a color position corresponding to a maximum light intensity thereof is (0.5719, 0.4215). A color gamut of the RGBA light source is shown in Table 7:

TABLE 7
Color gamut of RGBA tetrachromatic LED light source

| Bead color | Chromaticity coordinate x | Chromaticity coordinate y |
|---|---|---|
| Red R | 0.6852 | 0.3088 |
| Green G | 0.1783 | 0.7207 |
| Blue B | 0.1410 | 0.0491 |
| Amber A | 0.5719 | 0.4215 |

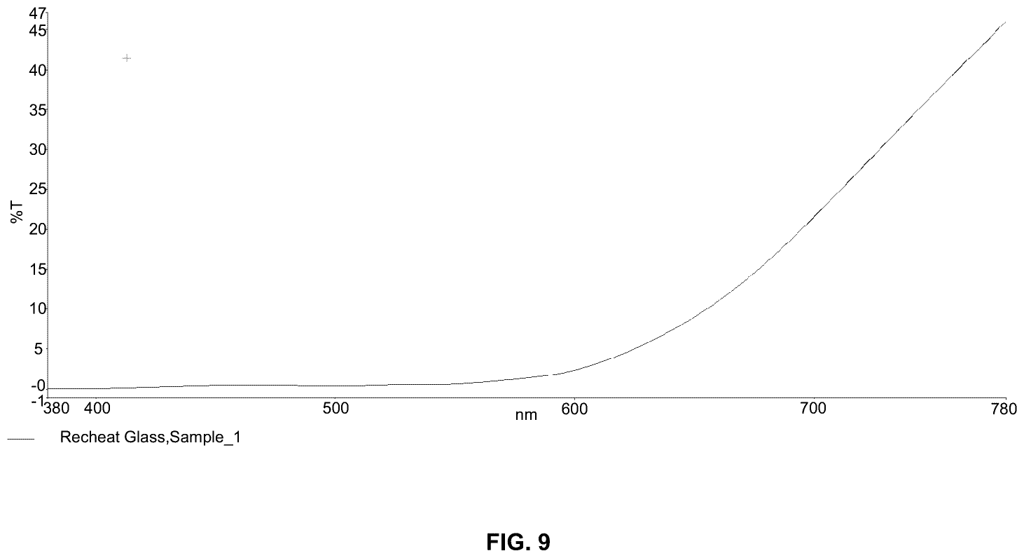

FIG. 9 is a diagram illustrating a transmission spectral distribution of a microcrystalline glass panel in Example 2.

A thickness of the microcrystalline glass panel is 4 mm, in a form of a thin layer. An average transmittance is 1.47% within a visible spectral range of 380 nm-780 nm, and a spectrum thereof is shown in FIG. 9. The chromaticity coordinates of the microcrystalline glass panel are (0.5791, 0.3383), which are within the microcrystalline glass panel chromaticity region W1.

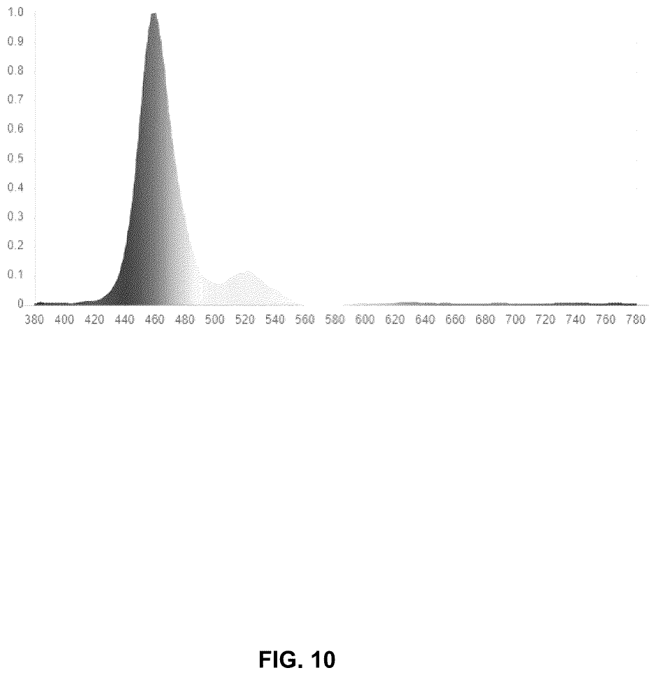

FIG. 10 is a diagram illustrating a spectral distribution of RGBA tetrachromatic lamp beads used in a white light color rendering device in Example 2 when white color is rendered.

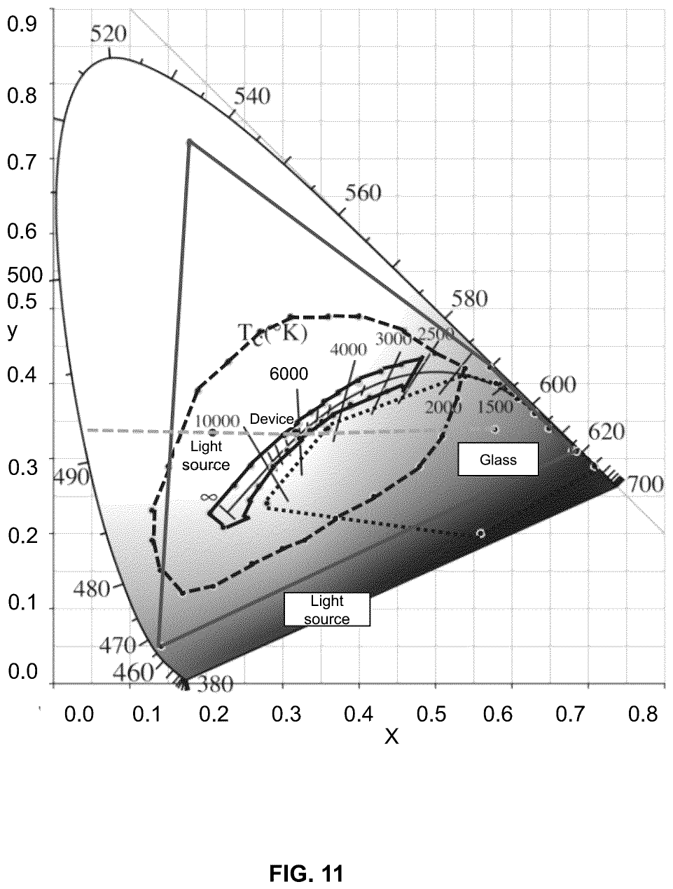

FIG. 11 is a diagram illustrating a distribution of chromaticity coordinates of a light source, a microcrystalline glass panel, and a white light color rendering device when the white light color rendering device is rendering white color in Example 2.

At equal power, chromaticity coordinates of a light source after transmitting through a display surface of a microcrystalline glass panel are (0.5045, 0.2989), wherein the light source displays pink color rather than white color. According to the equations of a light color adjustment technique in example 1, the chromaticity coordinates of the light source may be (0.2236, 0.3391). An intensity ratio of lamp beads is changed, at this time the spectrum of the light source is as shown in FIG. 10, the light emitted by the light source transmitting through the microcrystalline glass panel is displayed in white, and the chromaticity coordinates of the transmitted light are (0.3077, 0.3248). FIG. 11 shows the distribution of the chromaticity coordinates of the light source, the microcrystalline glass panel, and the white light color rendering device when the white light color rendering device is rendering white color. It may be seen from the figure that a white light displayed by the device is located within the optimal white region W4 in example 1, the microcrystalline glass panel is located within the region W1, and the tetrachromatic LED light source is located within W3.

In addition, preferably, the chromaticity coordinates (0.5791, 0.3383) of the microcrystalline glass panel are connected to an isoenergetic white light point (0.333,0.333) in a chromaticity coordinate map and make an extension line. A dominant wavelength of a spectral color at any point (except the isoenergetic white light point) on a connection line from an intersection of the extension line and the spectral trace line to the isoenergetic white light point (0.333, 0.333) may be a dominant wavelength of a standard white light complementary color of the light source.

Chromaticity coordinates of the light source are selected at any point on the connection line from the intersection of the extension line and the spectral trace line to the isoenergetic white light point (0.333, 0.333). By adjusting optical parameters of the light source, the chromaticity coordinates of the light source may be adjusted to (0.2236, 0.3391), so that the light emitted by the light source transmits the display surface of the microcrystalline glass panel having white chromaticity coordinates (0.5791, 0.3383) and displays a white light with specified white chromaticity coordinates (0.3077, 0.3248).

Example 3: The embodiment changes a light intensity ratio of RGBA trichromatic lamp beads, thereby changing a color position when the device rendered the color such that a light emitted by a three intrinsic peak light source may transmit through a display surface of a microcrystalline glass panel and display a white light on the display surface.

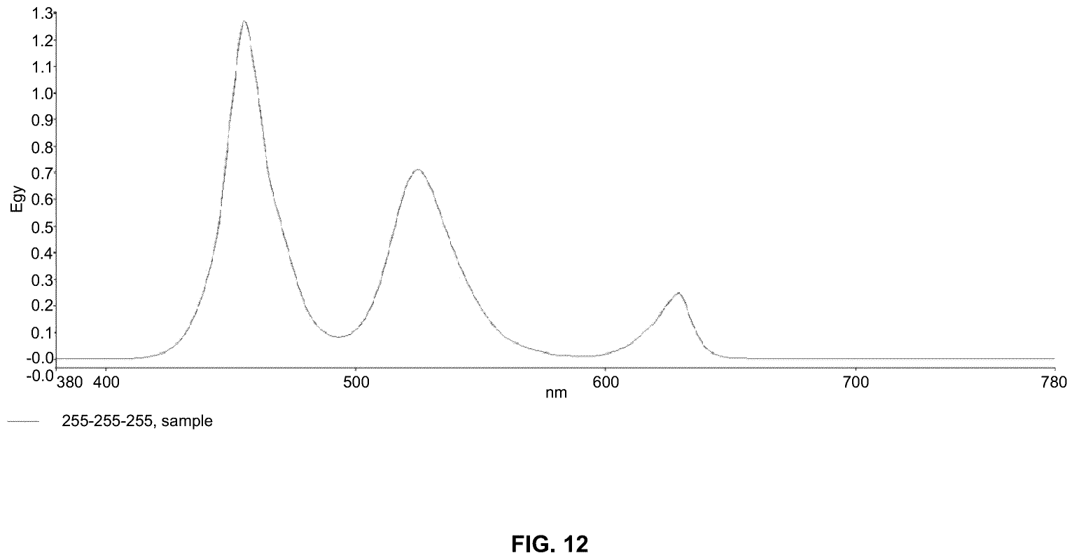

FIG. 12 is a diagram illustrating a spectral distribution of RGB trichromatic lamp beads at equal power in Example 3.

In example 3, a white light color rendering device based on a microcrystalline glass panel and an RGB trichromatic LED light source is provided. The light emitted by the RGB trichromatic LED light source may transmit through the microcrystalline glass panel and display a white light by adjusting a light intensity ratio of the RGB trichromatic LED light source. The device includes a microcrystalline glass panel and a light source composed of RGB trichromatic LED lamp beads. The microcrystalline glass panel has a display surface, and the light source is located on a side of a non-display surface of the microcrystalline glass panel. A spectrum of the light source under equal power is shown in FIG. 12, and the chromaticity coordinates thereof are (0.1874, 0.2516).

The spectrum of the light source used has three intrinsic peaks, each of which corresponds to a light-emitting lamp bead, where a characteristic peak of a red R lamp bead (a dominant wavelength) is 625 nm, a full width at half maxima thereof is within a range of 617 nm-632 nm, a total covering range thereof is 15 nm, and a color position corresponding to a maximum light intensity thereof is (0.6682, 0.3119). A characteristic peak of a green G lamp bead (the dominant wavelength) is 525 nm, a full width at half maxima thereof is within a range of 493 nm-542 nm, a total covering range thereof may be 39 nm, and a color position corresponding to a maximum light intensity thereof is (0.1777, 0.7468). A characteristic peak of a blue B lamp bead (the dominant wavelength) is 455 nm, a full width at half maxima thereof is within a range of 448 nm-465 nm, a total covering range thereof is 17 nm, and a color position corresponding to a maximum light intensity thereof is (0.1474, 0.0351). A color gamut of RGB light source is shown in Table 8:

TABLE 8
Color gamut of the RGB trichromatic light source

| Bead Color | Chromaticity coordinate x | Chromaticity coordinate y |
|---|---|---|
| Red R | 0.6682 | 0.3119 |
| Green G | 0.1777 | 0.7468 |
| Blue B | 0.1474 | 0.0351 |

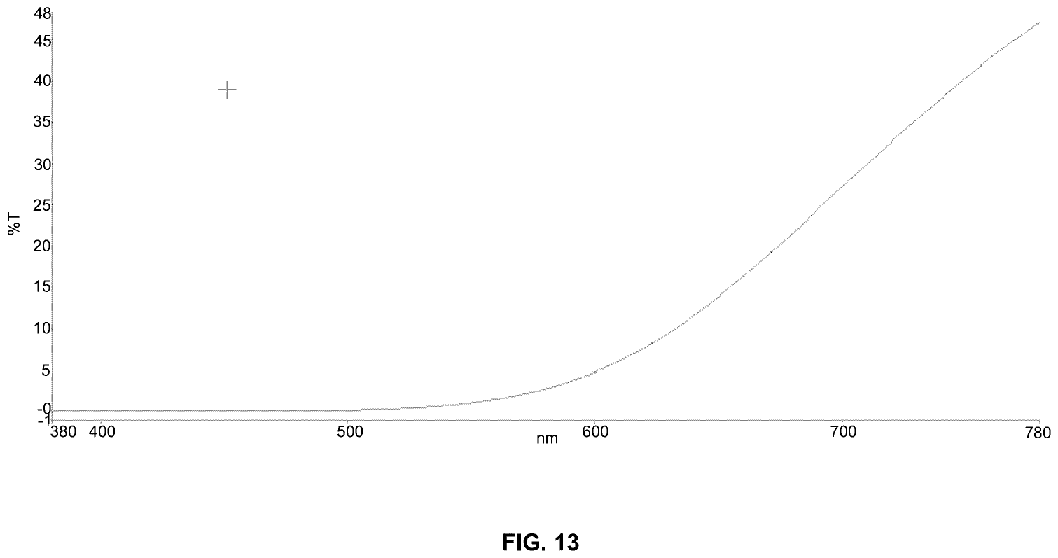

FIG. 13 is a diagram illustrating a transmission spectral distribution of a microcrystalline glass panel in Example 3.

A thickness of the microcrystalline glass panel is 4.27 mm, in a form of a thin layer. An average transmittance is 2.451% within a visible spectral range of 380 nm-780 nm, and a spectrum thereof is shown in FIG. 13. The chromaticity coordinates of the microcrystalline glass panel are (0.5973, 0.3463), which are within the microcrystalline glass panel chromaticity region W1.

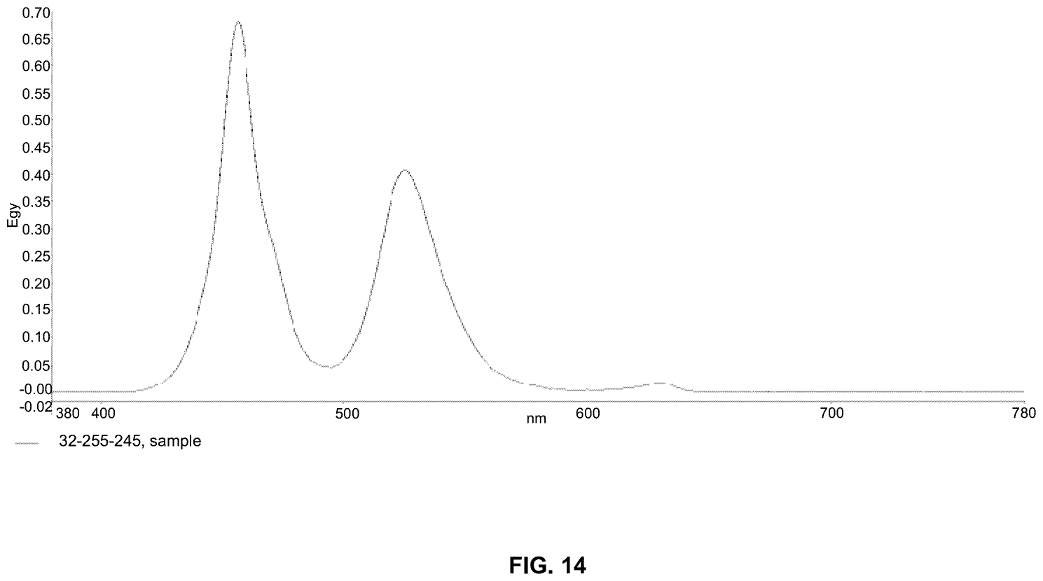

FIG. 14 is a diagram illustrating a spectral distribution of RGB trichromatic lamp beads used in a white light color rendering device when white color is rendered in Example 3.

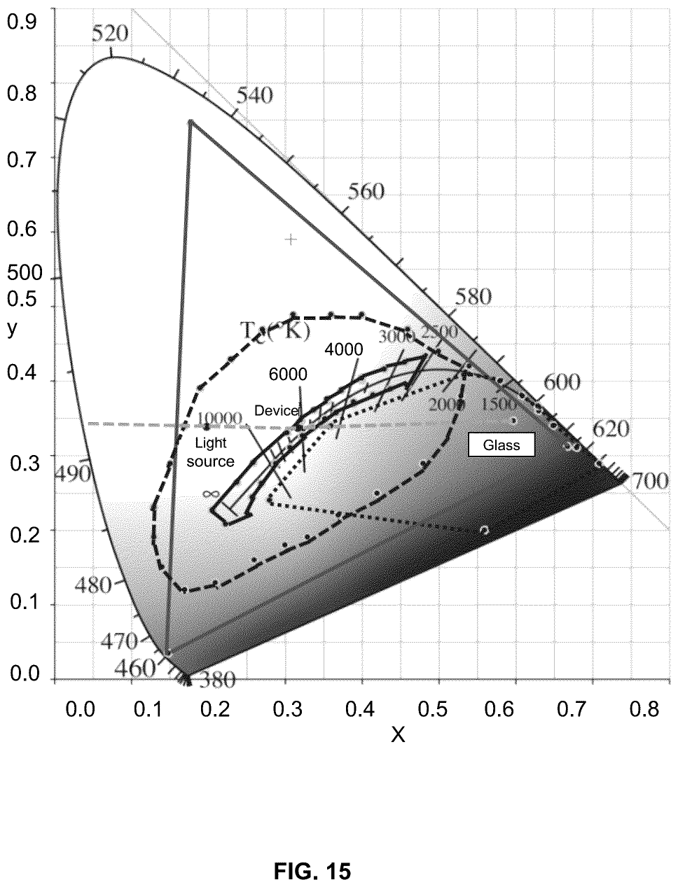

FIG. 15 is a diagram illustrating a distribution of chromaticity coordinates of a light source, a microcrystalline glass panel, and a white light color rendering device when the white light color rendering device is rendering white color in Example 3.

At equal intensity, chromaticity coordinates of a light source after transmitting through a display surface of a microcrystalline glass panel are (0.6057, 0.3484), wherein the light source displays orange-red color. According to equations of a light color adjustment technique in example 1, the chromaticity coordinates of the light source may be (0.2245, 0.3412). An intensity ratio of the light source is changed, at this time the spectrum of the light source is as shown in FIG. 14, the light emitted by the light source transmits through the microcrystalline glass panel and is displayed in white, and the chromaticity coordinates of the transmitted light are (0.3248, 0.3315). FIG. 15 shows the distribution of the chromaticity coordinates of the light source, the microcrystalline glass panel, and the white light color rendering device when the white light color rendering device is rendering white color. It may be seen from the figure that a white light displayed by the device is located within an optimal white region W4 in example 1, the microcrystalline glass panel is located within the region W1, and the trichromatic LED light source is located within W3.

In addition, preferably, the chromaticity coordinates (0.5973, 0.3463) of the microcrystalline glass panel are connected to an isoenergetic white light point (0.333,0.333) in a chromaticity coordinate map and make an extension line. A dominant wavelength of a spectral color at any point (except the isoenergetic white light point) on a connection line from an intersection of the extension line and the spectral trace line to the isoenergetic white light point (0.333, 0.333) may be a dominant wavelength of a standard white light complementary color of the light source.

Chromaticity coordinates of the light source are selected at any point on the connection line from the intersection of the extension line and a spectral trace line to the isoenergetic white light point (0.333, 0.333). By adjusting optical parameters of the light source, the chromaticity coordinates of the light source may be adjusted to (0.2245, 0.3412), so that the light emitted by the light source transmits through the display surface of the microcrystalline glass panel having white chromaticity coordinates (0.5973, 0.3463) and display a white light with specified white chromaticity coordinates (0.3248, 0.3315).

Example 4: The embodiment changes a spectral range of a blue LED after being doped with a phosphor, thereby changing a color position when the device renders the color such that the light emitted by a two intrinsic peak light source may transmit through the display surface of the microcrystalline glass panel and display a white light on the display surface.

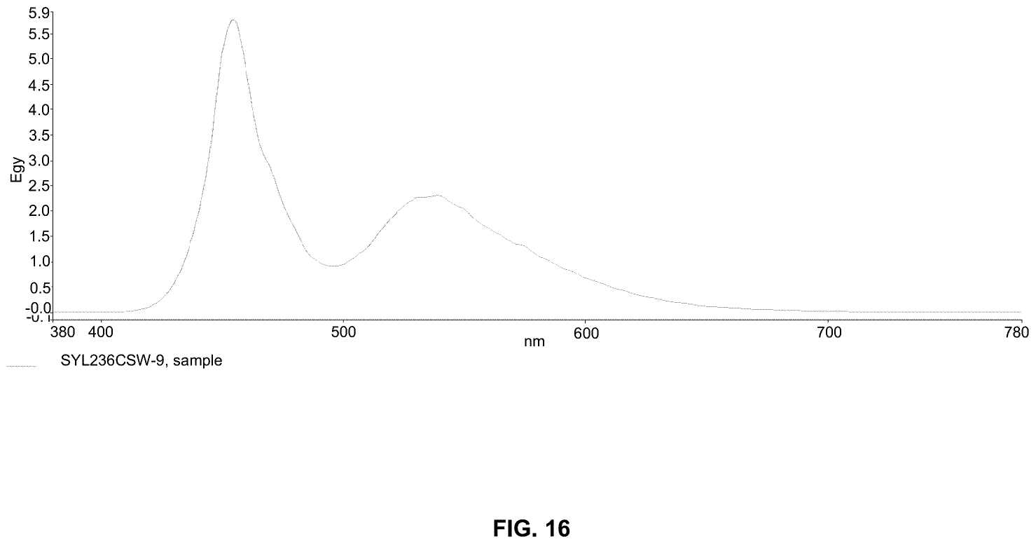

FIG. 16 is a diagram illustrating a spectral distribution of an LED light source at equal power in Example 3.

In example 4, a white light color rendering device based on a microcrystalline glass panel and a dichromatic LED light source is provided. The light emitted by the dichromatic LED light source may transmit through the microcrystalline glass panel and display a white light by adjusting a concentration of a B+ phosphor. The device includes the microcrystalline glass panel and a light source composed of blue LED lamp beads added with phosphor. The microcrystalline glass panel has a display surface, and the light source is located on a side of a non-display surface of the microcrystalline glass panel. A spectrum of the light source after being added with yttrium aluminum garnet (YAG: Ce3+) phosphor is shown in FIG. 16, and chromaticity coordinates thereof are (0.2279, 0.2760), and white light is displayed.

The spectrum of the light source has two intrinsic peaks, one of which corresponds to a light-emitting lamp bead, and another of which corresponds to a fluorescent material, where the light-emitting lamp is a blue LED lamp bead. A characteristic peak (a dominant wavelength) of the blue LED lamp bead is 458 nm, a full width at half maxima thereof is within a range of 453 nm-481 nm, and a total covering range thereof is 28 nm. A characteristic peak (the dominant wavelength) of an emitted fluorescent light is 535 nm, a full width at half maxima thereof is within a range of 505 nm-580 nm, and a total covering range thereof is 75 nm.

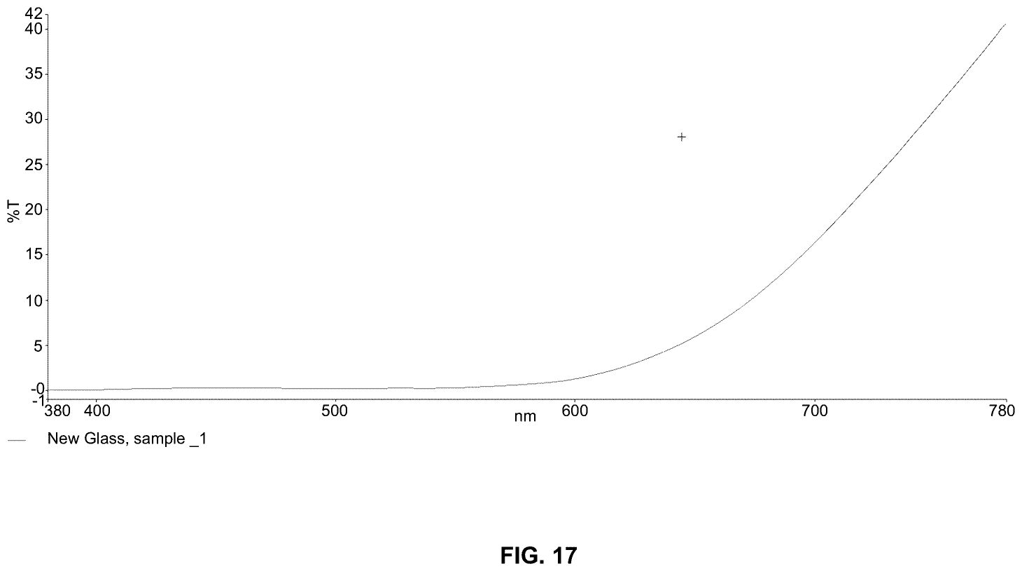

FIG. 17 is a diagram illustrating a transmission spectral distribution of a microcrystalline glass panel in Example 4.

A thickness of the microcrystalline glass panel used is 3.95 mm, in a form of a thin layer. An average transmittance is 0.8% within a visible spectral range of 380 nm-780 nm, and a spectrum thereof is shown in FIG. 17. The chromaticity coordinates of the microcrystalline glass panel are (0.5927, 0.3214), which are within the microcrystalline glass panel chromaticity region W1.

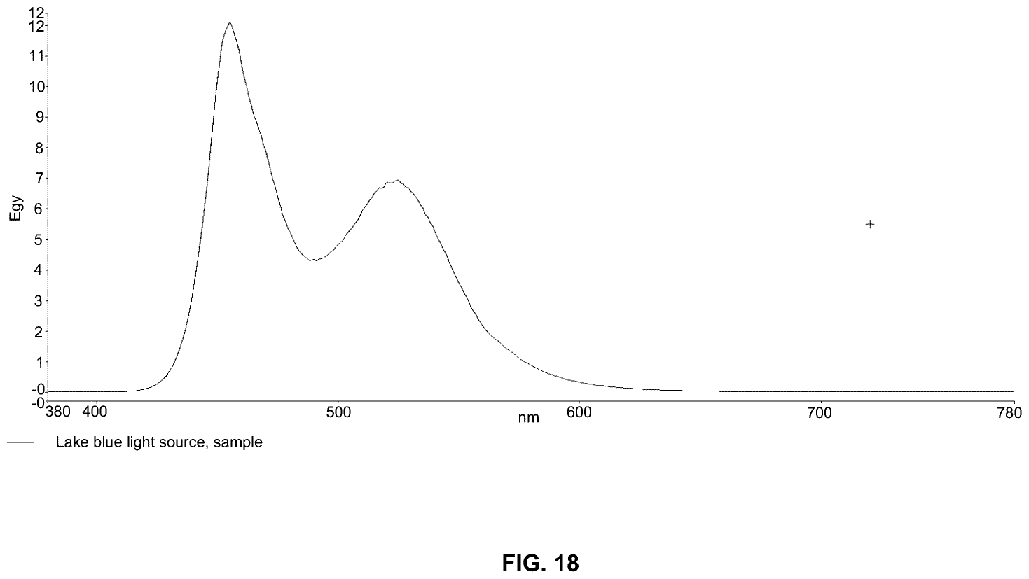

FIG. 18 is a diagram illustrating a spectral distribution of an LED light source used in a white light color rendering device when white color is rendered in Example 4.

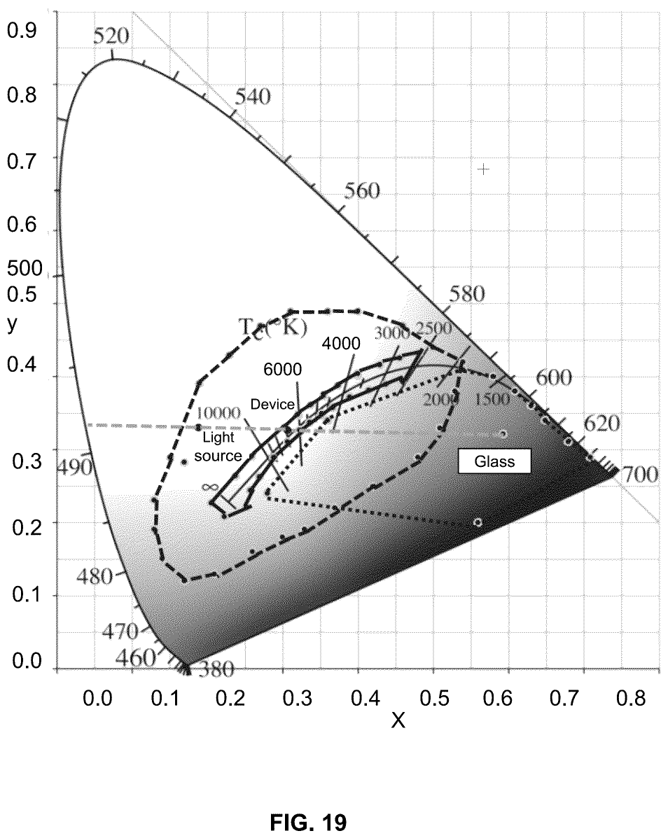

FIG. 19 is a diagram illustrating a distribution of chromaticity coordinates of a light source, a microcrystalline glass panel, and a white light color rendering device when the white light color rendering device is rendering white color in Example 4.

Chromaticity coordinates of a light source used after transmitting through a display surface of a microcrystalline glass panel are (0.2279, 0.2260), wherein the light source displays a blue color. According to the equations of a light color adjustment technique in example 1, the chromaticity coordinates of the light source may be (0.2176, 0.3405). A concentration of the phosphor doped in the sol that encapsulates the lamp bead is changed, at this time the spectrum of the light source is as shown in FIG. 18, the light emitted by the light source transmits through the microcrystalline glass panel and is displayed in white, and the chromaticity coordinates of the transmitted light are (0.3262, 0.3311). FIG. 19 shows the distribution of the chromaticity coordinates of the light source, the microcrystalline glass panel, and the white light color rendering device when the white light color rendering device is rendering white color. It may be seen from the figure that a white light displayed by the device is located within an optimal white region W4 in example 1, the microcrystalline glass panel is located within the region W1, and the tetrachromatic LED light source is located within W3.

In addition, preferably, the chromaticity coordinates (0.5927, 0.3214) of the microcrystalline glass panel are connected to an isoenergetic white light point (0.333,0.333) in a chromaticity coordinate map and make an extension line. A dominant wavelength of a spectral color at any point (except the isoenergetic white light point) on a connection line from an intersection of the extension line and the spectral trace line to the isoenergetic white light point (0.333, 0.333) may be a dominant wavelength of a standard white light complementary color of the light source.

Chromaticity coordinates of the light source are selected at any point on the connection line from the intersection of the extension line and a spectral trace line to the isoenergetic white light point (0.333, 0.333). By adjusting the optical parameters of the light source, the chromaticity coordinates of the light source may be adjusted to (0.2176, 0.3405), so that the light emitted by the light source transmits through the display surface of the microcrystalline glass panel having white chromaticity coordinates (0.5927,0.3214) and display a white light with specified white chromaticity coordinates (0.3262,0.3311).

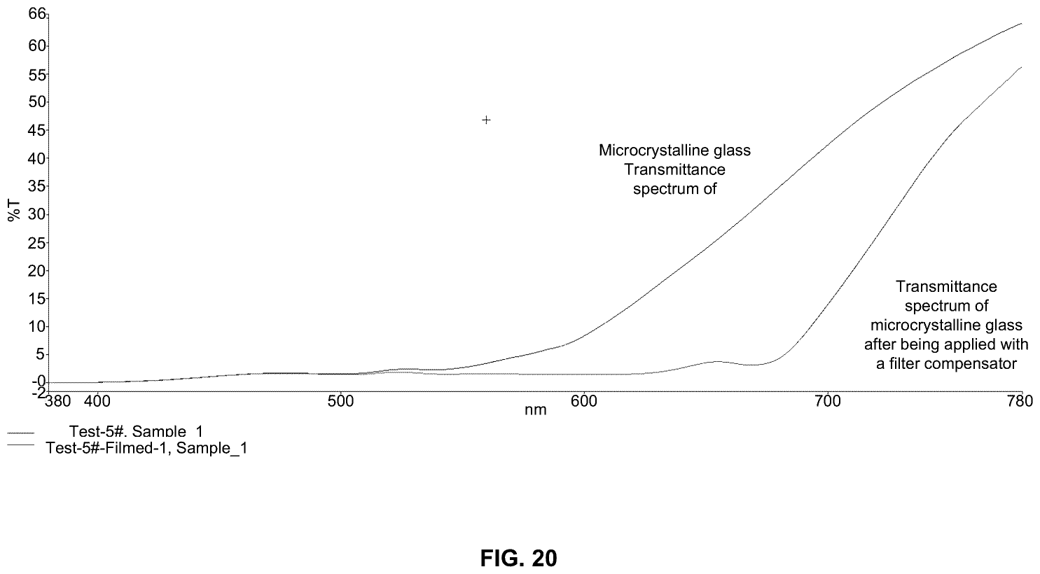

FIG. 20 is a diagram illustrating a transmittance spectrum before and after applying a filter compensator to a microcrystalline glass panel in a contrasting example.

In the contrasting example: a microcrystalline glass panel with i=21 is selected, by comparing an LED spectrum with that in the CN patent No. 103250004B in which a filter film is added, the transmittance spectrums of the microcrystalline glass panel before and after applying the filter compensator are shown in FIG. 20. It may be seen from the figure that adding a filter film or a compensator reduces a transmittance of the microcrystalline glass panel, making the microcrystalline glass panel maintain essentially the same transmittance of red, green, and blue bands in the white light so that an LED light source composed of the RGB trichromatic beads still maintains the original color after transmitting through the microcrystalline glass panel. While the present disclosure may realize a white light display by adjusting the light color of the light source, the transmittance of the microcrystalline glass panel is reduced, and no object is added to the light source and the display panel. Both of the two (i.e., adding a filter film or a compensator, and adjusting the light color of the light source) ultimately display white light, but a chromaticity of the light source used is different.

In particular, the light color rendering device and the method for adjusting the light are particularly applicable to the white color rendering of the microcrystalline glass stove panel. The microcrystalline glass with a relatively small transmittance may be selected, and the transmittance is particularly preferred to be within a range of 0.2-3%. Without a need for additional shading ink, filter compensator, etc., an intensity and spectral efficiency of the light source may be maximized, and light power through the microcrystalline glass may be enhanced to make the microcrystalline glass display a white light with a strong intensity, so that components on a side of a non-display surface may not or not easy to be seen.

FIG. 21 is a schematic diagram illustrating an exemplary light-emitting method facing a limited condition according to some embodiments of the present disclosure.

In 2110, the limited condition includes light emitted by a light source transmits through a non-display surface of a light-transmitting plate that satisfies a light-transmitting condition so that a display surface of the light-transmitting plate displays a display light that satisfies a display condition.

More descriptions regarding the light source and the light-transmitting plate may be found in FIG. 1 and/or FIG. 3 and related descriptions thereof.

The display light refers to a light presented on the display surface of the light-transmitting plate. The display light also refers to a light that a user ultimately wants. More descriptions regarding the light source may be found in FIG. 1 and related descriptions thereof. If the display lights required are different, the light-transmitting conditions of the light-transmitting plate may be the same or different, which may be determined and set according to actual needs. The user refers to an operator of the light-emitting device. The operator may include a designer, a user, etc. of the light-emitting device. More descriptions regarding the light-emitting device may be found in FIG. 3 and related descriptions thereof.

The limited condition refers to a constraint about at least one of the light source, the light-transmitting plate, and the display light.

In some embodiments, the limited condition may also be other conditions, which may be set in advance either manually or by the processor as appropriate.

In 2120, the light-transmitting condition includes a chromaticity coordinate range corresponding to the light-transmitting plate.

The light-transmitting condition refers to a transmission condition of the light-transmitting plate to the light from the light source. In some embodiments, the light-transmitting condition may include conditions for transmitting light of different colors.

In some embodiments, the chromaticity coordinate range corresponding to the light-transmitting plate refers to a chromaticity coordinate region where a transmitted light of a CIE standard illuminant passing through the light-transmitting plate is rendered in a CIE standard chromaticity system. The CIE standard chromaticity system refers to a standard system for quantitatively describing colors. For example, the CIE standard chromaticity system may be a CIE 1931 standard chromaticity system, etc. In some embodiments, the chromaticity coordinate range corresponding to the light-transmitting plate may be determined by the processor 130 of the dimming device 100. More descriptions may be found in FIG. 2 and related descriptions thereof.

In some embodiments, the light-transmitting condition may also include other conditions. The light-transmitting condition may be set in advance either manually or by the processor according to needs.

In 2130, the display condition includes a chromaticity coordinate range of the display light.

The display condition refers to a condition related to the display light. For example, the display condition may include the chromaticity coordinate range, a color temperature, etc., of the display light. The chromaticity coordinate range of the display light may also be referred to as the chromaticity coordinate range corresponding to the display light. In some embodiments, the chromaticity coordinate range of the display light may be determined by the processor 130 of the dimming device 100. More descriptions may be found in FIG. 2 and related descriptions thereof.

In some embodiments, the display condition may also include other conditions, which may be set in advance either manually or by the processor according to needs.

A chromaticity coordinate refers to a coordinate used to represent a color of a light. The chromaticity coordinate range refers to a range of chromaticity coordinates corresponding to a certain color (such as a target color). More descriptions regarding the target color may be found in FIG. 2 and related descriptions thereof.

In some embodiments, the chromaticity coordinate and the chromaticity coordinate range corresponding to the display light may be set in advance either manually or by the processor according to needs.

The color temperature refers to a measurement unit that represents the color of the light. For example, the color temperature may be expressed in the measurement unit of K (kelvin). Different colors may have the same color temperature. It may be understood that the chromaticity coordinate may completely reflect the color emitted by the light source, and the color temperature may approximately reflect the color emitted by the light source. The color temperature may be expressed as Tc.

In 2140, the light-emitting method includes the light source satisfying that a chromaticity coordinate range corresponding to the light source is a chromaticity coordinate range of the light source for displaying the display light, and a light color adjustment range corresponding to the light source is a spectrum adjustment range of the light source for displaying the display light.

In some embodiments, the chromaticity coordinate range corresponding to the light source may be determined by the processor 130 of the dimming device 100. More descriptions may be found in FIG. 2 and related descriptions thereof.

In some embodiments, different colors of display light may have different chromaticity coordinate ranges of the display light and different chromaticity coordinate ranges corresponding to the light source. In some embodiments, the different colors of display light may have different chromaticity coordinate ranges of the display light, different chromaticity coordinate ranges corresponding to the light source, different light color adjustment ranges corresponding to the light source, etc.

In some embodiments, the chromaticity coordinate region corresponding to the light-transmitting plate, the chromaticity coordinate region of the display light, etc., may be accessed in advance either light or by the processor.

A light-emitting parameter refers to a parameter used to describe a light-emitting characteristic of the light source. In some embodiments, the light-emitting parameter may include an intensity and a full width at half maxima of a main wavelength spectrum. More descriptions regarding the light-emitting parameter may be found in FIG. 2 and related descriptions thereof.

The intensity refers to an intensity of a light emitted by the light source, which may be expressed as a luminous flux within a unit solid angle in a given direction. The luminous flux refers to a light energy emitted by the light source per unit time. The intensity may also be referred to as a light-emitting intensity. More descriptions may be found in FIG. 2 and related descriptions thereof.

The full width at half maxima of the main wavelength spectrum refers to a width corresponding to a half-height of the spectrum corresponding to a wavelength with the largest peak in the spectrum diagram of the light source. In some embodiments, the full width at half maxima of the main wavelength spectrum may be expressed in various forms. For example, full width at half maxima of the main wavelength spectrum may be expressed as a wavelength interval between two points of the spectral line at which the amplitude of the wavelength of the largest peak falls by half. The narrower the full width at half maxima of the main wavelength spectrum, the better the monochromaticity of the light source, i.e., the smaller the color error, and the more uniform the color. In some embodiments, the full width at half maxima of the main wavelength spectrum may also be expressed in other forms, such as a root mean square spectral width.

In some embodiments of the present disclosure, under the premise that the overall light intensity and the main wavelength are basically unchanged, increasing the full width at half maxima of the main wavelength may increase the color of the light source, and a transmitted light passing through the microcrystalline glass panels may be changed, and the color temperature may also be changed (usually the color temperature increases). In some embodiments of the present disclosure, under the premise that the overall light intensity and the main wavelength are unchanged, decreasing the full width at half maxima of the main wavelength may decrease the color of the light source, and a transmitted light passing through the microcrystalline glass panels may be changed, and the color temperature may also be changed (usually the color temperature decreases).

In some embodiments of the present disclosure, through the light-emitting method facing the limited condition, the light source and the light-transmitting plate may emit different lights under the limited condition to obtain different display lights to satisfy display needs of users in different scenarios.

The following are some embodiments with specific limited conditions, which do not limit some other embodiments in the present disclosure.

### Example 5

In some embodiments, the chromaticity coordinate range corresponding to the light-transmitting plate may include a chromaticity coordinate region surrounded by the chromaticity coordinates in Table 9, i.e., the light-transmitting condition of the light-transmitting plate is that the transmitted light of the CIE standard illuminant through the light-transmitting plate presents the chromaticity coordinate region in the CIE standard colorimetric system. Table 9 is as follows:

TABLE 9
Chromaticity coordinates presented by the transmitted
light through the light-transmitting plate

| x | y |
|---|---|
| 0.68 | 0.31 |
| 0.71 | 0.29 |
| 0.65 | 0.34 |
| 0.63 | 0.36 |
| 0.61 | 0.38 |
| 0.56 | 0.2 |
| 0.58 | 0.4 |
| 0.54 | 0.42 |
| 0.36 | 0.34 |
| 0.28 | 0.24 |

In some embodiments, the chromaticity coordinate range of the display light may include the chromaticity coordinate range surrounded by the chromaticity coordinates in Table 10. Table 10 is as follows:

TABLE 10
Chromaticity coordinates of the display light

| | Chromaticity | Chromaticity |
|---|---|---|
| Color temperature | coordinate x | coordinate y |
| 4200 | 0.40 | 0.49 |
| 4950 | 0.36 | 0.49 |
| 6030 | 0.31 | 0.49 |
| 7150 | 0.27 | 0.47 |
| 9000 | 0.23 | 0.43 |
| 12570 | 0.19 | 0.39 |
| 21270 | 0.17 | 0.34 |
| ∞ | 0.15 | 0.29 |
| ∞ | 0.13 | 0.23 |
| ∞ | 0.13 | 0.19 |
| ∞ | 0.14 | 0.15 |
| ∞ | 0.17 | 0.12 |
| ∞ | 0.21 | 0.13 |
| ∞ | 0.26 | 0.16 |
| ∞ | 0.30 | 0.18 |
| 11730 | 0.33 | 0.19 |
| 2220 | 0.37 | 0.22 |
| 1810 | 0.42 | 0.25 |
| 1670 | 0.48 | 0.29 |
| 1670 | 0.51 | 0.33 |
| 1780 | 0.53 | 0.38 |
| 1880 | 0.54 | 0.41 |
| 2430 | 0.50 | 0.44 |
| 3130 | 0.46 | 0.47 |

In some embodiments, the chromaticity coordinate range of the display light may be obtained by a standard CIE whiteness equation, as well as a color tolerance equation.

In some embodiments, the chromaticity coordinate range corresponding to the light source may include a chromaticity coordinate region surrounded by the chromaticity coordinates in Table 11. Table 11 is as follows:

TABLE 11
Chromaticity coordinates corresponding to the light source

| x | y |
|---|---|
| 0.022 | 0.420 |
| 0.020 | 0.511 |
| 0.020 | 0.465 |
| 0.019 | 0.494 |

In some embodiments, the light-emitting component of the light source may be a lighting component, the light-emitting component may include 3 primary color lamps. Intrinsic peaks of a spectrum of the light source may be within a range of 440 nm-495 nm, a range of 495 nm-520 nm, and a range of 520 nm-570 nm, respectively, and the primary color lamp with the intrinsic peak within a range of 440 nm-495 nm is dominant. More descriptions regarding the lighting component may be found in FIG. 3 and related descriptions thereof.

In some embodiments of the present disclosure, by making the chromaticity coordinate range corresponding to the light-transmitting plate as shown in Table 9, and the chromaticity coordinate range corresponding to the light source as shown in Table 11, the display surface of the light-transmitting plate may display the chromaticity coordinate range of the display light as shown in Table 10, which satisfies the white light requirements of users in specific scenarios and enhances the user experience.

### Example 6

In some embodiments, the chromaticity coordinate range corresponding to the light-transmitting plate may include the chromaticity coordinate region surrounded by the chromaticity coordinates in Table 9, i.e., the light-transmitting condition of the light-transmitting plate is that the transmitted light of the CIE standard illuminant through the light-transmitting plate presents the chromaticity coordinate region in the CIE standard colorimetric system.

In some embodiments, the chromaticity coordinate range of the display light may include the chromaticity coordinate range surrounded by the chromaticity coordinates in Table 10

In some embodiments, a chromaticity coordinate range corresponding to an optimized count of light sources and spectral range may include a chromaticity coordinate region surrounded by the chromaticity coordinates in Table 12. Table 12 is shown below:

TABLE 12
Chromaticity coordinates corresponding to the light source

| x | y |
|---|---|
| 0.020 | 0.498 |
| 0.229 | 0.388 |
| 0.047 | 0.483 |

In some embodiments, the light-emitting component of the light source may be a lighting component, and the light-emitting component may include 2 primary color lamps. Intrinsic peaks of a spectrum of the light source may be within a range of 440 nm-495 nm and a range of 520 nm-570 nm, respectively, and the primary color lamp with the intrinsic peak within a range of 440 nm-495 nm is dominant.

In some embodiments of the present disclosure, by making the chromaticity coordinate range corresponding to the light-transmitting plate as shown in Table 9, and the chromaticity coordinate range corresponding to the light source as shown in Table 12, the display surface of the light-transmitting plate may display the chromaticity coordinate range of the display light as shown in Table 10, which reduces a count of the lighting component and improves the stability of the lighting unit, thereby further satisfying the white light requirements of users in specific scenarios and enhancing the user experience.

### Example 7

In some embodiments, the chromaticity coordinate range corresponding to the light-transmitting plate is a chromaticity coordinate region enclosed by the following chromaticity coordinates:

TABLE 13
Chromaticity coordinates presented by the transmitted
light of the light-transmitting plate

| x | y |
|---|---|
| 0.5927 | 0.3214 |
| 0.5973 | 0.3463 |
| 0.5791 | 0.3383 |

The target color of the display light is white, and the chromaticity coordinate range of said display light is a chromaticity coordinate region enclosed by the following chromaticity coordinates:

TABLE 14
Chromaticity coordinates of the display light

| | Chromaticity | Chromaticity |
|---|---|---|
| Color temperature | coordinate x | coordinate y |
| 7410 | 0.2989 | 0.3115 |
| 7300 | 0.2972 | 0.3252 |
| 6790 | 0.3041 | 0.339 |
| 6030 | 0.3196 | 0.3494 |
| 5210 | 0.3403 | 0.3528 |
| 5250 | 0.3386 | 0.3356 |
| 5620 | 0.3300 | 0.3235 |
| 5970 | 0.3231 | 0.3149 |
| 6740 | 0.3110 | 0.3046 |
| 7660 | 0.2989 | 0.2977 |
| 8350 | 0.2886 | 0.3011 |

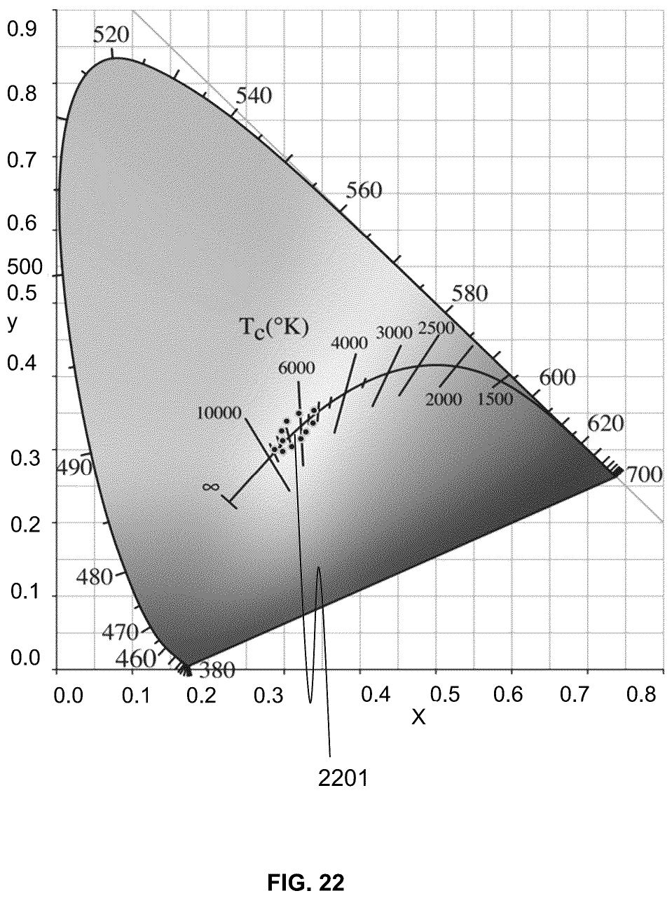

A chromaticity coordinate region 2201 as shown in FIG. 22 is surrounded by the chromaticity coordinates of Table 14

The chromaticity coordinate range corresponding to the light source is the chromaticity coordinate region enclosed by the following chromaticity coordinates:

TABLE 15
Chromaticity coordinates corresponding to the light source

| x | y |
|---|---|
| 0.0542 | 0.318 |
| 0.0818 | 0.318 |
| 0.1008 | 0.3146 |
| 0.111 | 0.3077 |
| 0.1025 | 0.3001 |
| 0.0887 | 0.2911 |
| 0.0766 | 0.2803 |
| 0.0612 | 0.2713 |
| 0.0522 | 0.2672 |
| 0.0501 | 0.2800 |
| 0.0501 | 0.2867 |
| 0.0469 | 0.2971 |
| 0.0416 | 0.3183 |

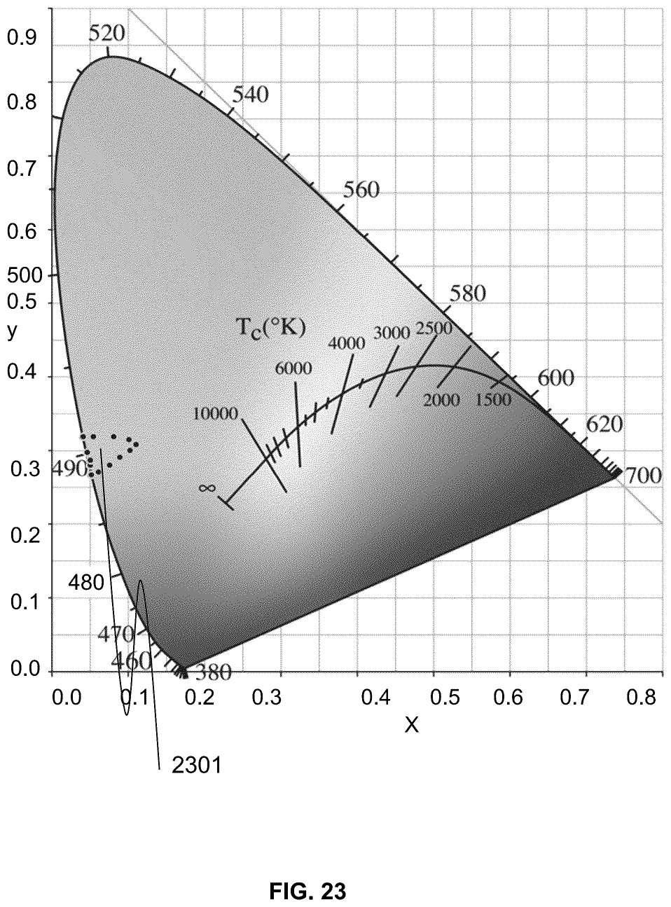

As shown in FIG. 23, the chromaticity coordinate range corresponding to the light source is the chromaticity coordinate region 2301 enclosed by the chromaticity coordinates of Table 15.

In some embodiments, the light-emitting device of the light source is a monochromatic lighting component. The monochromatic lighting component includes a primary color lamp, and the intrinsic peak of the spectrum of the light source is within a range of 470 nm-500 nm.

In some embodiments of the present disclosure, by making the chromaticity coordinate range corresponding to the light-transmitting plate as shown in Table 13, and the chromaticity coordinate range corresponding to the light source as shown in Table 15, the display surface of the light-transmitting plate may display the chromaticity coordinate range of the display light as shown in Table 14, which further satisfies the white light requirements of users in specific scenarios and enhances the user experience.

### Example 8

In some embodiments, the chromaticity coordinate range corresponding to the light-transmitting plate may include a chromaticity coordinate region surrounded by the chromaticity coordinates in Table 13.

In some embodiments, the target color of the display light is yellow, and the chromaticity coordinate range of the display light is a chromaticity coordinate region enclosed by the following chromaticity coordinates:

TABLE 16
Chromaticity coordinates of the display light

| | Chromaticity | Chromaticity |
|---|---|---|
| Color temperature | coordinate x | coordinate y |
| 3870 | 0.4420 | 0.5661 |
| 4060 | 0.4265 | 0.5609 |
| 4400 | 0.4023 | 0.5592 |
| 4910 | 0.3696 | 0.5604 |
| 5170 | 0.3541 | 0.5696 |
| 5520 | 0.3334 | 0.5765 |
| 5550 | 0.3317 | 0.6075 |
| 5470 | 0.3368 | 0.6350 |
| 5480 | 0.3368 | 0.6592 |
| 5430 | 0.3403 | 0.6695 |
| 5240 | 0.3541 | 0.6540 |
| 5000 | 0.3713 | 0.6368 |
| 4790 | 0.3868 | 0.6247 |
| 4640 | 0.3954 | 0.6161 |
| 4530 | 0.4023 | 0.6092 |
| 4240 | 0.4213 | 0.5937 |

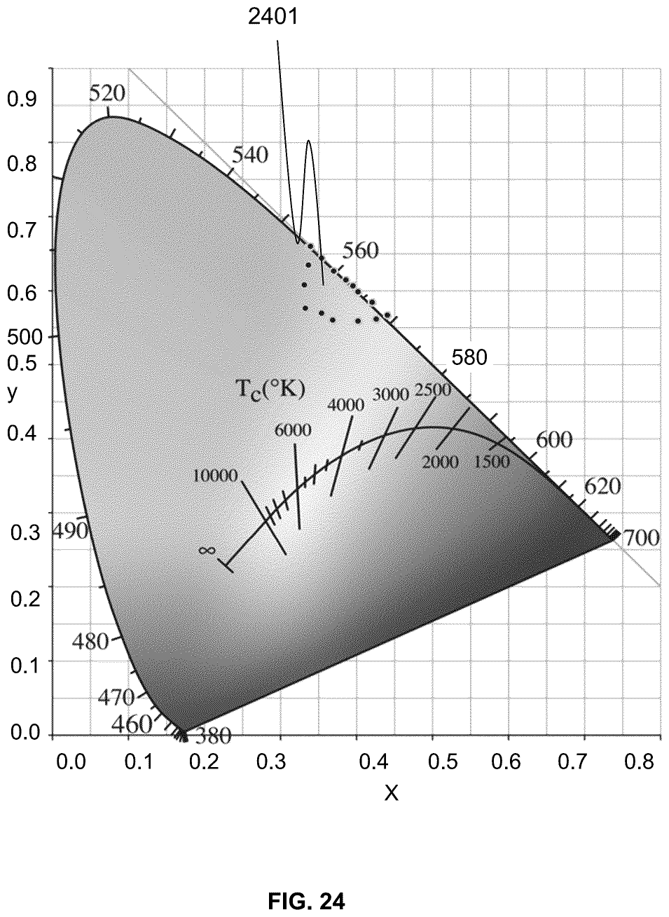

As shown in FIG. 24, a chromaticity coordinate region 2401 is surrounded by the corresponding chromaticity coordinates of Table 17.

In some embodiments, the chromaticity coordinate range corresponding to the light source is a chromaticity coordinate region enclosed by the following chromaticity coordinates:

TABLE 18
Chromaticity coordinates corresponding to the light source

| Color temperature | x | y |
|---|---|---|
| 9700 | 0.0340 | 0.7975 |
| 9240 | 0.0652 | 0.7855 |
| 9090 | 0.0803 | 0.7704 |
| 9040 | 0.0913 | 0.7512 |
| 8980 | 0.1085 | 0.7180 |
| 8900 | 0.1286 | 0.6798 |
| 8790 | 0.1467 | 0.6476 |
| 8640 | 0.1669 | 0.6134 |
| 8730 | 0.1830 | 0.5641 |
| 8804 | 0.1961 | 0.5219 |
| 9490 | 0.1669 | 0.5400 |
| 10170 | 0.1296 | 0.5702 |
| 10960 | 0.0903 | 0.6074 |
| 11270 | 0.0491 | 0.6486 |
| 11280 | 0.0259 | 0.6859 |
| 11260 | 0.0118 | 0.7100 |
| 10620 | 0.0158 | 0.7472 |
| 10170 | 0.0229 | 0.7714 |
| 9760 | 0.0329 | 0.7935 |

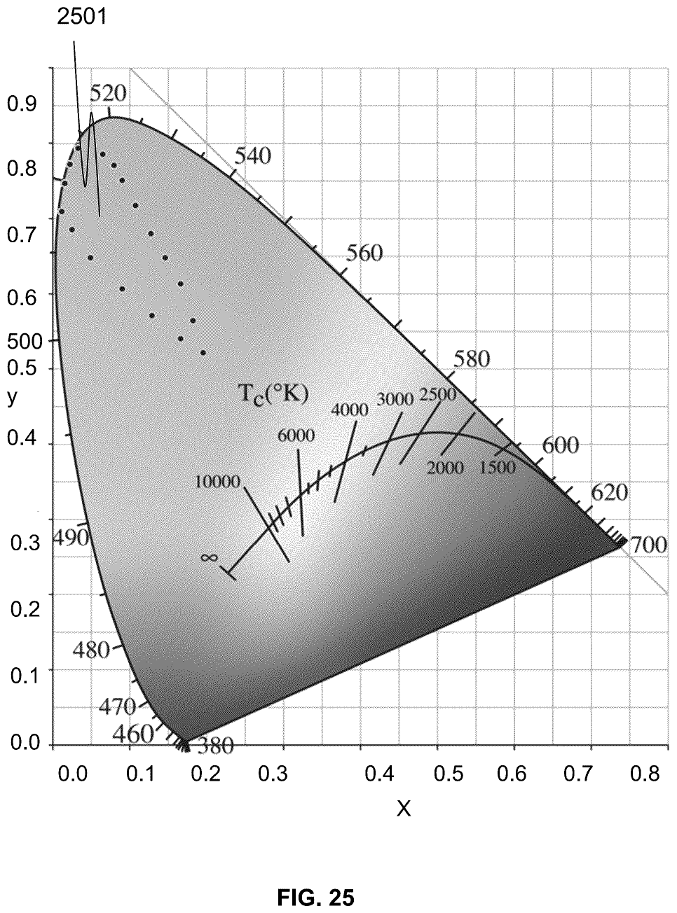

As shown in FIG. 25, a chromaticity coordinate region 2501 is surrounded by the corresponding chromaticity coordinates of Table 13.

In some embodiments, the light-emitting device of the light source is a monochromatic lighting component. The monochromatic lighting component includes a primary color lamp, and the intrinsic peak of the spectrum of the light source is within a range of 560 nm-580 nm.

In some embodiments, the light-emitting device of the light source is a lighting component. The lighting component may include two primary color lamps, and the intrinsic peaks of the spectrum of the light source are within a range of 490 nm-560 nm and a range of 560nm-580nm, respectively, and the primary color lamp with the intrinsic peak within a range of 560 nm-580 nm is dominant.

In some embodiments of the present disclosure, by making the chromaticity coordinate range corresponding to the light-transmitting plate as shown in Table 13, and the chromaticity coordinate range corresponding to the light source as shown in Table 18, the display surface of the light-transmitting plate may display the chromaticity coordinate range of the display light as shown in Table 17, and the display light may be yellow, which satisfies yellow light requirements of users and enhances the user experience.

### Example 9

In some embodiments, the chromaticity coordinate range corresponding to the light-transmitting plate may include a chromaticity coordinate region surrounded by the chromaticity coordinates in Table 13.

In some embodiments, the target color of the display light is blue, and the chromaticity coordinate range of the display light is a chromaticity coordinate region enclosed by the following chromaticity coordinates:

TABLE 19
Chromaticity coordinates of the display light

| | Chromaticity | Chromaticity |
|---|---|---|
| Color temperature | coordinate x | coordinate y |
| 100000 | 0.1185 | 0.0928 |
| 100000 | 0.1097 | 0.1020 |
| 100000 | 0.1180 | 0.1151 |
| 100000 | 0.1203 | 0.1222 |
| 100000 | 0.1227 | 0.1317 |
| 100000 | 0.1286 | 0.1423 |
| 100000 | 0.1381 | 0.1542 |
| 100000 | 0.1559 | 0.1578 |
| 100000 | 0.1713 | 0.1542 |
| 100000 | 0.1796 | 0.1471 |
| 100000 | 0.1915 | 0.1329 |
| 100000 | 0.1915 | 0.1163 |
| 100000 | 0.1939 | 0.1068 |
| 100000 | 0.1939 | 0.0973 |
| 100000 | 0.1915 | 0.0866 |
| 100000 | 0.1891 | 0.0736 |

In some embodiments, the chromaticity coordinate range corresponding to the light source is a chromaticity coordinate region enclosed by the following chromaticity coordinates:

TABLE 20
Chromaticity coordinates corresponding to the light source

| Color temperature | x | y |
|---|---|---|
| 100000 | 0.1185 | 0.0928 |
| 100000 | 0.1097 | 0.1020 |
| 100000 | 0.1180 | 0.1151 |
| 100000 | 0.1203 | 0.1222 |
| 100000 | 0.1227 | 0.1317 |
| 100000 | 0.1286 | 0.1423 |
| 100000 | 0.1381 | 0.1542 |
| 100000 | 0.1559 | 0.1578 |
| 100000 | 0.1713 | 0.1542 |
| 100000 | 0.1796 | 0.1471 |
| 100000 | 0.1915 | 0.1329 |
| 100000 | 0.1915 | 0.1163 |
| 100000 | 0.1939 | 0.1068 |
| 100000 | 0.1939 | 0.0973 |
| 100000 | 0.1915 | 0.0866 |
| 100000 | 0.1891 | 0.0736 |
| 100000 | 0.1879 | 0.0582 |
| 100000 | 0.1844 | 0.0451 |
| 100000 | 0.1808 | 0.0356 |

In some embodiments, the light-emitting device of the light source is a monochromatic lighting component. The monochromatic lighting component includes a primary color lamp, and the intrinsic peak of the spectrum of the light source is within a range of 440 nm-470 nm.

In some embodiments, the light-emitting device of the light source is the lighting component, the lighting component may include two primary color lamps, the intrinsic peaks of the spectrum of the light source are within a range of 440 nm-470 nm and a range of 520 nm-570 nm, respectively, and the primary color lamp with the intrinsic peak within a range of 440 nm-470 nm is dominant.

In some embodiments of the present disclosure, by making the chromaticity coordinate range corresponding to the light-transmitting plate as shown in Table 13, and the chromaticity coordinate range corresponding to the light source as shown in Table 20, the display surface of the light-transmitting plate may display the chromaticity coordinate range of the display light as shown in Table 19, and the display light is blue, which satisfies blue light requirements of users and enhances the user experience.

### Example 10

In some embodiments, the chromaticity coordinate range corresponding to the light-transmitting plate may include a chromaticity coordinate region surrounded by the chromaticity coordinates in Table 13.

The target color of the display light is cyan, and the chromaticity coordinate range of the display light is a chromaticity coordinate region enclosed by the following chromaticity coordinates:

TABLE 21
Chromaticity coordinates of the display light

| | Chromaticity | Chromaticity |
|---|---|---|
| Color temperature | coordinate x | coordinate y |
| 19490 | 0.0148 | 0.5075 |
| 18350 | 0.0349 | 0.4980 |
| 16790 | 0.0515 | 0.4980 |
| 16610 | 0.0693 | 0.4802 |
| 16010 | 0.0836 | 0.4719 |
| 16020 | 0.0978 | 0.4553 |
| 17090 | 0.1132 | 0.4257 |
| 16900 | 0.1275 | 0.4115 |
| 17770 | 0.1381 | 0.3925 |
| 20100 | 0.1417 | 0.3735 |
| 25890 | 0.1452 | 0.3486 |
| 40710 | 0.1476 | 0.3249 |
| ∞ | 0.1441 | 0.2941 |
| ∞ | 0.1369 | 0.2633 |
| ∞ | 0.1286 | 0.2372 |
| ∞ | 0.1215 | 0.2064 |

The chromaticity coordinate range corresponding to the light source is a chromaticity coordinate region enclosed by the following chromaticity coordinates:

TABLE 22
Chromaticity coordinates corresponding to the light source

| Color temperature | x | y |
|---|---|---|
| 19490 | 0.0148 | 0.5075 |
| 18350 | 0.0349 | 0.4980 |
| 16790 | 0.0515 | 0.4980 |
| 16610 | 0.0693 | 0.4802 |
| 16010 | 0.0836 | 0.4719 |
| 16020 | 0.0978 | 0.4553 |
| 17090 | 0.1132 | 0.4257 |
| 16900 | 0.1275 | 0.4115 |
| 17770 | 0.1381 | 0.3925 |
| 20100 | 0.1417 | 0.3735 |
| 25890 | 0.1452 | 0.3486 |
| 40710 | 0.1476 | 0.3249 |
| ∞ | 0.1441 | 0.2941 |
| ∞ | 0.1369 | 0.2633 |
| ∞ | 0.1286 | 0.2372 |
| ∞ | 0.1215 | 0.2064 |
| 19490 | 0.0148 | 0.5075 |
| 18350 | 0.0349 | 0.4980 |
| 16790 | 0.0515 | 0.4980 |

In some embodiments, the light-emitting device of the light source is the monochromatic lighting component. The monochromatic lighting component includes a primary color lamp, and the intrinsic peak of the spectrum of the light source is within a range of 470 nm-500 nm.

In some embodiments, the light-emitting device of the light source is the lighting component, the lighting component may include two primary color lamps, the intrinsic peaks of the spectrum of the light source may be within a range of 470 nm-500 nm and a range of 500 nm-560 nm, respectively, and the primary color lamp with the intrinsic peak within a range of 470 nm-500 nm is dominant.

In some embodiments of the present disclosure, by making the chromaticity coordinate range corresponding to the light-transmitting plate as shown in Table 13, and the chromaticity coordinate range corresponding to the light source as shown in Table 22, the display surface of the light-transmitting plate may display the chromaticity coordinate range of the display light as shown in Table 21, and the display light is cyan, which satisfies cyan light requirements of users and enhances the user experience.

### Example 11

In some embodiments, the chromaticity coordinate range corresponding to the light-transmitting plate may include a chromaticity coordinate region surrounded by the chromaticity coordinates in Table 13.

The target color of the display light is a green light, and the chromaticity coordinate range of the display light is a chromaticity coordinate region enclosed by the following chromaticity coordinates:

TABLE 23
Chromaticity coordinates of the display light

| | Chromaticity | Chromaticity |
|---|---|---|
| Color temperature | coordinate x | coordinate y |
| 8760 | 0.0729 | 0.8348 |
| 9010 | 0.0610 | 0.8265 |
| 9190 | 0.0527 | 0.8193 |
| 9470 | 0.0409 | 0.8099 |
| 9620 | 0.0397 | 0.7944 |
| 9470 | 0.0575 | 0.7743 |
| 9480 | 0.0646 | 0.7577 |
| 9500 | 0.0717 | 0.7411 |
| 9500 | 0.0800 | 0.7233 |
| 9480 | 0.0871 | 0.7103 |
| 9340 | 0.1002 | 0.6960 |
| 9130 | 0.1108 | 0.6949 |
| 8900 | 0.1156 | 0.7103 |
| 8790 | 0.1132 | 0.7304 |
| 8710 | 0.1108 | 0.7470 |
| 8620 | 0.1085 | 0.7660 |

The chromaticity coordinate range corresponding to the light source is the chromaticity coordinate region enclosed by the following chromaticity coordinates:

TABLE 24
Chromaticity coordinates corresponding to the light source

| Color temperature | x | y |
|---|---|---|
| 8760 | 0.0729 | 0.8348 |
| 9010 | 0.0610 | 0.8265 |
| 9190 | 0.0527 | 0.8193 |
| 9470 | 0.0409 | 0.8099 |
| 9620 | 0.0397 | 0.7944 |
| 9470 | 0.0575 | 0.7743 |
| 9480 | 0.0646 | 0.7577 |
| 9500 | 0.0717 | 0.7411 |
| 9500 | 0.0800 | 0.7233 |
| 9480 | 0.0871 | 0.7103 |
| 9340 | 0.1002 | 0.6960 |
| 9130 | 0.1108 | 0.6949 |
| 8900 | 0.1156 | 0.7103 |
| 8790 | 0.1132 | 0.7304 |
| 8710 | 0.1108 | 0.7470 |
| 8620 | 0.1085 | 0.7660 |
| 8560 | 0.1061 | 0.7814 |
| 8510 | 0.1037 | 0.7968 |
| 8480 | 0.0990 | 0.8134 |

In some embodiments, the light-emitting device of the light source is the monochromatic lighting component. The monochromatic lighting component includes a primary color lamp, and the intrinsic peak of the spectrum of the light source is within a range of 500 nm-560 nm.

In some embodiments, the light-emitting device of the light source is the lighting component, the lighting component may include two primary color lamps, the intrinsic peaks of the spectrum of the light source may be within a range of 470 nm-500 nm and a range of 500 nm-560 nm, respectively, and the primary color lamp with the intrinsic peak within a range of 500 nm-560 nm is dominant.

In some embodiments of the present disclosure, by making the chromaticity coordinate range corresponding to the light-transmitting plate as shown in Table 13, and the chromaticity coordinate range corresponding to the light source as shown in Table 24, the display surface of the light-transmitting plate may display the chromaticity coordinate range of the display light as shown in Table 23, and the display light is green, which satisfies green light requirements of users and enhances the user experience.

### Example 12

In some embodiments, the chromaticity coordinate range corresponding to the light-transmitting plate may include a chromaticity coordinate region surrounded by the chromaticity coordinates in Table 13.

The target color of the display light is orange, and the chromaticity coordinate range of the display light is a chromaticity coordinate region enclosed by the following chromaticity coordinates:

TABLE 25
Chromaticity coordinates of the display light

| | Chromaticity | Chromaticity |
|---|---|---|
| Color temperature | coordinate x | coordinate y |
| 3180 | 0.4785 | 0.5194 |
| 3240 | 0.4667 | 0.5040 |
| 3330 | 0.4525 | 0.4850 |
| 3420 | 0.4394 | 0.4672 |
| 3450 | 0.4299 | 0.4482 |
| 3140 | 0.4382 | 0.4245 |
| 2790 | 0.4536 | 0.4103 |
| 2460 | 0.4702 | 0.3961 |
| 2220 | 0.4868 | 0.3901 |
| 1900 | 0.5118 | 0.3771 |
| 1680 | 0.5355 | 0.3700 |
| 1670 | 0.5639 | 0.3629 |
| 1670 | 0.5829 | 0.3652 |
| 1670 | 0.6114 | 0.3676 |
| 1670 | 0.6304 | 0.3700 |
| 1670 | 0.6126 | 0.3890 |

The chromaticity coordinate range corresponding to the light source is the chromaticity coordinate region enclosed by the following chromaticity coordinates:

TABLE 26
Chromaticity coordinates corresponding to the light source

| Color temperature | x | y |
|---|---|---|
| 8090 | 0.1239 | 0.8158 |
| 8070 | 0.1322 | 0.7944 |
| 8080 | 0.1393 | 0.766 |
| 8100 | 0.1464 | 0.7458 |
| 7980 | 0.1607 | 0.7245 |
| 7980 | 0.1654 | 0.7115 |
| 7920 | 0.1761 | 0.6866 |
| 7840 | 0.1868 | 0.6664 |
| 7730 | 0.1986 | 0.6462 |
| 7530 | 0.2152 | 0.6249 |
| 7330 | 0.2295 | 0.6095 |
| 7090 | 0.2449 | 0.5953 |
| 6760 | 0.2627 | 0.5917 |
| 6500 | 0.2745 | 0.6059 |
| 6400 | 0.2781 | 0.6213 |
| 6390 | 0.2757 | 0.6474 |
| 6280 | 0.2793 | 0.6771 |
| 6220 | 0.2816 | 0.6949 |
| 6170 | 0.284 | 0.7126 |

In some embodiments, the light-emitting device of the light source is the monochromatic lighting component. The monochromatic lighting component includes a primary color lamp, and the intrinsic peak of the spectrum of the light source is within a range of 580 nm-610 nm.

In some embodiments, the light-emitting device of the light source is the lighting component, the lighting component includes two primary color lamps, the intrinsic peaks of the spectrum of the light source may be within a range of 470 nm-580 nm and a range of 580 nm-610 nm, respectively, and the primary color lamp with the intrinsic peak within a range of 580 nm-610 nm is dominant.

In some embodiments of the present disclosure, by making the chromaticity coordinate range corresponding to the light-transmitting plate as shown in Table 13, and the chromaticity coordinate range corresponding to the light source as shown in Table 26, the display surface of the light-transmitting plate may display the chromaticity coordinate range of the display light as shown in Table 25, and the display light is orange, which satisfies orange light requirements of users and enhances the user experience.

### Example 13

In some embodiments, the chromaticity coordinate range corresponding to the light-transmitting plate may include a chromaticity coordinate region surrounded by the chromaticity coordinates in Table 13.

The target color of the display light is violet, and the chromaticity coordinate range of the display light is a chromaticity coordinate region enclosed by the following chromaticity coordinates:

TABLE 27
Chromaticity coordinates of the display light

| | Chromaticity | Chromaticity |
|---|---|---|
| Color temperature | coordinate x | coordinate y |
| ∞ | 0.1856 | 0.0095 |
| ∞ | 0.1856 | 0.0261 |
| ∞ | 0.1891 | 0.0392 |
| ∞ | 0.1891 | 0.0487 |
| ∞ | 0.1939 | 0.0605 |
| ∞ | 0.1962 | 0.0700 |
| ∞ | 0.2010 | 0.0819 |
| ∞ | 0.2069 | 0.0961 |
| ∞ | 0.2176 | 0.1103 |
| ∞ | 0.2318 | 0.1163 |
| ∞ | 0.2316 | 0.1115 |
| ∞ | 0.2413 | 0.1044 |
| ∞ | 0.2425 | 0.0854 |
| ∞ | 0.2437 | 0.0736 |
| ∞ | 0.2378 | 0.0593 |
| ∞ | 0.2342 | 0.0309 |

The chromaticity coordinate range corresponding to the light source is the chromaticity coordinate region enclosed by the following chromaticity coordinates:

TABLE 28
Chromaticity coordinates corresponding to the light source

| | Chromaticity | Chromaticity |
|---|---|---|
| Color temperature | coordinate x | coordinate y |
| ∞ | 0.1856 | 0.0095 |
| ∞ | 0.1856 | 0.0261 |
| ∞ | 0.1891 | 0.0392 |
| ∞ | 0.1891 | 0.0487 |
| ∞ | 0.1939 | 0.0605 |
| ∞ | 0.1962 | 0.0700 |
| ∞ | 0.2010 | 0.0819 |
| ∞ | 0.2069 | 0.0961 |
| ∞ | 0.2176 | 0.1103 |
| ∞ | 0.2318 | 0.1163 |
| ∞ | 0.2316 | 0.1115 |
| ∞ | 0.2413 | 0.1044 |
| ∞ | 0.2425 | 0.0854 |
| ∞ | 0.2437 | 0.0736 |
| ∞ | 0.2378 | 0.0593 |
| ∞ | 0.2342 | 0.0309 |

In some embodiments, the light-emitting device of the light source is the monochromatic lighting component. The monochromatic lighting component includes a primary color lamp, and the intrinsic peak of the spectrum of the light source is within a range of 380 nm-420 nm.

In some embodiments, the light-emitting device of the light source is the lighting component, the lighting component includes two primary color lamps, the intrinsic peaks of the spectrum of the light source may be within a range of 380 nm-420 nm and a range of 440 nm-470 nm, respectively, and the primary color lamp with the intrinsic peak within a range of 380 nm-420 nm is dominant.

In some embodiments of the present disclosure, by making the chromaticity coordinate range corresponding to the light-transmitting plate as shown in Table 13, and the chromaticity coordinate range corresponding to the light source as shown in Table 28, the display surface of the light-transmitting plate may display the chromaticity coordinate range of the display light as shown in Table 27, and the display light is violet, which satisfies violet light requirements of users and enhances the user experience.

### Example 14

In some embodiments, the chromaticity coordinate range corresponding to the light-transmitting plate may include a chromaticity coordinate region surrounded by the chromaticity coordinates in Table 13.

The target color of the display light is red, and the chromaticity coordinate range of the display light is a chromaticity coordinate region enclosed by the following chromaticity coordinates:

TABLE 29
Chromaticity coordinates of the display light

| | Chromaticity | Chromaticity |
|---|---|---|
| Color temperature | coordinate x | coordinate y |
| 1670 | 0.7369 | 0.2668 |
| 1670 | 0.7158 | 0.2799 |
| 1680 | 0.7015 | 0.2905 |
| 1680 | 0.6778 | 0.3060 |
| 1680 | 0.6517 | 0.3107 |
| 1690 | 0.6316 | 0.3095 |
| 1690 | 0.6078 | 0.2977 |
| 1690 | 0.6019 | 0.2822 |
| 1700 | 0.6090 | 0.2668 |
| 1710 | 0.6375 | 0.2633 |
| 1700 | 0.6565 | 0.2656 |
| 1690 | 0.6683 | 0.2692 |
| 1720 | 0.6920 | 0.2704 |
| 1680 | 0.7146 | 0.2704 |

The chromaticity coordinate range corresponding to the light source is the chromaticity coordinate region enclosed by the following chromaticity coordinates:

TABLE 30
Chromaticity coordinates corresponding to the light source

| Color temperature | x | y |
|---|---|---|
| 1670 | 0.7369 | 0.2668 |
| 1670 | 0.7158 | 0.2799 |
| 1680 | 0.7015 | 0.2905 |
| 1680 | 0.6778 | 0.3060 |
| 1680 | 0.6517 | 0.3107 |
| 1690 | 0.6316 | 0.3095 |
| 1690 | 0.6078 | 0.2977 |
| 1690 | 0.6019 | 0.2822 |
| 1700 | 0.6090 | 0.2668 |
| 1710 | 0.6375 | 0.2633 |
| 1700 | 0.6565 | 0.2656 |
| 1690 | 0.6683 | 0.2692 |
| 1720 | 0.6920 | 0.2704 |
| 1680 | 0.7146 | 0.2704 |

In some embodiments, the light-emitting device of the light source is a monochromatic lighting component. The monochromatic lighting component includes a primary color lamp, and the intrinsic peak of the spectrum of the light source is within a range of 610 nm-680 nm.

In some embodiments, the light-emitting device of the light source is the lighting component, the lighting component includes two primary color lamps, the intrinsic peaks of the spectrum of the light source may be within a range of 580 nm-610 nm and a range of 610 nm-680 nm, respectively, and the primary color lamp with the intrinsic peak within a range of 610 nm-680 nm is dominant.

In some embodiments of the present disclosure, by making the chromaticity coordinate range corresponding to the light-transmitting plate as shown in Table 13, and the chromaticity coordinate range corresponding to the light source as shown in Table 30, the display surface of the light-transmitting plate may display the chromaticity coordinate range of the display light as shown in Table 29, and the display light is red, which satisfies red light requirements of users and enhances the user experience.

In some embodiments of the present disclosure, the user's requirements for different types of white light, yellow light, etc., and/or the user's requirements for a display light of different colors may be satisfied by adjusting the chromaticity coordinate range corresponding to the light-transmitting plate, the chromaticity coordinate range of the display light, and the chromaticity coordinate range corresponding to the light source, thereby enhancing the user experience.

In some embodiments, the chromaticity coordinate range corresponding to the light-transmitting plate, the chromaticity coordinate range of the displaying light, and the chromaticity coordinate range corresponding to the light source may also be chromaticity coordinate regions surrounded by any feasible chromaticity coordinates, which may be set according to the actual needs.

The following Example 15 to Example 17 are illustrated with an example of an intrinsic peak.

### Example 15

Some embodiments of the present disclosure provide a light-emitting device of white light based on a microcrystalline glass panel and a laser diode (LD) light source, and a light emitted by the LD light source may transmit through the microcrystalline glass panel and a white light may be displayed. The light-emitting device includes the microcrystalline glass panel and a light source composed of laser diode (LD) beads. The microcrystalline glass panel has a display surface, the light source is located on a side of a non-display surface of the microcrystalline glass panel, and the chromaticity coordinates thereof are (0.0735, 0.3034).

In some embodiments, the spectrum of the light source has one intrinsic peak corresponding to a light-emitting lamp bead, where a characteristic peak of the light-emitting lamp bead (a dominant wavelength) is 490 nm, a full width at half maxima thereof is within a range of 485 nm-495 nm, and a total covering range thereof is 10 nm.

In some embodiments, due to the difference between the microcrystalline glass panel and the LD light source, a range of the characteristic peak (the dominant wavelength) of the light-emitting lamp beads and a range of the full width at half maxima vary according to the actual situation. The lighting manner fully utilizes the monochromaticity of the LD, and the color gamut of the screen display is wider.

### Example 16

Some embodiments of the present disclosure provide a light-emitting device of white light based on a microcrystalline glass panel and an LED light source, and a light emitted by the LD light source may transmit through the microcrystalline glass panel and a white light may be displayed. The light-emitting device includes a microcrystalline glass panel and a light source composed of LED beads. The microcrystalline glass panel has a display surface, the light source is located on a side of a non-display surface of the microcrystalline glass panel, the chromaticity coordinates thereof are (0.0969, 0.2928), and white light is displayed.

In some embodiments, the spectrum of the light source has one intrinsic peak corresponding to a light-emitting lamp bead, where a characteristic peak of the light-emitting lamp bead (the dominant wavelength) is 485 nm, a full width at half maxima thereof is within a range of 475 nm-495 nm, and a total covering range thereof is 20 nm.

In some embodiments, due to the difference between the microcrystalline glass panel and the LED light source, a range of the characteristic peak (the dominant wavelength) of the light-emitting lamp beads and a range of the full width at half maxima vary according to the actual situation. In the lighting manner, the light source has a good stability, and batch products have low chromaticity aberration, which is easy to mass-produce and cost-effective, and may provide a more specific and practical lighting solution for corresponding lighting scenarios.

### Example 17

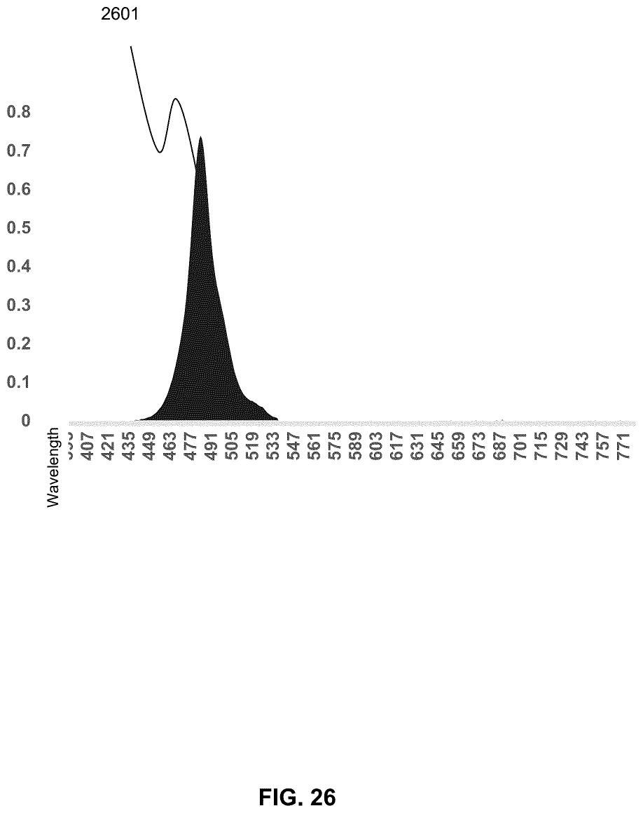

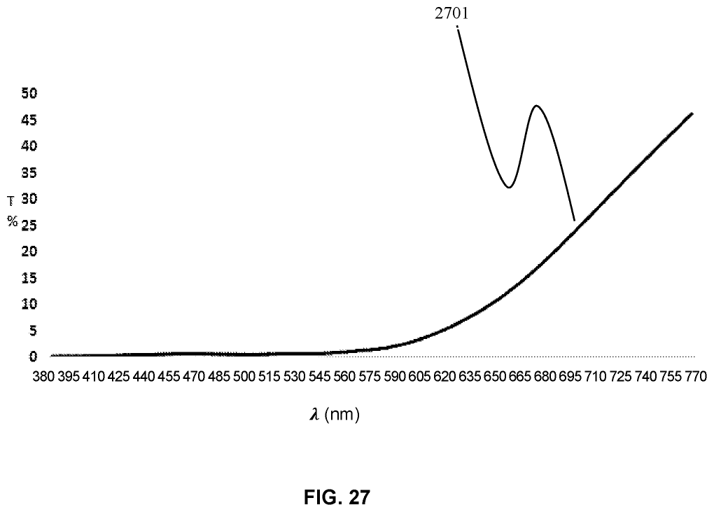

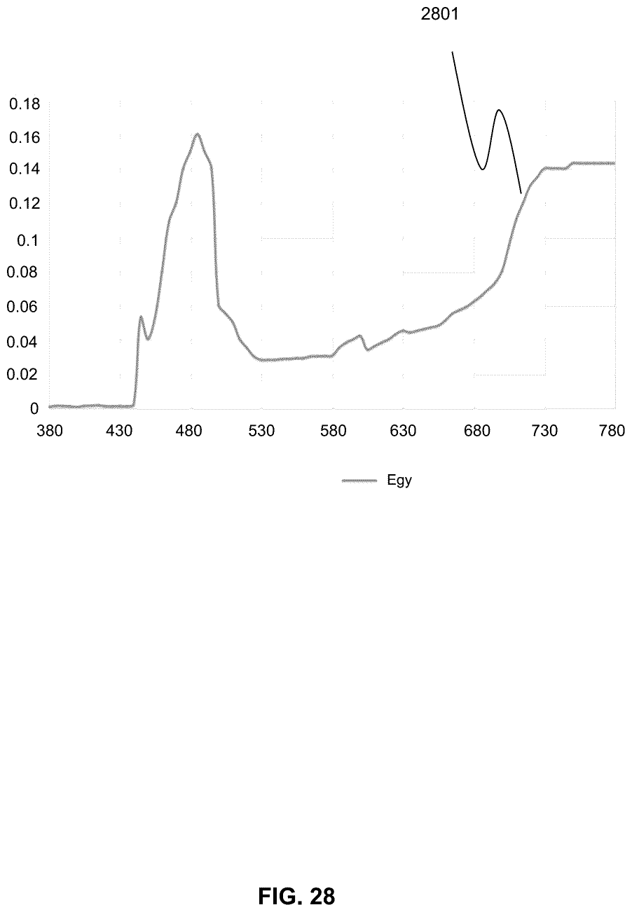

FIG. 26 is a diagram illustrating a spectral distribution of an intrinsic peak of a light source according to some embodiments of the present disclosure. FIG. 27 is a diagram illustrating a transmission spectral distribution of a microcrystalline glass panel according to some embodiments of the present disclosure. FIG. 28 is a diagram illustrating a transmission spectral distribution of a microcrystalline glass panel used in a light-emitting device that displays a white color according to some embodiments of the present disclosure.

Some embodiments of the present disclosure provide a light-emitting device of white light based on a microcrystalline glass panel and a blue light source, and a light emitted by the blue light source may transmit through the microcrystalline glass panel and a white light may be displayed. The light-emitting device includes a microcrystalline glass panel and a light source composed of blue LED beads. The microcrystalline glass panel has a display surface, the light source is located on a side of a non-display surface of the microcrystalline glass panel, a spectrum of the blue light source is as shown in FIG. 26, the chromaticity coordinates thereof are (0.2837, 0.2905), and white light is displayed.

In some embodiments, the spectrum of the light source has one intrinsic peak corresponding to a light-emitting lamp bead, where a characteristic peak of the light-emitting lamp bead (the dominant wavelength) is 485 nm, and a full width at half maxima thereof is 30 nm.

A thickness of the microcrystalline glass panel is 2.5 mm, in a form of a thin layer. An average transmittance is 5% within a visible spectral range of 380 nm-780 nm, and a spectrum thereof is shown in FIG. 27. The chromaticity coordinates of the microcrystalline glass panel are (0.5791, 0.3383), which are within the microcrystalline glass panel chromaticity region.

Chromaticity coordinates of the light source after transmitting through the display surface of the microcrystalline glass panel are (0.2837, 0.2905), wherein the light source after transmitting through the display surface of the microcrystalline glass panel displays cool white color, at this time the spectrum of the light source is as shown in FIG. 28.

Compared with the previous embodiment, this embodiment takes into account the problem of color enhancement of the light source due to the increase in the full width at half maxima of the light source. The final display effect indicates that the color difference generated in this embodiment is within an acceptable range, which provides a reference for a white light color tolerance caused by the color difference of the light due to the aging of the light source. Accordingly, for the light-emitting device in this embodiment, the influence of the color difference of the light source caused by long-term use or production inconsistencies on the white light may be accepted, and there are fewer requirements for high lighting components in this embodiment, which is more suitable for promotion.

In some embodiments of the present disclosure, a light-emitting device of white light based on the microcrystalline glass panel and the light source may also be provided, and a light emitted by the light source may transmit through the microcrystalline glass panel and a white light may be displayed. A plurality of embodiments regarding the spectrum of the light source with one intrinsic peak may also be provided.

In some embodiments, in addition to the white light, a plurality of light-emitting devices of different colors may be included, which may be designed according to actual needs.

Some embodiments of the present disclosure provide a light-emitting system facing a limited condition. The system may include a processor, the processor may be configured to control the light emitted by the light source to pass through the non-display surface of the light-transmitting plate that satisfies a light-transmitting condition, so as to cause the display surface of the light-transmitting plate to display a display light that satisfies the display condition. The light-transmitting condition may include a chromaticity coordinate range corresponding to the light-transmitting plate. The chromaticity coordinate range corresponding to the light-transmitting plate refers to a chromaticity coordinate region where a transmitted light of a CIE standard illuminant passing through the light-transmitting plate is rendered in a CIE standard chromaticity system. The display condition may include a chromaticity coordinate range of the display light. The chromaticity coordinate range of the display light refers to a chromaticity coordinate range required by the display light to display a transmitted light in a target color. The light-emitting method may include the light source satisfying that a chromaticity coordinate range corresponding to the light source is a chromaticity coordinate range of the light source for displaying the display light, and a light color adjustment range corresponding to the light source is a spectrum adjustment range of the light source for displaying the display light.

Some embodiments of the present disclosure provide a non-transitory computer-readable storage medium, the storage medium may store computer instructions. When the computer reads the computer instructions in the storage medium, the computer executes the light-emitting method facing the limited condition as described in any of the foregoing embodiments.

The basic concept has been described above. Obviously, for those skilled in the art, the above detailed disclosure is only an example, and does not constitute a limitation to the present disclosure. Although not expressly stated here, those skilled in the art may make various modifications, improvements and corrections to the present disclosure. Such modifications, improvements and corrections are suggested in this disclosure, so such modifications, improvements and corrections still belong to the spirit and scope of the exemplary embodiments of the present disclosure.

Meanwhile, the present disclosure uses specific words to describe the embodiments of the present disclosure. For example, “one embodiment”, “an embodiment”, and/or “some embodiments” refer to a certain feature, structure or characteristic related to at least one embodiment of the present disclosure. Therefore, it should be emphasized and noted that references to “one embodiment” or “an embodiment” or “an alternative embodiment” two or more times in different places in the present disclosure do not necessarily refer to the same embodiment. In addition, certain features, structures or characteristics in one or more embodiments of the present disclosure may be properly combined.

Furthermore, the recited order of processing elements or sequences, or the use of numbers, letters, or other designations therefore, is not intended to limit the claimed processes and methods to any order except as may be specified in the claims. Although the above disclosure discusses some embodiments of the present disclosure currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes. History application documents that are inconsistent or conflictive with the contents of the present disclosure are excluded, as well as documents (currently or subsequently appended to the present specification) limiting the broadest scope of the claims of the present disclosure. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A light-emitting method facing a limited condition, comprising:
the limited condition including that a light emitted by a light source transmits through a non-display surface of a light-transmitting plate that satisfies a light-transmitting condition so that a display surface of the light-transmitting plate displays a display light that satisfies a display condition; wherein
the light-transmitting condition includes a chromaticity coordinate range corresponding to the light-transmitting plate, wherein the chromaticity coordinate range corresponding to the light-transmitting plate is a chromaticity coordinate region where a transmitted light of a CIE standard illuminant passing through the light-transmitting plate is rendered in a CIE standard chromaticity system; and
the display condition includes a chromaticity coordinate range of the display light, wherein the chromaticity coordinate range of the display light is a chromaticity coordinate range required by the display light to display a transmitted light in a target color; and
the light-emitting method includes the light source satisfying that a chromaticity coordinate range corresponding to the light source is a chromaticity coordinate range of the light source for displaying the display light, and a light color adjustment range corresponding to the light source is a spectrum adjustment range of the light source for displaying the display light.

2. The light-emitting method of claim 1, wherein the chromaticity coordinate range corresponding to the light-transmitting plate is a chromaticity coordinate region enclosed by following chromaticity coordinates:

| x | y |
|---|---|
| 0.68 | 0.31 |
| 0.71 | 0.29 |
| 0.65 | 0.34 |
| 0.63 | 0.36 |
| 0.61 | 0.38 |
| 0.56 | 0.2 |
| 0.58 | 0.4 |
| 0.54 | 0.42 |
| 0.36 | 0.34 |
| 0.28 | 0.24 |

the target color of the display light is white, the chromaticity coordinate range of the display light is a chromaticity coordinate region enclosed by following chromaticity

| | Chromaticity | Chromaticity |
|---|---|---|
| Color temperature | coordinate x | coordinate y |
| 4200 | 0.40 | 0.49 |
| 4950 | 0.36 | 0.49 |
| 6030 | 0.31 | 0.49 |
| 7150 | 0.27 | 0.47 |
| 9000 | 0.23 | 0.43 |
| 12570 | 0.19 | 0.39 |
| 21270 | 0.17 | 0.34 |
| ∞ | 0.15 | 0.29 |
| ∞ | 0.13 | 0.23 |
| ∞ | 0.13 | 0.19 |
| ∞ | 0.14 | 0.15 |
| ∞ | 0.17 | 0.12 |
| ∞ | 0.21 | 0.13 |
| ∞ | 0.26 | 0.16 |
| ∞ | 0.30 | 0.18 |
| 11730 | 0.33 | 0.19 |
| 2220 | 0.37 | 0.22 |
| 1810 | 0.42 | 0.25 |
| 1670 | 0.48 | 0.29 |
| 1670 | 0.51 | 0.33 |
| 1780 | 0.53 | 0.38 |
| 1880 | 0.54 | 0.41 |
| 2430 | 0.50 | 0.44 |
| 3130 | 0.46 | 0.47 |

the chromaticity coordinate range corresponding to the light source is a chromaticity coordinate region enclosed by following chromaticity coordinates:

| x | y |
|---|---|
| 0.022 | 0.420 |
| 0.020 | 0.511 |
| 0.020 | 0.465 |
| 0.019 | 0.494 |

3. The light-emitting method of claim 1, wherein the chromaticity coordinate range corresponding to the light-transmitting plate is a chromaticity coordinate region enclosed by following chromaticity coordinates:

| x | y |
|---|---|
| 0.68 | 0.31 |
| 0.71 | 0.29 |
| 0.65 | 0.34 |
| 0.63 | 0.36 |
| 0.61 | 0.38 |
| 0.56 | 0.2 |
| 0.58 | 0.4 |
| 0.54 | 0.42 |
| 0.36 | 0.34 |
| 0.28 | 0.24 |

the target color of the display light is white, the chromaticity coordinate range of the display light is a chromaticity coordinate region enclosed by following chromaticity coordinates:

| | Chromaticity | Chromaticity |
|---|---|---|
| Color temperature | coordinate x | coordinate y |
| 4200 | 0.40 | 0.49 |
| 4950 | 0.36 | 0.49 |
| 6030 | 0.31 | 0.49 |
| 7150 | 0.27 | 0.47 |
| 9000 | 0.23 | 0.43 |
| 12570 | 0.19 | 0.39 |
| 21270 | 0.17 | 0.34 |
| ∞ | 0.15 | 0.29 |
| ∞ | 0.13 | 0.23 |
| ∞ | 0.13 | 0.19 |
| ∞ | 0.14 | 0.15 |
| ∞ | 0.17 | 0.12 |
| ∞ | 0.21 | 0.13 |
| ∞ | 0.26 | 0.16 |
| ∞ | 0.30 | 0.18 |
| 11730 | 0.33 | 0.19 |
| 2220 | 0.37 | 0.22 |
| 1810 | 0.42 | 0.25 |
| 1670 | 0.48 | 0.29 |
| 1670 | 0.51 | 0.33 |
| 1780 | 0.53 | 0.38 |
| 1880 | 0.54 | 0.41 |
| 2430 | 0.50 | 0.44 |
| 3130 | 0.46 | 0.47 |

the chromaticity coordinate range corresponding to the light source is a chromaticity coordinate region enclosed by following chromaticity coordinates:

| x | y |
|---|---|
| 0.020 | 0.498 |
| 0.229 | 0.388 |
| 0.047 | 0.483 |

4. The light-emitting method of claim 1, wherein the chromaticity coordinate range corresponding to the light-transmitting plate is a chromaticity coordinate region enclosed by following chromaticity coordinates:

| x | y |
|---|---|
| 0.5927 | 0.3214 |
| 0.5973 | 0.3463 |
| 0.5791 | 0.3383 |

the target color of the display light is white, the chromaticity coordinate range of the display light is a chromaticity coordinate region enclosed by following chromaticity coordinates:

| | Chromaticity | Chromaticity |
|---|---|---|
| Color temperature | coordinate x | coordinate y |
| 7410 | 0.2989 | 0.3115 |
| 7300 | 0.2972 | 0.3252 |
| 6790 | 0.3041 | 0.339 |
| 6030 | 0.3196 | 0.3494 |
| 5210 | 0.3403 | 0.3528 |
| 5250 | 0.3386 | 0.3356 |
| 5620 | 0.3300 | 0.3235 |
| 5970 | 0.3231 | 0.3149 |
| 6740 | 0.3110 | 0.3046 |
| 7660 | 0.2989 | 0.2977 |
| 8350 | 0.2886 | 0.3011 |

the chromaticity coordinate range corresponding to the light source is a chromaticity coordinate region enclosed by following chromaticity coordinates:

| x | y |
|---|---|
| 0.0542 | 0.318 |
| 0.0818 | 0.318 |
| 0.1008 | 0.3146 |
| 0.111 | 0.3077 |
| 0.1025 | 0.3001 |
| 0.0887 | 0.2911 |
| 0.0766 | 0.2803 |
| 0.0612 | 0.2713 |
| 0.0522 | 0.2672 |
| 0.0501 | 0.2800 |
| 0.0501 | 0.2867 |
| 0.0469 | 0.2971 |
| 0.0416 | 0.3183 |

5. The light-emitting method of claim 1, wherein the chromaticity coordinate range corresponding to the light-transmitting plate is a chromaticity coordinate region enclosed by following chromaticity coordinates:

| x | y |
|---|---|
| 0.5927 | 0.3214 |
| 0.5973 | 0.3463 |
| 0.5791 | 0.3383 |

the target color of the display light is yellow, the chromaticity coordinate range of the display light is a chromaticity coordinate region enclosed by following chromaticity coordinates:

| | Chromaticity | Chromaticity |
|---|---|---|
| Color temperature | coordinate x | coordinate y |
| 3870 | 0.4420 | 0.5661 |
| 4060 | 0.4265 | 0.5609 |
| 4400 | 0.4023 | 0.5592 |
| 4910 | 0.3696 | 0.5604 |
| 5170 | 0.3541 | 0.5696 |
| 5520 | 0.3334 | 0.5765 |
| 5550 | 0.3317 | 0.6075 |
| 5470 | 0.3368 | 0.6350 |
| 5480 | 0.3368 | 0.6592 |
| 5430 | 0.3403 | 0.6695 |
| 5240 | 0.3541 | 0.6540 |
| 5000 | 0.3713 | 0.6368 |
| 4790 | 0.3868 | 0.6247 |
| 4640 | 0.3954 | 0.6161 |
| 4530 | 0.4023 | 0.6092 |
| 4240 | 0.4213 | 0.5937 |

and the chromaticity coordinate range corresponding to the light source is a chromaticity coordinate region enclosed by following chromaticity coordinates:

| Color temperature | x | y |
|---|---|---|
| 9700 | 0.0340 | 0.7975 |
| 9240 | 0.0652 | 0.7855 |
| 9090 | 0.0803 | 0.7704 |
| 9040 | 0.0913 | 0.7512 |
| 8980 | 0.1085 | 0.7180 |
| 8900 | 0.1286 | 0.6798 |
| 8790 | 0.1467 | 0.6476 |
| 8640 | 0.1669 | 0.6134 |
| 8730 | 0.1830 | 0.5641 |
| 8804 | 0.1961 | 0.5219 |
| 9490 | 0.1669 | 0.5400 |
| 10170 | 0.1296 | 0.5702 |
| 10960 | 0.0903 | 0.6074 |
| 11270 | 0.0491 | 0.6486 |
| 11280 | 0.0259 | 0.6859 |
| 11260 | 0.0118 | 0.7100 |
| 10620 | 0.0158 | 0.7472 |
| 10170 | 0.0229 | 0.7714 |
| 9760 | 0.0329 | 0.7935 |

6. The light-emitting method of claim 1, wherein the chromaticity coordinate range corresponding to the light-transmitting plate is a chromaticity coordinate region enclosed by following chromaticity coordinates:

| x | y |
|---|---|
| 0.5927 | 0.3214 |
| 0.5973 | 0.3463 |
| 0.5791 | 0.3383 |

the target color of the display light is blue, the chromaticity coordinate range of the display light is a chromaticity coordinate region enclosed by following chromaticity coordinates:

| | Chromaticity | Chromaticity |
|---|---|---|
| Color temperature | coordinate x | coordinate y |
| 100000 | 0.1185 | 0.0928 |
| 100000 | 0.1097 | 0.1020 |
| 100000 | 0.1180 | 0.1151 |
| 100000 | 0.1203 | 0.1222 |
| 100000 | 0.1227 | 0.1317 |
| 100000 | 0.1286 | 0.1423 |
| 100000 | 0.1381 | 0.1542 |
| 100000 | 0.1559 | 0.1578 |
| 100000 | 0.1713 | 0.1542 |
| 100000 | 0.1796 | 0.1471 |
| 100000 | 0.1915 | 0.1329 |
| 100000 | 0.1915 | 0.1163 |
| 100000 | 0.1939 | 0.1068 |
| 100000 | 0.1939 | 0.0973 |
| 100000 | 0.1915 | 0.0866 |
| 100000 | 0.1891 | 0.0736 |

and the chromaticity coordinate range corresponding to the light source is a chromaticity coordinate region enclosed by following chromaticity coordinates:

| Color temperature | x | y |
|---|---|---|
| 100000 | 0.1185 | 0.0928 |
| 100000 | 0.1097 | 0.1020 |
| 100000 | 0.1180 | 0.1151 |
| 100000 | 0.1203 | 0.1222 |
| 100000 | 0.1227 | 0.1317 |
| 100000 | 0.1286 | 0.1423 |
| 100000 | 0.1381 | 0.1542 |
| 100000 | 0.1559 | 0.1578 |
| 100000 | 0.1713 | 0.1542 |
| 100000 | 0.1796 | 0.1471 |
| 100000 | 0.1915 | 0.1329 |
| 100000 | 0.1915 | 0.1163 |
| 100000 | 0.1939 | 0.1068 |
| 100000 | 0.1939 | 0.0973 |
| 100000 | 0.1915 | 0.0866 |
| 100000 | 0.1891 | 0.0736 |
| 100000 | 0.1879 | 0.0582 |
| 100000 | 0.1844 | 0.0451 |
| 100000 | 0.1808 | 0.0356 |

7. The light-emitting method of claim 1, wherein the chromaticity coordinate range corresponding to the light-transmitting plate is a chromaticity coordinate region enclosed by following chromaticity coordinates:

| x | y |
|---|---|
| 0.5927 | 0.3214 |
| 0.5973 | 0.3463 |
| 0.5791 | 0.3383 |

the target color of the display light is cyan, the chromaticity coordinate range of the display light is a chromaticity coordinate region enclosed by following chromaticity coordinates:

| | Chromaticity | Chromaticity |
|---|---|---|
| Color temperature | coordinate x | coordinate y |
| 19490 | 0.0148 | 0.5075 |
| 18350 | 0.0349 | 0.4980 |
| 16790 | 0.0515 | 0.4980 |
| 16610 | 0.0693 | 0.4802 |
| 16010 | 0.0836 | 0.4719 |
| 16020 | 0.0978 | 0.4553 |
| 17090 | 0.1132 | 0.4257 |
| 16900 | 0.1275 | 0.4115 |
| 17770 | 0.1381 | 0.3925 |
| 20100 | 0.1417 | 0.3735 |
| 25890 | 0.1452 | 0.3486 |
| 40710 | 0.1476 | 0.3249 |
| ∞ | 0.1441 | 0.2941 |
| ∞ | 0.1369 | 0.2633 |
| ∞ | 0.1286 | 0.2372 |
| ∞ | 0.1215 | 0.2064 |

and the chromaticity coordinate range corresponding to the light source is a chromaticity coordinate region enclosed by following chromaticity coordinates:

| Color temperature | x | y |
|---|---|---|
| 19490 | 0.0148 | 0.5075 |
| 18350 | 0.0349 | 0.4980 |
| 16790 | 0.0515 | 0.4980 |
| 16610 | 0.0693 | 0.4802 |
| 16010 | 0.0836 | 0.4719 |
| 16020 | 0.0978 | 0.4553 |
| 17090 | 0.1132 | 0.4257 |
| 16900 | 0.1275 | 0.4115 |
| 17770 | 0.1381 | 0.3925 |
| 20100 | 0.1417 | 0.3735 |
| 25890 | 0.1452 | 0.3486 |
| 40710 | 0.1476 | 0.3249 |
| ∞ | 0.1441 | 0.2941 |
| ∞ | 0.1369 | 0.2633 |
| ∞ | 0.1286 | 0.2372 |
| ∞ | 0.1215 | 0.2064 |
| 19490 | 0.0148 | 0.5075 |
| 18350 | 0.0349 | 0.4980 |
| 16790 | 0.0515 | 0.4980 |

8. The light-emitting method of claim 1, wherein the chromaticity coordinate range corresponding to the light-transmitting plate is a chromaticity coordinate region enclosed by following chromaticity coordinates:

| x | y |
|---|---|
| 0.5927 | 0.3214 |
| 0.5973 | 0.3463 |
| 0.5791 | 0.3383 |

the target color of the display light is green, the chromaticity coordinate range of the display light is a chromaticity coordinate region enclosed by following chromaticity coordinates:

| | Chromaticity | Chromaticity |
|---|---|---|
| Color temperature | coordinate x | coordinate y |
| 8760 | 0.0729 | 0.8348 |
| 9010 | 0.0610 | 0.8265 |
| 9190 | 0.0527 | 0.8193 |
| 9470 | 0.0409 | 0.8099 |
| 9620 | 0.0397 | 0.7944 |
| 9470 | 0.0575 | 0.7743 |
| 9480 | 0.0646 | 0.7577 |
| 9500 | 0.0717 | 0.7411 |
| 9500 | 0.0800 | 0.7233 |
| 9480 | 0.0871 | 0.7103 |
| 9340 | 0.1002 | 0.6960 |
| 9130 | 0.1108 | 0.6949 |
| 8900 | 0.1156 | 0.7103 |
| 8790 | 0.1132 | 0.7304 |
| 8710 | 0.1108 | 0.7470 |
| 8620 | 0.1085 | 0.7660 |

and the chromaticity coordinate range corresponding to the light source is a chromaticity coordinate region enclosed by following chromaticity coordinates:

| Color temperature | x | y |
|---|---|---|
| 8760 | 0.0729 | 0.8348 |
| 9010 | 0.0610 | 0.8265 |
| 9190 | 0.0527 | 0.8193 |
| 9470 | 0.0409 | 0.8099 |
| 9620 | 0.0397 | 0.7944 |
| 9470 | 0.0575 | 0.7743 |
| 9480 | 0.0646 | 0.7577 |
| 9500 | 0.0717 | 0.7411 |
| 9500 | 0.0800 | 0.7233 |
| 9480 | 0.0871 | 0.7103 |
| 9340 | 0.1002 | 0.6960 |
| 9130 | 0.1108 | 0.6949 |
| 8900 | 0.1156 | 0.7103 |
| 8790 | 0.1132 | 0.7304 |
| 8710 | 0.1108 | 0.7470 |
| 8620 | 0.1085 | 0.7660 |
| 8560 | 0.1061 | 0.7814 |
| 8510 | 0.1037 | 0.7968 |
| 8480 | 0.0990 | 0.8134 |

9. The light-emitting method of claim 1, wherein the chromaticity coordinate range corresponding to the light-transmitting plate is a chromaticity coordinate region enclosed by following chromaticity coordinates:

| x | y |
|---|---|
| 0.5927 | 0.3214 |
| 0.5973 | 0.3463 |
| 0.5791 | 0.3383 |

the target color of the display light is orange, the chromaticity coordinate range of the display light is a chromaticity coordinate region enclosed by following chromaticity coordinates:

| | Chromaticity | Chromaticity |
|---|---|---|
| Color temperature | coordinate x | coordinate y |
| 3180 | 0.4785 | 0.5194 |
| 3240 | 0.4667 | 0.5040 |
| 3330 | 0.4525 | 0.4850 |
| 3420 | 0.4394 | 0.4672 |
| 3450 | 0.4299 | 0.4482 |
| 3140 | 0.4382 | 0.4245 |
| 2790 | 0.4536 | 0.4103 |
| 2460 | 0.4702 | 0.3961 |
| 2220 | 0.4868 | 0.3901 |
| 1900 | 0.5118 | 0.3771 |
| 1680 | 0.5355 | 0.3700 |
| 1670 | 0.5639 | 0.3629 |
| 1670 | 0.5829 | 0.3652 |
| 1670 | 0.6114 | 0.3676 |
| 1670 | 0.6304 | 0.3700 |
| 1670 | 0.6126 | 0.3890 |

and the chromaticity coordinate range corresponding to the light source is a chromaticity coordinate region enclosed by following chromaticity coordinates:

| Color temperature | x | y |
|---|---|---|
| 8090 | 0.1239 | 0.8158 |
| 8070 | 0.1322 | 0.7944 |
| 8080 | 0.1393 | 0.766 |
| 8100 | 0.1464 | 0.7458 |
| 7980 | 0.1607 | 0.7245 |
| 7980 | 0.1654 | 0.7115 |
| 7920 | 0.1761 | 0.6866 |
| 7840 | 0.1868 | 0.6664 |
| 7730 | 0.1986 | 0.6462 |
| 7530 | 0.2152 | 0.6249 |
| 7330 | 0.2295 | 0.6095 |
| 7090 | 0.2449 | 0.5953 |
| 6760 | 0.2627 | 0.5917 |
| 6500 | 0.2745 | 0.6059 |
| 6400 | 0.2781 | 0.6213 |
| 6390 | 0.2757 | 0.6474 |
| 6280 | 0.2793 | 0.6771 |
| 6220 | 0.2816 | 0.6949 |
| 6170 | 0.284 | 0.7126 |

10. The light-emitting method of claim 1, wherein the chromaticity coordinate range corresponding to the light-transmitting plate is a chromaticity coordinate region enclosed by following chromaticity coordinates:

| x | y |
|---|---|
| 0.5927 | 0.3214 |
| 0.5973 | 0.3463 |
| 0.5791 | 0.3383 |

the target color of the display light is violet, the chromaticity coordinate range of the display light is a chromaticity coordinate region enclosed by following chromaticity coordinates:

| | Chromaticity | Chromaticity |
|---|---|---|
| Color temperature | coordinate x | coordinate y |
| ∞ | 0.1856 | 0.0095 |
| ∞ | 0.1856 | 0.0261 |
| ∞ | 0.1891 | 0.0392 |
| ∞ | 0.1891 | 0.0487 |
| ∞ | 0.1939 | 0.0605 |
| ∞ | 0.1962 | 0.0700 |
| ∞ | 0.2010 | 0.0819 |
| ∞ | 0.2069 | 0.0961 |
| ∞ | 0.2176 | 0.1103 |
| ∞ | 0.2318 | 0.1163 |
| ∞ | 0.2316 | 0.1115 |
| ∞ | 0.2413 | 0.1044 |
| ∞ | 0.2425 | 0.0854 |
| ∞ | 0.2437 | 0.0736 |
| ∞ | 0.2378 | 0.0593 |
| ∞ | 0.2342 | 0.0309 |

and the chromaticity coordinate range corresponding to the light source is a chromaticity coordinate region enclosed by following chromaticity coordinates:

| | Chromaticity | Chromaticity |
|---|---|---|
| Color temperature | coordinate x | coordinate y |
| ∞ | 0.1856 | 0.0095 |
| ∞ | 0.1856 | 0.0261 |
| ∞ | 0.1891 | 0.0392 |
| ∞ | 0.1891 | 0.0487 |
| ∞ | 0.1939 | 0.0605 |
| ∞ | 0.1962 | 0.0700 |
| ∞ | 0.2010 | 0.0819 |
| ∞ | 0.2069 | 0.0961 |
| ∞ | 0.2176 | 0.1103 |
| ∞ | 0.2318 | 0.1163 |
| ∞ | 0.2316 | 0.1115 |
| ∞ | 0.2413 | 0.1044 |
| ∞ | 0.2425 | 0.0854 |
| ∞ | 0.2437 | 0.0736 |
| ∞ | 0.2378 | 0.0593 |
| ∞ | 0.2342 | 0.0309 |

11. The light-emitting method of claim 1, wherein the chromaticity coordinate range corresponding to the light-transmitting plate is a chromaticity coordinate region enclosed by following chromaticity coordinates:

| x | y |
|---|---|
| 0.5927 | 0.3214 |
| 0.5973 | 0.3463 |
| 0.5791 | 0.3383 |

the target color of the display light is red, the chromaticity coordinate range of the display light is a chromaticity coordinate region enclosed by following chromaticity coordinates:

| | Chromaticity | Chromaticity |
|---|---|---|
| Color temperature | coordinate x | coordinate y |
| 1670 | 0.7369 | 0.2668 |
| 1670 | 0.7158 | 0.2799 |
| 1680 | 0.7015 | 0.2905 |
| 1680 | 0.6778 | 0.3060 |
| 1680 | 0.6517 | 0.3107 |
| 1690 | 0.6316 | 0.3095 |
| 1690 | 0.6078 | 0.2977 |
| 1690 | 0.6019 | 0.2822 |
| 1700 | 0.6090 | 0.2668 |
| 1710 | 0.6375 | 0.2633 |
| 1700 | 0.6565 | 0.2656 |
| 1690 | 0.6683 | 0.2692 |
| 1720 | 0.6920 | 0.2704 |
| 1680 | 0.7146 | 0.2704 |

and the chromaticity coordinate range corresponding to the light source is a chromaticity coordinate region enclosed by following chromaticity coordinates:

| Color temperature | x | y |
|---|---|---|
| 1670 | 0.7369 | 0.2668 |
| 1670 | 0.7158 | 0.2799 |
| 1680 | 0.7015 | 0.2905 |
| 1680 | 0.6778 | 0.3060 |
| 1680 | 0.6517 | 0.3107 |
| 1690 | 0.6316 | 0.3095 |
| 1690 | 0.6078 | 0.2977 |
| 1690 | 0.6019 | 0.2822 |
| 1700 | 0.6090 | 0.2668 |
| 1710 | 0.6375 | 0.2633 |
| 1700 | 0.6565 | 0.2656 |
| 1690 | 0.6683 | 0.2692 |
| 1720 | 0.6920 | 0.2704 |
| 1680 | 0.7146 | 0.2704 |

12. The light-emitting method of claim 1, further comprising:
adjusting at least one light-emitting parameter of the light source so that the display surface of the light-transmitting plate displays the display light that satisfies the display condition, wherein the at least one light-emitting parameter include an intensity and a full width at half maxima of a main wavelength spectrum.

13. A light-emitting device facing a limited condition, comprising a light source and a light-transmitting plate, wherein
the light source is configured to emit light to a non-display surface of a light-transmitting plate that satisfies a light-transmitting condition so that a display surface of the light-transmitting plate displays a display light that satisfies a display condition; wherein
the light-transmitting condition includes a chromaticity coordinate range corresponding to the light-transmitting plate, wherein the chromaticity coordinate range corresponding to the light-transmitting plate is a chromaticity coordinate region where a transmitted light of a CIE standard illuminant passing through the light-transmitting plate is rendered in a CIE standard chromaticity system; and
the display condition includes a chromaticity coordinate range of the display light, wherein the chromaticity coordinate range of the display light is a chromaticity coordinate range required by the display light to display a transmitted light in a target color; and
the light source satisfies that a chromaticity coordinate range corresponding to the light source is a chromaticity coordinate range of the light source for displaying the display light, and a light color adjustment range corresponding to the light source is a spectrum adjustment range of the light source for displaying the display light.

14. The light-emitting device of claim 13, wherein a light-emitting component of the light source is a lighting component, and the target color is white; wherein
the lighting component includes three primary color lamps, intrinsic peaks of a spectrum of the light source are within a range of 440 nm-495 nm, a range of 495 nm-520 nm, and a range of 520 nm-570 nm, respectively, and the primary color lamp with the intrinsic peak within the range of 440 nm-495 nm is dominant; or
the lighting component includes two primary color lamps, the intrinsic peaks of the spectrum of the light source are within a range of 440 nm-495 nm and a range of 520 nm-570 nm, respectively, and the primary color lamp with the intrinsic peak within the range of 440 nm-495 nm is dominant; or
the lighting component includes one primary color lamp, and an intrinsic peak of the spectrum of the light source is within a range of 470 nm-500 nm.

15. The light-emitting device of claim 13, wherein a light-emitting component of the light source is a lighting component, and the target color is yellow; wherein
the lighting component includes one primary color lamp, and an intrinsic peak of a spectrum of the light source is within a range of 560 nm-580 nm; or
the lighting component includes two primary color lamps, intrinsic peaks of the spectrum of the light source are within a range of 490 nm-560 nm and a range of 560 nm-580 nm, respectively, and the primary color lamp with the intrinsic peak within the range of 560 nm-580 nm is dominant.

16. The light-emitting device of claim 13, wherein a light-emitting component of the light source is a lighting component, and the target color is blue; wherein
the lighting component includes one primary color lamp, and an intrinsic peak of a spectrum of the light source is within a range of 440 nm-470 nm; or
the lighting component includes two primary color lamps, intrinsic peaks of the spectrum of the light source are within a range of 440 nm-470 nm and a range of 520 nm-570 nm, respectively, and the primary color lamp with the intrinsic peak within the range of 440 nm-470 nm is dominant.

17. The light-emitting device of claim 13, wherein a light-emitting component of the light source is a lighting component, and the target color is cyan; wherein
the lighting component includes one primary color lamp, and an intrinsic peak of a spectrum of the light source is within a range of 440 nm-470 nm; or
the lighting component includes two primary color lamps, intrinsic peaks of the spectrum of the light source are within a range of 440 nm-470 nm and a range of 520 nm-570 nm, respectively, and the primary color lamp with the intrinsic peak within the range of 440 nm-470 nm is dominant.

18. The light-emitting device of claim 13, wherein a light-emitting component of the light source is a lighting component, and the target color is green; wherein
the lighting component includes one primary color lamp, and an intrinsic peak of a spectrum of the light source is within a range of 500 nm-560 nm; or
the lighting component includes two primary color lamps, intrinsic peaks of the spectrum of the light source are within a range of 470 nm-500 nm and a range of 500 nm-560 nm, respectively, and the primary color lamp with the intrinsic peak within the range of 500 nm-560 nm is dominant.

19. The light-emitting device of claim 13, wherein a light-emitting component of the light source is a lighting component, and the target color is orange; wherein
the lighting component includes one primary color lamp, and an intrinsic peak of a spectrum of the light source is within a range of 580 nm-610 nm; or
the lighting component includes two primary color lamps, intrinsic peaks of the spectrum of the light source are within a range of 470 nm-580 nm and a range of 580 nm-610 nm, respectively, and the primary color lamp with the intrinsic peak within the range of 580 nm-610 nm is dominant.

20. A non-transitory computer-readable storage medium storing computer instructions, wherein when a computer reads the computer instructions in the storage medium, the computer performs a light-emitting method facing a limited condition, wherein
the limited condition includes that a light emitted by a light source transmits through a non-display surface of a light-transmitting plate that satisfies a light-transmitting condition so that a display surface of the light-transmitting plate displays a display light that satisfies a display condition; wherein
the light-transmitting condition includes a chromaticity coordinate range corresponding to the light-transmitting plate, wherein the chromaticity coordinate range corresponding to the light-transmitting plate is a chromaticity coordinate region where a transmitted light of a CIE standard illuminant passing through the light-transmitting plate is rendered in a CIE standard chromaticity system; and
the display condition includes a chromaticity coordinate range of the display light, wherein the chromaticity coordinate range of the display light is a chromaticity coordinate range required by the display light to display a transmitted light in a target color; and
the light-emitting method includes the light source satisfying that a chromaticity coordinate range corresponding to the light source is a chromaticity coordinate range of the light source for displaying the display light, and a light color adjustment range corresponding to the light source is a spectrum adjustment range of the light source for displaying the display light.
